(19) United States
(12) Patent Application Publication
(10) Pub. No.: US 2026/0228162 A1
(43) Pub. Date: Aug. 6, 2026

(54) CXL Scale-Up Memory Tier for GPUs and Heterogeneous PCIe Fabrics Comprising Hosts, Devices, and Switches, Enabling Shared Memory via Protocol Translations

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/629,017

(22) Filed: Mar. 26, 2026

Related U.S. Application Data
(63) Continuation of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

In computing environments where entities may utilize different protocols while requiring coordinated access to shared resources, there may be scenarios where a first entity supporting PCIe, such as a GPU, needs to access memory resources coupled to a second entity supporting CXL.mem. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. Some implementations include translating PCIe memory requests to CXL.mem M2S requests, and translating CXL.mem S2M data responses to PCIe completions. The translations may include physical address translations, Tag translations, and speculative memory reads.

### CROSS-REFERENCE TO RELATED APPLICATIONS

This Application claims priority to: U.S. Provisional Ser. No. 63/991,122, filed Feb. 25, 2026; U.S. Provisional Ser. No. 63/931,124, filed Dec. 4, 2025; U.S. Provisional Ser. No. 63/906,709, filed Oct. 28, 2025; U.S. Provisional Ser. No. 63/895,053, filed Oct. 7, 2025; U.S. Provisional Ser. No. 63/874,393, filed Sep. 2, 2025; U.S. Provisional Ser. No. 63/856,653, filed Aug. 3, 2025; U.S. Provisional Ser. No. 63/826,342, filed Jun. 18, 2025; U.S. Provisional Ser. No. 63/811,859, filed May 25, 2025; and U.S. Provisional Ser. No. 63/784,089, filed Apr. 5, 2025. This Application is also a Continuation-In-Part of U.S. patent application Ser. No. 19/371,779, filed Oct. 28, 2025, which claims priority to: U.S. Provisional Ser. No. 63/752,940, filed Feb. 3, 2025; U.S. Provisional Ser. No. 63/743,658, filed Jan. 10, 2025; and U.S. Provisional Ser. No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Ser. No. 63/719,640, filed 12 Nov. 2024; U.S. Provisional Ser. No. 63/701,554, filed 30 Sep. 2024; U.S. Provisional Ser. No. 63/695,957, filed 18 Sep. 2024; U.S. Provisional Ser. No. 63/678,045, filed 31 Jul. 2024; U.S. Provisional Ser. No. 63/652,165, filed 27 May 2024; and U.S. Provisional Ser. No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Ser. No. 63/609,833, filed 13 Dec. 2023.

### BACKGROUND

Peripheral Component Interconnect Express (PCIe) is a high-speed serial interconnect standard that provides communication between host processors and peripheral devices in computing systems. PCIe defines a layered architecture comprising a transaction layer, a data link layer, and a physical layer. The transaction layer generates and processes Transaction Layer Packets (TLPs) that carry memory read requests, memory write requests, completions, and other transaction types between requesters and completers. PCIe supports both posted transactions, such as memory writes that do not require a completion, and non-posted transactions, such as memory reads that require a completion carrying the requested data. PCIe also defines Unordered Input/Output (UIO) transaction types that provide ordering flexibility for memory operations in systems with multiple paths between source and destination.

Compute Express Link (CXL) is an interconnect technology that enables cache-coherent memory access and high-bandwidth communication between hosts and devices. CXL builds upon the physical and electrical interface defined by PCIe while adding protocols that support memory semantics and cache coherency operations. The CXL specification defines sub-protocols, including CXL.io for input/output operations, CXL.mem for memory access, and CXL.cache for cache coherency. CXL.mem utilizes Master-to-Subordinate (M2S) messages to carry requests and data from a memory master toward a memory subordinate, and Subordinate-to-Master (S2M) messages to carry responses and data from the subordinate toward the master. The M2S channel includes request messages that carry memory read and write operations along with address information and transaction identifiers. The S2M channel includes data response messages that carry read data, and no-data response messages that carry completion status.

GPUs and other accelerators commonly utilize PCIe interfaces to communicate with host processors and to access system resources. In computing architectures that employ accelerators for workloads such as artificial intelligence (AI), machine learning, and graphics rendering, the memory capacity available to a GPU may be limited by the high-bandwidth memory (HBM) integrated within the GPU package. CXL memory devices, including memory expanders and memory pools, provide memory capacity that may exceed the local memory available within individual accelerators.

### SUMMARY

In some implementations, computing architectures may incorporate entities that communicate using different protocols while requiring coordinated access to shared memory resources. There may be scenarios where a first entity communicating based on PCIe, such as a GPU, needs to access memory resources coupled to a second entity communicating based on CXL.mem, such as a CXL memory expander or a CXL memory pool. Some implementations address these scenarios by providing translation between PCIe TLPs and CXL.mem messages, facilitating memory operations, data transfers, and resource sharing across different protocol domains.

In various implementations, a method for translating between PCIe TLPs and CXL messages comprises receiving a PCIe memory request by a computer from a first entity; translating, by the computer, the PCIe memory request to a CXL.mem M2S request; sending, by the computer to a second entity, the CXL.mem M2S request; receiving, by the computer from the second entity, a CXL.mem S2M DRS corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers. The method may include physical address translation between different address spaces utilized by the first and second entities, Tag translation between PCIe and CXL.mem Tag formats, and speculative memory reads initiated by the computer.

In other implementations, an apparatus for translating between PCIe TLPs and CXL messages comprises a first interface configured to communicate with a first entity based on PCIe, a second interface configured to communicate with a second entity based on CXL.mem, and a computer coupled to the first interface and the second interface. The computer is configured to receive, from the first entity via the first interface, a PCIe memory request; translate the PCIe memory request to a CXL.mem M2S request; send, to the second entity via the second interface, the CXL.mem M2S request; receive, from the second entity via the second interface, a CXL.mem S2M DRS corresponding to the CXL.mem M2S request; translate the CXL.mem S2M DRS to a PCIe Completion; and send, to the first entity via the first interface, the PCIe Completion. The apparatus may be implemented as a switch, a bridge, a semiconductor device, a chiplet within an IC package, or an active cable.

In other implementations, a system comprises GPUs, wherein at least one GPU of the GPUs does not support CXL communications; a CXL device coupled to memory having a capacity greater than a capacity of HBM of any one of the GPUs; and a computer coupled between the GPUs and the CXL device. The computer comprises a first interface configured to communicate with the GPUs based on PCIe and a second interface configured to communicate with the CXL device based on CXL.mem. The computer is configured to receive, from a GPU of the GPUs via the first interface, a PCIe memory request; translate the PCIe memory request to a CXL.mem M2S request; send, to the CXL device via the second interface, the CXL.mem M2S request; receive, from the CXL device via the second interface, a CXL.mem S2M DRS; translate the CXL.mem S2M DRS to a PCIe Completion; and send the PCIe Completion to the GPU via the first interface. The system may enable GPUs to access memory resources that exceed their local HBM capacity through the translation provided by the computer.

### BRIEF DESCRIPTION OF THE DRAWINGS

FIG. 1A illustrates an example of a system that translates between PCIe and CXL.mem;

FIG. 1B illustrates an example of a TFD demonstrating translations between PCIe TLPs and CXL.mem messages;

FIG. 1C illustrates an example of a TFD demonstrating translations between PCIe UIO TLPs and CXL.mem messages;

FIG. 2A illustrates an example of a system comprising an RPU that translates between UALink-based traffic and CXL.mem-based traffic;

FIG. 2B illustrates an example of a TFD demonstrating translations between UPLI request and CXL.mem M2S Req MemRd;

FIG. 3A illustrates an example of a system comprising an RPU that enables UALink-based entities to access CXL-based resources coupled to the RPU;

FIG. 3B illustrates an example of a TFD demonstrating intent-based translation between UPLI and CXL.mem;

FIG. 4A illustrates an example of a system comprising a processor comprising a UALink port enabling external entities to access memory resources mapped to an address space utilized by the processor's coherent interconnect;

FIG. 4B illustrates an example of a TFD demonstrating two UPLI requests forwarded to different memories mapped to an address space utilized by a processor's coherent interconnect;

FIG. 5A illustrates an example of a system comprising a processor comprising a coherent interconnect, a UALink port, and a CXL RP;

FIG. 5B illustrates an example of a TFD demonstrating translating two UPLI requests to a coherent interconnect request and to a CXL.mem request;

FIG. 6A illustrates an example of a system that translates between UALink-based traffic and CXL.mem traffic;

FIG. 6B illustrates an example of a TFD demonstrating translations between UPLI request and CXL.mem request, with an optional speculative memory read;

FIG. 7A illustrates an example of a system comprising an apparatus that translates between NVLink-based traffic and CXL.mem traffic;

FIG. 7B illustrates an example of a TFD demonstrating translations between NVLink-based traffic and CXL.mem traffic;

FIG. 8A illustrates an example of a system, comprising an RPU having an NVLink interface, which enables a GPU to access resources coupled to the RPU over CXL.mem;

FIG. 8B illustrates an example of a TFD demonstrating translations between an NVLink-based protocol and CXL.mem utilized for communicating with a CXL device or CXL memory;

FIG. 8C illustrates an example of a TFD demonstrating translations between NVLink-based requests and CXL.mem requests;

FIG. 9A illustrates an example of a system that translates between an NVLink-based protocol and a CXL protocol;

FIG. 9B illustrates an example of a system comprising an RPU in an NVLink switch or NVSwitch, coupled to NVLink and CXL.mem entities;

FIG. 9C illustrates an example of a system comprising an xPU with an NVLink Fusion chiplet;

FIG. 10A illustrates an example of a system comprising a processor including a coherent interconnect and an NVLink interface;

FIG. 10B illustrates an example of a TFD demonstrating two NVLink read requests forwarded to different memories via a coherent interconnect;

FIG. 11A illustrates an example of a system comprising a processor comprising an NVLink interface and a CXL RP;

FIG. 11B illustrates an example of a TFD demonstrating translating a first NVLink request to a coherent interconnect protocol, and translating a second NVLink read request to a CXL.mem M2S MemRd request;

FIG. 12A illustrates an example of a system that translates between first and second CXL.mem;

FIG. 12B illustrates an example of a transaction flow diagram (TFD) demonstrating translations between CXL.mem M2S MemRdData request and CXL.mem M2S MemRd request, with optional speculative memory reads;

FIG. 13A illustrates an example of a system comprising a computer, having a buffer/cache, which translates between first and second CXL.mem;

FIG. 13B illustrates an example of a TFD demonstrating translations between a first CXL.mem M2S MemSpecRd and a second CXL.mem M2S MemSpecRd, with an optional initiation of a third CXL.mem M2S MemSpecRd;

FIG. 13C illustrates an example of a TFD demonstrating translations between CXL.mem M2S MemSpecRd and CXL.mem M2S MemRd*;

FIG. 14A illustrates an example of a system that translates between three CXL.mem interfaces;

FIG. 14B illustrates an example of a TFD demonstrating translations between four CXL.mem M2S requests;

FIG. 15A illustrates an example of a system comprising a processor/switch with a CXL device configured to enable external entities to access resources coupled to the processor;

FIG. 15B illustrates an example of a TFD demonstrating translations between first and second CXL.mem transactions comprising MemRd*;

FIG. 16A illustrates an example of a system comprising a processor configured to communicate with multiple hosts according to CXL.mem;

FIG. 16B illustrates an example of a TFD demonstrating two CXL.mem transactions directed to different memories coupled to a processor;

FIG. 17A illustrates an example of a system that translates between CXL.mem and PCIe;

FIG. 17B illustrates an example of a transaction flow diagram (TFD) demonstrating translations between CXL.mem M2S request and PCIe MRd;

FIG. 17C illustrates an example of a TFD demonstrating translations between CXL.mem M2S request and PCIe UIOMRd;

FIG. 18A illustrates an example of a system comprising first and second entities coupled by a computer that translates between CXL.mem and PCIe;

FIG. 18B illustrates an example of a TFD demonstrating translations between CXL.mem M2S RwD and PCIe MWr;

FIG. 18C illustrates an example of a TFD demonstrating translations between CXL.mem M2S RwD and PCIe UIOMWr;

FIG. 19A illustrates an example of a system comprising a cable that translates between CXL-based traffic and PCIe-based traffic;

FIG. 19B illustrates an example of a TFD demonstrating translations performed by an active cable between CXL.mem transactions and PCIe transactions;

FIG. 20A and FIG. 20B illustrate examples of translating between CXL.mem and UALink-based protocol;

FIG. 21A illustrates an example of an RPU comprising a cache, which translates between CXL.mem and UPLI;

FIG. 21B illustrates an example of an RPU without a cache, translates between CXL.mem and UPLI;

FIG. 22 illustrates an example of a host CPU accessing various devices over CXL.mem to UALink;

FIG. 23A illustrates an example of a system that translates between first and second PCIe-based protocols;

FIG. 23B illustrates an example of a TFD demonstrating translations between PCIe MRd and PCIe UIOMRd;

FIG. 23C illustrates an example of a TFD demonstrating translations between PCIe UIOMRd and PCIe MRd;

FIG. 24A illustrates an example of a system that translates between CXL-based traffic and PCIe-based traffic;

FIG. 24B illustrates an example of a TFD demonstrating translations between CXL.io UIOMRd and PCIe UIOMRd;

FIG. 24C illustrates an example of a TFD demonstrating translations between CXL.io UIOMRd and PCIe MRd;

FIG. 25A illustrates an example of a system that translates between CXL.io traffic;

FIG. 25B illustrates an example of a TFD demonstrating translations between CXL.io MRd and CXL.io UIOMRd;

FIG. 25C illustrates an example of a TFD demonstrating translations between CXL.io UIOMRd and CXL.io MRd;

FIG. 26A illustrates an example of a silicon device functioning as an established xPU design before modification;

FIG. 26B illustrates an example of a silicon device capable of providing the functionality of a CXL MHD;

FIG. 26C illustrates an example of a silicon device capable of providing the functionality of a UALink Switch;

FIG. 27A illustrates a system comprising a prior art xPU design, such as a processor design, that includes a repurposed area;

FIG. 27B illustrates an example of a Multi-Headed Device (MHD) implementation that may be based on an xPU or an MxPU design, such as a processor design, that includes a repurposed area; and

FIG. 27C illustrates an example of a processor comprising termination circuits implemented at interfaces between silicon die areas.

### DETAILED DESCRIPTION

In environments where entities may utilize different protocols while requiring coordinated access to shared resources, there may be scenarios where a first entity communicating based on PCIe, such as a GPU, needs to access memory resources coupled to a second entity communicating based on CXL.mem, such as a CXL memory expander or a CXL memory pool. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. This translation may enable PCIe devices that do not natively support CXL protocols to access large-capacity CXL-attached memory resources. For example, GPUs designed with PCIe interfaces may access CXL memory pools that provide memory capacity exceeding the HBM integrated within the GPUs, thereby extending the effective memory available for AI/ML workloads, graphics rendering, or general-purpose GPU computing possibly without requiring hardware modifications to existing GPU designs. The computer may perform address translations between different physical address spaces, opcode translations between PCIe and CXL.mem, and Tag translations between PCIe Tag formats and CXL.mem Tag formats.

In various implementations, a method for translating between Peripheral Component Interconnect Express (PCIe) Transaction Layer Packets (TLPs) and Compute Express Link (CXL) messages, comprising: receiving a PCIe memory request by a computer from a first entity; translating, by the computer, the PCIe memory request to a CXL.mem Master-to-Subordinate (M2S) request; sending, by the computer to a second entity, the CXL.mem M2S request; receiving, by the computer from the second entity, a CXL.mem Subordinate-to-Master Data Response (S2M DRS) corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, switches, bridges, or active cables. The computer may maintain state information, such as pending transaction tables or tracker entries, to correlate CXL.mem S2M DRS responses with previously transmitted CXL.mem M2S requests and with pending PCIe transactions. Additionally, the elements may communicate through one or more intermediary components, such as a switch, a retimer, or other suitable entity that facilitates information transfer. The first entity may include devices such as GPUs, NICs, DMA engines, accelerators, or other PCIe endpoints, while the second entity may include CXL memory expanders, CXL memory pools, GFDs, or other CXL.mem-capable devices.

In some implementations of the method, the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an address space utilized by the first entity for PCIe memory-mapped I/O (MMIO) operations, and the second physical address space may include a Host Physical Address (HPA) space utilized by a CXL host coupled to a CXL device of the second entity. The computer may maintain translation tables that map regions of the first physical address space to corresponding regions of the second physical address space, enabling the first entity to access CXL-attached memory resources using addresses within its native address space.

In some implementations of the method, the first entity comprises a GPU that does not support CXL.mem, wherein the second entity comprises a CXL memory pool, and wherein the computer exposes memory resources of the CXL memory pool to the GPU via a PCIe memory address space. The computer may expose the CXL memory pool to the GPU by configuring Base Address Registers (BARs) or other PCIe mechanisms to advertise a memory region that the GPU can access using standard PCIe memory read and write operations. The GPU may utilize this exposed memory region for various purposes, such as storing intermediate computation results, model parameters for AI/ML inference, texture data for graphics rendering, or working data sets that exceed the GPU's local HBM capacity. The computer may handle the translation transparently, such that the GPU may operate without awareness that the underlying memory is accessed utilizing CXL.mem rather than standard PCIe memory, which may enable existing GPU designs with PCIe interfaces to benefit from CXL-attached memory resources.

In some implementations of the method, the computer communicates with GPUs via interfaces, and wherein the computer translates PCIe memory requests from the GPUs to CXL.mem M2S requests targeting a shared memory resource of the CXL memory pool. The shared memory region of the CXL memory pool may be accessible by multiple GPUs, enabling data sharing, inter-GPU communication, or load balancing across the GPUs. The computer may implement arbitration logic to manage concurrent memory requests from the GPUs, and may utilize QoS mechanisms to allocate bandwidth or prioritize requests from different GPUs. The shared memory architecture may be beneficial in multi-GPU computing environments, such as AI/ML training clusters, where GPUs may need to access common datasets, model parameters, or intermediate results. The interfaces may include separate PCIe links, lanes within a shared PCIe link, or virtual channels within a PCIe fabric.

In some implementations of the method, the computer maintains memory allocation information associating portions of the CXL memory pool with certain respective GPUs of the GPUs, and wherein translating the PCIe memory request comprises selecting a portion of the CXL memory pool based on an identity of a requesting GPU. The memory allocation information may include address range tables, partition descriptors, or access control lists that define which portions of the CXL memory pool are accessible by each GPU. The computer may identify the requesting GPU based on the Requester ID in the PCIe memory request, a source port identifier, or other identification mechanisms. The partitioning may enable isolation between GPUs for security or fault containment purposes, or may enable dynamic memory allocation wherein portions of the CXL memory pool are assigned to GPUs based on workload requirements. The computer may support exclusive partitions (accessible by a single GPU) and/or shared regions (accessible by multiple GPUs) within the CXL memory pool.

In some implementations of the method, the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CplD) comprising the data and the first Tag; and wherein the computer maintains a mapping between the first Tag and the second Tag. The computer may maintain the mapping between the first Tag and the second Tag in a tracker entry, a translation table, or another relevant data structure. Upon receiving the CXL.mem S2M DRS from the second entity, the computer may utilize the second Tag to identify the corresponding pending transaction and retrieve the first Tag for inclusion in the PCIe CplD. GPUs may utilize PCIe memory reads to access large memory pools for workloads such as graphics rendering, machine learning inference, or general-purpose GPU computing workloads. NICs may utilize PCIe memory reads to access memory buffers for network packet processing, RDMA, or storage traffic handling. DMA engines may utilize PCIe memory reads to transfer data between memory regions on behalf of other system components. The second entity may expose memory resources that are implemented using various memory technologies such as DDR5, DDR4, HBM, persistent memory, or combinations thereof.

In some implementations, the method further comprises receiving, by the computer from the first entity, a PCIe Memory Write request (MWr) comprising write data; translating the PCIe MWr to a CXL.mem M2S request with Data (M2S RwD) comprising a MemWr* and the write data; sending the CXL.mem M2S RwD to the second entity; and receiving, from the second entity, a CXL.mem S2M No Data Response (S2M NDR) comprising Cmp*. The PCIe MWr may be a posted write that does not require a completion to be returned to the first entity. However, CXL.mem may return an S2M NDR with Cmp* to acknowledge receipt of the write data by the second entity. The computer may absorb the S2M NDR without forwarding the acknowledgment to the first entity, or may utilize the S2M NDR to update internal state or flow control mechanisms. The write data may be transferred from the PCIe domain to the CXL.mem domain with optional format conversion, alignment adjustment, or byte enable manipulation as appropriate for the respective protocol specifications. The computer may buffer the write data internally and may implement mechanisms to handle scenarios where the CXL.mem M2S RwD encounters errors or back-pressure from the second entity.

In some implementations of the method, the computer is included in a switch, and wherein the PCIe memory request is selected from: a UIO Memory Read (UIOMRd) request, a UIO Memory Write request (UIOMWr), a Memory Read (MRd) request, or a Memory Write request (MWr). The selection among UIOMRd, UIOMWr, MRd, or MWr may depend on the capabilities of the first entity and the configuration of the path between the first entity and the computer.

In some implementations of the method, the PCIe memory request comprises a PCIe Unordered Input/Output (UIO) Memory Read (UIOMRd) request, and wherein the PCIe Completion comprises a PCIe UIO Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. UIO transactions may allow out-of-order completion delivery, which may reduce head-of-line blocking and improve overall system throughput in heavily loaded systems. The UIORdCplD completion may include a CDL that the computer may populate with information collected from the CXL.mem domain, from the computer itself, or from intermediate components.

In some implementations, the method further comprises receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity. The UIO Memory Write request may be a non-posted transaction for which the first entity expects a UIOWrCpl, and the computer may translate the CXL.mem S2M NDR to the PCIe UIOWrCpl, thereby providing end-to-end acknowledgment that the write data has been received by the second entity. This non-posted write may be beneficial for maintaining ordering guarantees or for implementing synchronization mechanisms. The UIOWrCpl may include a CDL that the computer may populate based on the DevLoad from the CXL.mem S2M NDR or based on locally generated information.

In some implementations of the method, the CXL.mem S2M DRS comprises a DevLoad, and wherein the PCIe Completion comprises a CXL DevLoad (CDL) populated based on the DevLoad. The DevLoad in the CXL.mem S2M DRS may carry QoS telemetry information indicating the loading or congestion state of the second entity or intermediate components in the CXL.mem path. The computer may translate this telemetry information to the CDL in the PCIe UIORdCplD, thereby propagating QoS information back to the first entity. The first entity may utilize this information to make informed decisions about subsequent memory operations, such as throttling request rates, adjusting request priorities, or selecting alternative memory resources based on observed loading conditions. This end-to-end propagation of telemetry information may enable more efficient resource utilization in heterogeneous computing systems.

In some implementations, the method further comprises sending, by the computer to the second entity, a CXL.mem M2S request comprising MemSpecRd. The speculative memory read may be initiated by the computer to fetch data from the second entity in advance of, or without, the first entity explicitly requesting that data. The CXL.mem MemSpecRd opcode provides a mechanism for speculative memory access that does not have a direct equivalent in PCIe, enabling the computer to leverage CXL.mem-specific capabilities to improve performance for PCIe devices. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. Data returned in response to speculative reads may be buffered by the computer and may be utilized to satisfy subsequent requests from the first entity, potentially reducing observed read latency.

In some implementations, the method further comprises receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data; and populating a subsequent PCIe Completion with at least some of the buffered data responsive to the subsequent PCIe memory request. The computer may maintain a prefetch buffer or cache structure to store data received in response to speculative read requests. When a subsequent PCIe memory request from the first entity targets an address for which speculative data has been buffered, the computer may service the request from the buffer without initiating a new CXL.mem transaction, thereby reducing the observed read latency. The buffered data may be invalidated or refreshed based on coherency requirements, timeout policies, or subsequent write operations to the same address. The computer may implement address matching logic to determine whether incoming PCIe memory requests can be satisfied from buffered speculative data.

In some implementations, the method further comprises detecting sequential access patterns in physical addresses of prior PCIe memory requests received from the first entity, and initiating the CXL.mem M2S request comprising MemSpecRd targeting a next sequential physical address. The computer may track physical addresses from consecutive PCIe memory requests received from the first entity to identify sequential access patterns indicative of linear memory traversal. Upon detecting that the first entity has accessed certain addresses in sequence, the computer may speculatively facilitate the readiness of the data from subsequent addresses before the first entity explicitly requests them. The sequential pattern detection may account for cacheline boundaries, page boundaries, or other memory organization units to optimize prefetch granularity.

In some implementations, the method further comprises detecting strided access patterns in physical addresses of prior PCIe memory requests received from the first entity, calculating a stride distance between accessed addresses, and initiating the CXL.mem M2S request comprising MemSpecRd targeting a physical address offset by the stride distance. The computer may identify non-sequential but regular access patterns wherein the first entity accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag. PCIe supports variable Tag widths depending on device capabilities and negotiated settings, including 5-bit Tags (default), 8-bit extended Tags, 10-bit Tags (for high-speed links), and 14-bit Tags (for flit mode and UIO). CXL.mem utilizes a fixed 16-bit Tag for transaction identification. The computer may translate between these different Tag formats by allocating CXL.mem Tags from a Tag pool, maintaining a mapping table between PCIe Tags and CXL.mem Tags, or implementing algorithmic Tag generation based on the PCIe Tag and additional context. The translation may also accommodate scenarios where the computer needs to maintain more outstanding CXL.mem transactions than the PCIe Tag space allows (for example, when issuing speculative CXL.mem reads independently of PCIe demand requests) by drawing from the larger CXL.mem Tag space for those additional transactions.

In some implementations of the method, the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion. CXL.mem transactions are typically cacheline-sized (64 bytes), while PCIe memory requests may specify data lengths up to 4 KB using the Length field and byte enables. When a PCIe memory request specifies a data length exceeding the cacheline size, the computer may split the request into CXL.mem M2S requests, each targeting a 64-byte cacheline. The computer may track the outstanding CXL.mem requests and may aggregate the returned data into a single PCIe Completion or into multiple PCIe Completions as permitted by PCIe. The aggregation may involve buffering data from responses, ordering the data according to address sequence, and formatting the aggregated data according to PCIe Completion requirements.

In some implementations of the method, the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion. PCIe memory requests may specify data lengths smaller than a cacheline using byte enables, requesting as little as a single doubleword (4 bytes) or even individual bytes. CXL.mem responses return cacheline-sized data regardless of the requested length. The computer may trim the returned data to the bytes requested by the first entity, aligning the data to native boundaries such as doubleword boundaries as specified by the PCIe specifications. The trimming operation may reduce the data payload size in the PCIe Completion, potentially improving bandwidth efficiency on the path between the computer and the first entity.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus for translating between Peripheral Component Interconnect Express (PCIe) Transaction Layer Packets (TLPs) and Compute Express Link (CXL) messages, comprising: a first interface configured to communicate with a first entity based on PCIe; a second interface configured to communicate with a second entity based on CXL.mem; and a computer coupled to the first interface and the second interface, wherein the computer is configured to: receive a PCIe memory request from the first entity via the first interface; translate the PCIe memory request to a CXL.mem Master-to-Subordinate (M2S) request; send, to the second entity via the second interface, the CXL.mem M2S request; receive, from the second entity via the second interface, a CXL.mem Subordinate-to-Master Data Response (S2M DRS) corresponding to the CXL.mem M2S request; translate the CXL.mem S2M DRS to a PCIe Completion; and send the PCIe Completion to the first entity via the first interface. The apparatus may be implemented as a switch, a bridge, a semiconductor device, a chiplet within an IC package, or other suitable form factor. The first interface may include PCIe physical layer components, link layer components, and transaction layer logic configured to communicate according to PCIe specifications. The second interface may include CXL physical layer components (which may share physical layer characteristics with PCIe), link layer components, and CXL.mem transaction layer logic. The computer may include translation logic, address translation tables, Tag mapping structures, and pending transaction trackers. In some examples, the apparatus and at least one of the first entity or the second entity may be included within the same IC package, optionally coupled by UCIe links or other die-to-die interconnects.

In some implementations of the apparatus, the PCIe memory request comprises a first physical address belonging to a first physical address space, the CXL.mem M2S request comprises a second physical address belonging to a second physical address space, and wherein the computer is further configured to translate between the first physical address and the second physical address. The apparatus may include address translation logic, which may be implemented using lookup tables, content-addressable memory (CAM), translation lookaside buffers (TLBs), or programmable translation functions. The translation may enable the first entity to access CXL-attached memory using addresses within its native address space while the second entity operates within its own address space. The address translation may be configured by system software, firmware, or hardware during system initialization or dynamically during operation.

In some implementations of the apparatus, the first entity comprises a GPU that does not support CXL.mem, the second entity comprises a CXL memory pool, and wherein the computer is configured to expose memory resources of the CXL memory pool to the GPU as a PCIe memory-mapped region. The apparatus may function as a bridge enabling GPUs designed with PCIe interfaces to access CXL-attached memory resources. The apparatus may expose the CXL memory pool as one or more PCIe BARs that the GPU can access using PCIe memory transactions, which may enable GPU-based AI/ML workloads to utilize memory capacities exceeding the HBM integrated within the GPU.

In some implementations of the apparatus, the computer is further configured to send, to the second entity via the second interface, a CXL.mem M2S request comprising MemSpecRd. The apparatus may include logic configured to initiate speculative memory reads to the second entity based on observed access patterns from the first entity. The speculative reads may utilize the CXL.mem MemSpecRd, which provides speculative access not available in PCIe. Data returned in response to speculative reads may be stored in a buffer within the apparatus for rapid delivery when subsequently requested by the first entity.

In some implementations of the apparatus, the apparatus is located in an active cable. The active cable may include the first interface at one end configured to connect to a PCIe device such as a GPU, and the second interface at the other end configured to connect to a CXL device such as a memory expander or memory pool. The computer may be implemented within the cable housing utilizing embedded logic. The active cable form factor may enable translation to be added to existing systems by replacing passive cables with active translation cables, possibly without requiring modifications to the connected devices.

In various implementations, a system comprising: Graphics Processing Units (GPUs), wherein at least one GPU of the GPUs does not support Compute Express Link (CXL) communications; a CXL device coupled to memory having a capacity greater than a capacity of high-bandwidth memory (HBM) of any one of the GPUs; and a computer coupled between the GPUs and the CXL device, the computer comprising: a first interface configured to communicate with the GPUs based on PCIe; and a second interface configured to communicate with the CXL device based on CXL.mem; wherein the computer is configured to: receive, from a GPU of the GPUs via the first interface, a PCIe memory request; translate the PCIe memory request to a CXL.mem Master-to-Subordinate (M2S) request; send, to the CXL device via the second interface, the CXL.mem M2S request; receive, from the CXL device via the second interface, a CXL.mem Subordinate-to-Master Data Response (S2M DRS); translate the CXL.mem S2M DRS to a PCIe Completion; and send the PCIe Completion to the GPU via the first interface. The system may enable GPUs that do not natively support CXL to access memory resources that exceed their local HBM capacity, such as for storing model parameters, intermediate computation results, KV-cache entries, or working data sets for AI/ML inference and training workloads. The CXL device may include a CXL memory expander, a CXL memory pool, a Global Fabric-Attached Memory device (GFD), or a CXL Type 2 device with device-attached memory. The memory coupled to the CXL device may be implemented using DDR5, DDR4, LPDDR, persistent memory, or combinations thereof, and may provide memory capacity and bandwidth characteristics that complement the high-bandwidth but limited-capacity HBM integrated within the GPUs. The computer may be implemented as a semiconductor device, an ASIC, a chiplet, a switch, an active cable, or other suitable form factor positioned between the PCIe domain of the GPUs and the CXL.mem domain of the CXL device. The computer may maintain per-GPU tracking structures, address translation tables, and Tag mapping resources to support concurrent translations from GPUs. In some examples, the computer and the CXL device may be included within a same IC package, optionally coupled by UCIe links or other die-to-die interconnects.

In some implementations of the system, the memory is accessible by the GPUs as a shared memory region, and wherein the computer is configured to translate PCIe memory requests from the GPUs to CXL.mem M2S requests targeting the shared memory region. The shared memory region may enable GPUs to access common data, such as model parameters, training datasets, or intermediate computation results, without requiring explicit data copying between GPUs. The computer may implement arbitration and flow control mechanisms to manage concurrent access from GPUs. The shared memory architecture may reduce total memory requirements and inter-GPU communication latency in multi-GPU systems.

In some implementations of the system, the computer maintains memory allocation information associating portions of the memory with respective GPUs, and wherein translating the PCIe memory request comprises selecting a target address within the memory based on an identity of a requesting GPU of the GPUs. The memory allocation information may enable partitioned access wherein each GPU is assigned a dedicated portion of the memory for private use. The computer may identify the requesting GPU based on the Requester ID in the PCIe memory request or other identification mechanisms, and may direct the CXL.mem M2S request to the appropriate memory partition. The partitioning may provide isolation between GPU workloads for security, fault containment, or resource management purposes.

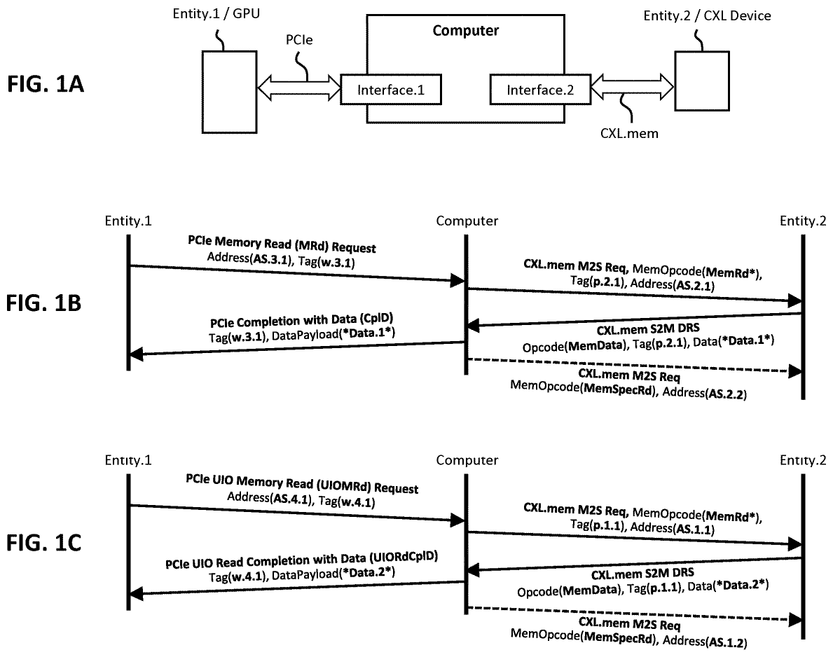

FIG. 1A illustrates an example of a system comprising a switch (e.g., a CXL switch), a processor, or a bridge, which comprises a computer coupled between a first interface (Interface.1) and a second interface (Interface.2). The first interface may communicate according to PCIe with a first entity (Entity.1), such as a GPU. The second interface may communicate according to a CXL protocol, such as CXL.mem, with a second entity (Entity.2), such as a CXL device, which may be a CXL memory expander, a CXL memory pool, or a GFD. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the PCIe domain and the CXL domain, such as translating between PCIe TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer and at least one of the first entity or the second entity may be included within the same IC package, optionally coupled by one or more UCIe links.

FIG. 1B illustrates an example of a TFD demonstrating translations, performed by a computer, between PCIe TLPs received from a first entity (Entity.1), which may be a GPU, and CXL.mem messages sent to a second entity (Entity.2), which may be a CXL device, possibly enabling the first entity to access resources mapped to an address space utilized by the second entity. The first entity may initiate a PCIe transaction that includes a PCIe Memory Read (MRd) request comprising Address(AS.3.1) and Tag(w.3.1). The computer may translate the PCIe transaction to a CXL.mem transaction that includes a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses such as translating the CXL.mem S2M DRS to a PCIe Completion with Data (CplD) comprising Tag(w.3.1) and DataPayload(*Data.1*), and may send the CplD to the first entity. The computer may perform further translations, such as protocol translations, opcode translations, command translations, or TLP translations, e.g., translating between PCIe TLPs and CXL.mem messages, wherein these translations may include field translations, such as translating between PCIe Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

FIG. 1C illustrates an example of a TFD demonstrating translations between PCIe UIO TLPs received from a first entity (Entity.1), which may be a GPU, and CXL.mem messages sent to a second entity (Entity.2) which may be a CXL device, possibly enabling the first entity to access resources mapped to an address space utilized by the second entity (Entity.2). The first entity may initiate a PCIe UIO transaction that may include a PCIe UIO Memory Read (UIOMRd) request comprising Address(AS.4.1) and Tag(w.4.1). The computer may translate the PCIe UIO transaction to a CXL.mem transaction that may include a CXL.mem M2S request comprising MemOpcode(MemRd*), Tag(p.1.1), and Address(AS.1.1), and may send the CXL.mem M2S request to the second entity. Upon receiving one or more responses from the second entity, which may include a CXL.mem S2M DRS comprising Opcode(MemData), Tag(p.1.1), and Data(*Data.2*), the computer may translate the one or more responses, such as translating the CXL.mem S2M DRS to a PCIe UIO Read Completion with Data (UIORdCplD) comprising Tag(w.4.1) and DataPayload(*Data.2*); and may send the UIORdCplD to the first entity. The computer may perform further translations, such as protocol translations, opcode translations, command translations, or TLP translations, e.g., translating between PCIe UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL.mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL.mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL.mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators'UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL.mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

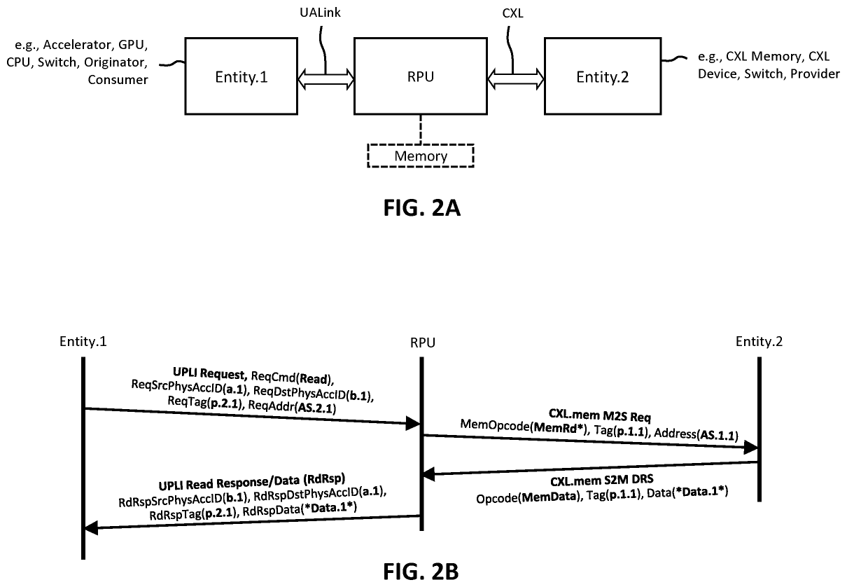

FIG. 2A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 2B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

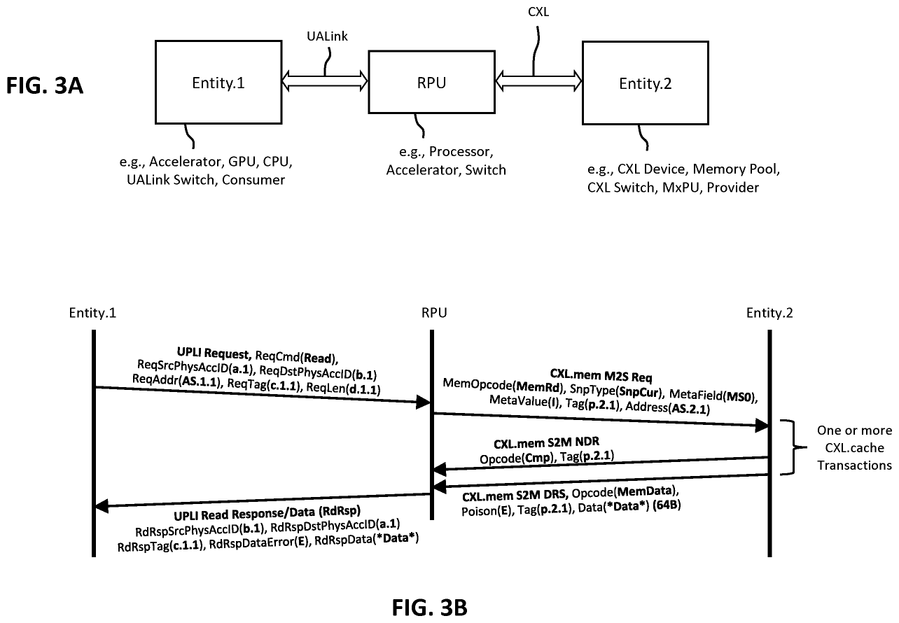

FIG. 3A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 3B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64 B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

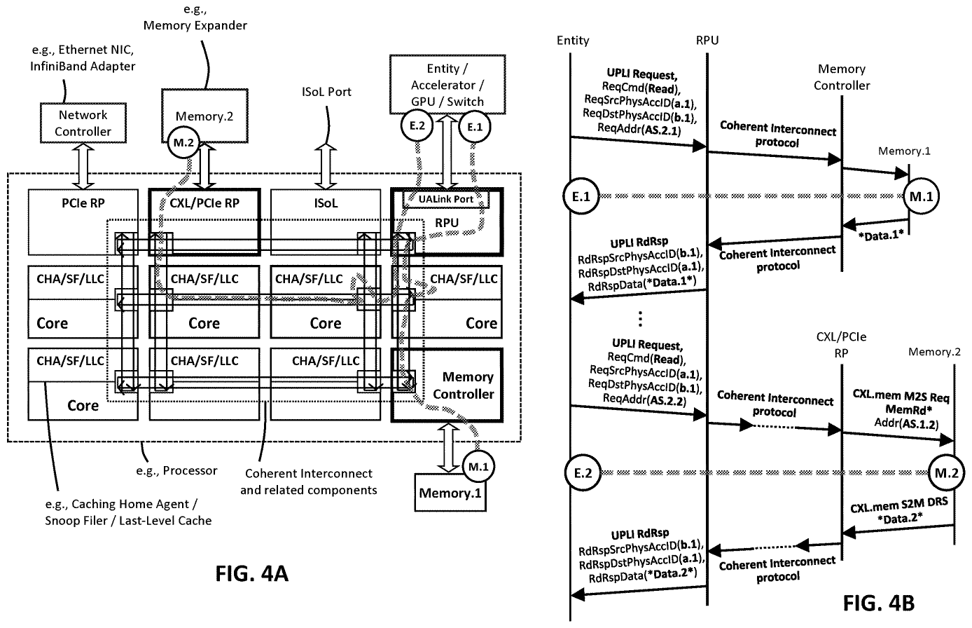

FIG. 4A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 4B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

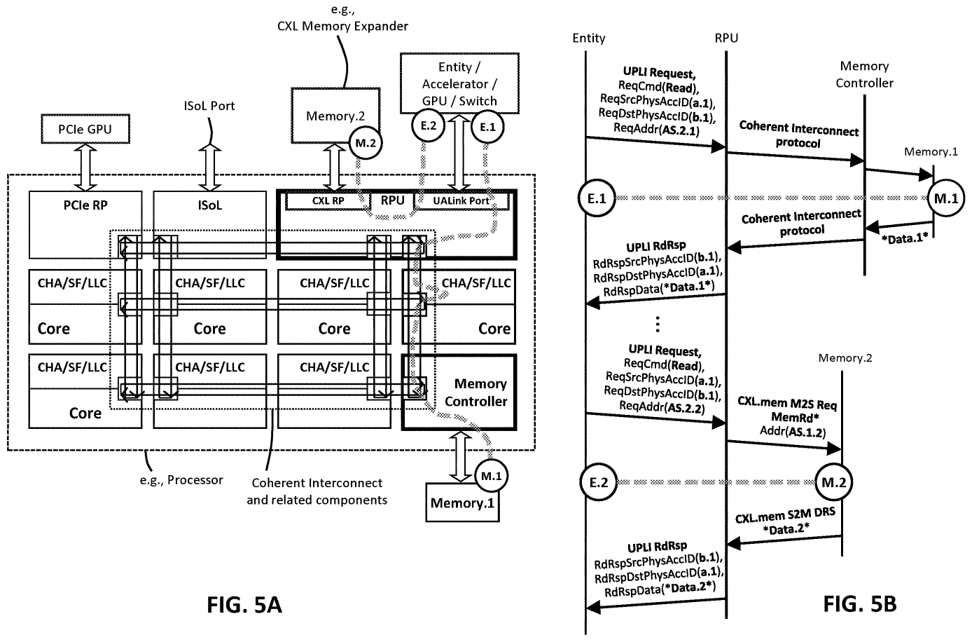

FIG. 5A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 5B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

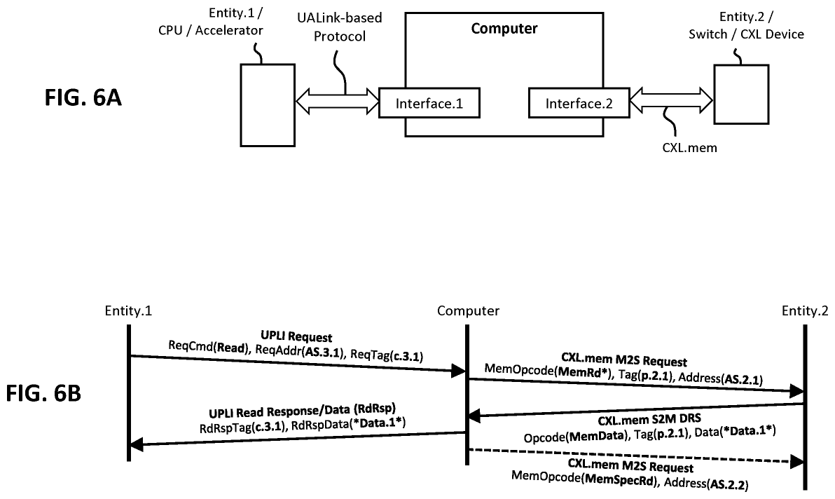

FIG. 6A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 6B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

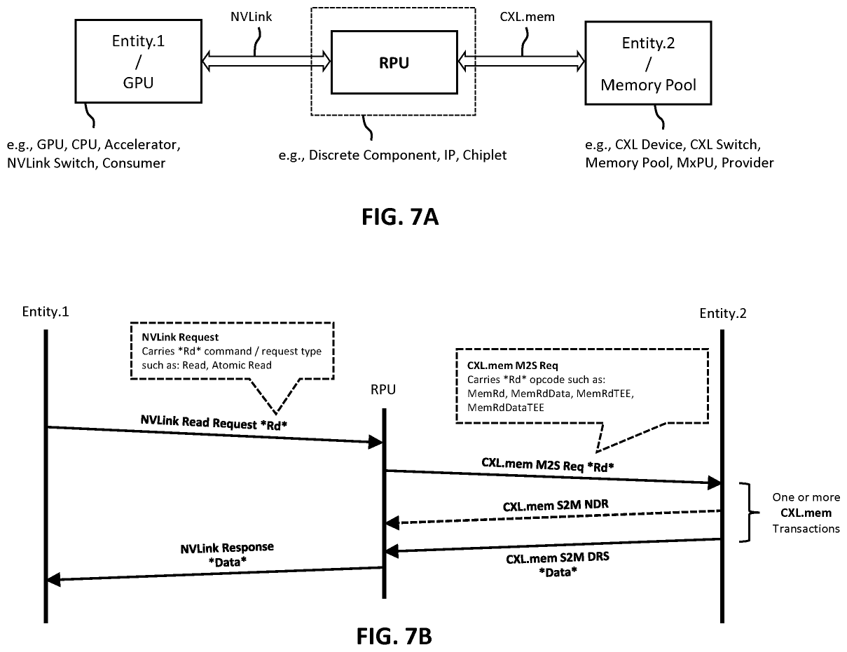

FIG. 7A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 7B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

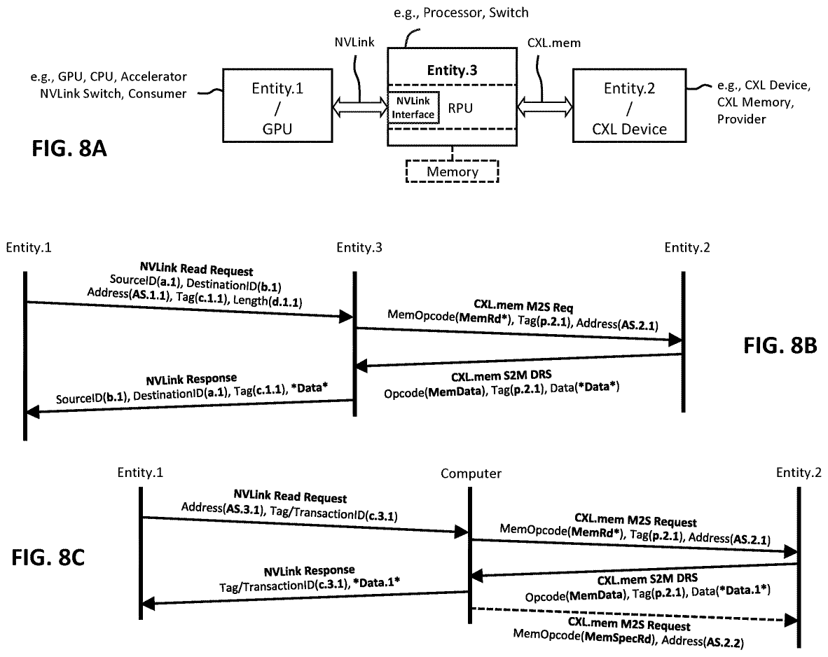

FIG. 8A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 8B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 8C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

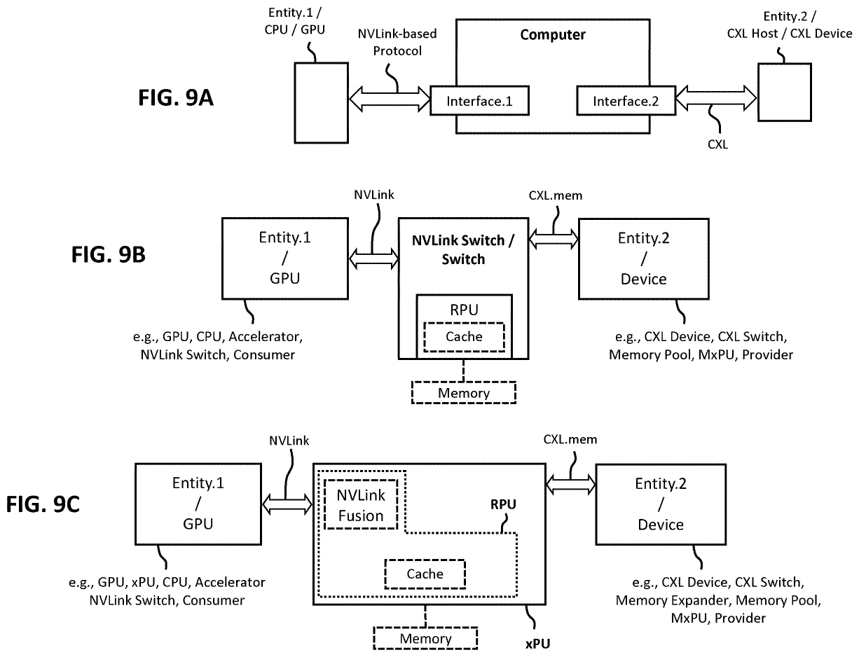

FIG. 9A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 9B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 9C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

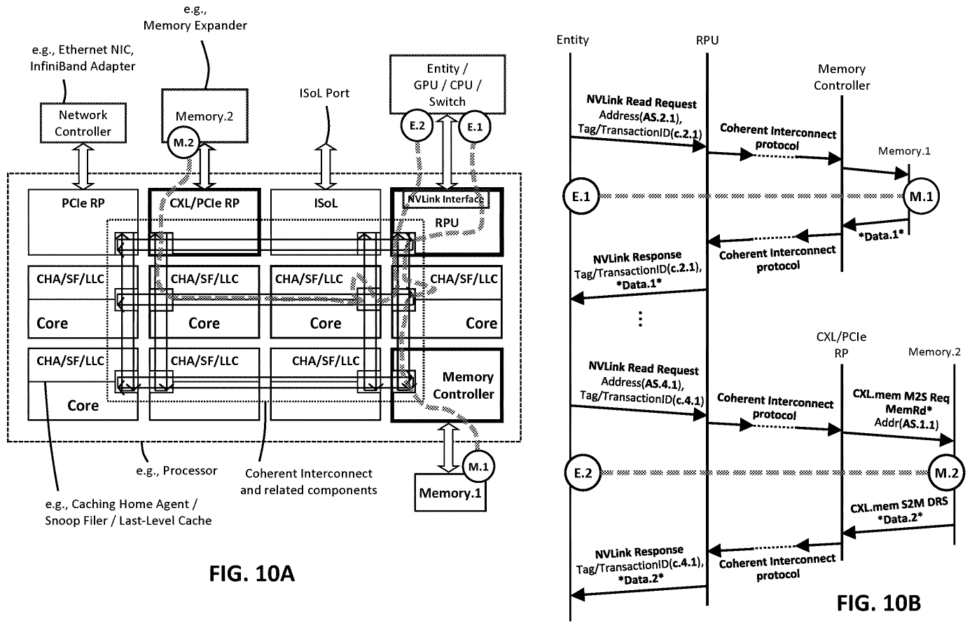

FIG. 10A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 10B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU/Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

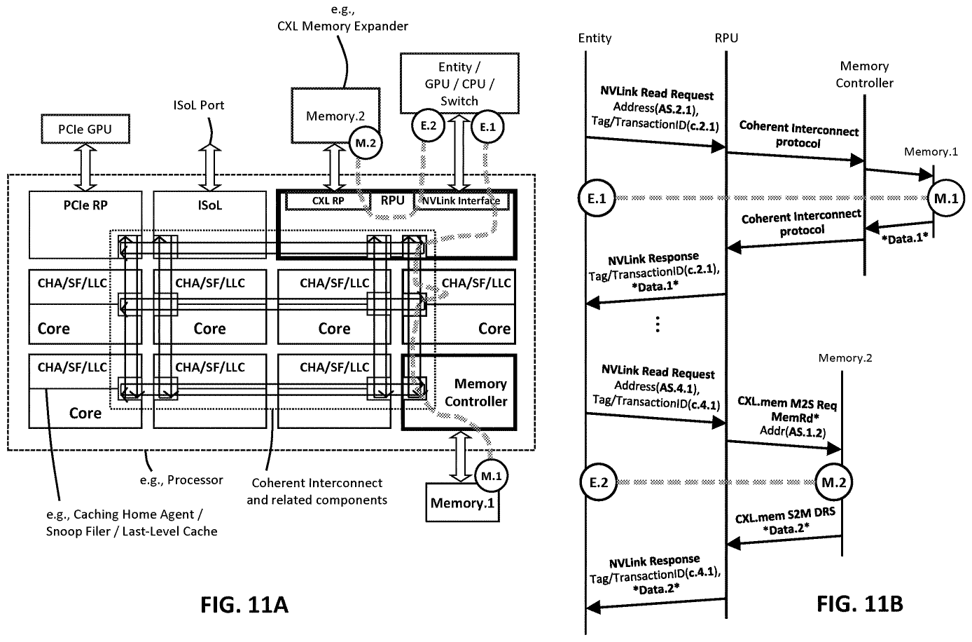

FIG. 11A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 11B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

Modern data center architectures increasingly utilize disaggregated memory systems wherein multiple compute hosts may require access to shared memory resources through different protocols and address spaces. CXL.mem enables memory access between a CXL host and CXL devices, wherein different CXL device types may utilize different CXL.mem revisions and/or instances. Translations between different CXL.mem messages may enable CXL communications between a CXL device and CXL hosts, may facilitate memory prefetching and speculative read operations to reduce access latency, and/or may enable novel architectures wherein hosts access memory devices without an intervening CXL switch, contrary to standard CXL topologies, which require a CXL switch between hosts and a Single Logical Device (SLD), a Multi-Logical Device (MLD), or a Global Fabric-Attached Memory Device (GFD), when hosts require access to the same device.

In various implementations, a method for translating between Compute Express Link (CXL) messages, comprising: receiving, from a first entity, a first CXL.mem Master-to-Subordinate (M2S) request; translating, by a computer, the first CXL.mem M2S request to a second CXL.mem M2S request, wherein value of at least one field, selected from MemOpcode, Tag, or Address, is different between the first and second CXL.mem M2S requests; and sending the second CXL.mem M2S request to a second entity. The translation between CXL.mem M2S requests may enable communication between a first entity, such as a CXL host, and a second entity, such as a CXL device that utilizes different CXL.mem revisions and/or fields values. The modified fields may affect protocol fields including physical addresses which may be carried in Address fields for address space mapping, opcodes which may be carried in MemOpcode fields for protocol semantic adaptation, or Tags for transaction management. The computer may selectively translate values of one or more of these field types depending on the incompatibility between the CXL host's protocol and the CXL device's protocol. Physical address translation may enable access across different memory domains, opcode translation may enable different operations or device type bridging, and Tag translation may enable transaction tracking across protocol boundaries.

In some implementations of the method, the first entity comprises a CXL host, and the first CXL.mem M2S request comprises a first physical address belonging to a first Host Physical Address (HPA) space utilized by the CXL host; and wherein the second entity comprises a CXL device, and the second CXL.mem M2S request comprises a second physical address within an address space exposed by the second entity. The address translation between HPA spaces may enable a CXL host to access memory resources exposed by a CXL device that utilizes a different HPA space.

In some implementations of the method, the at least one field comprises the Address, the first CXL.mem M2S request comprises a first physical address belonging to a first Host Physical Address (HPA) space utilized by the first entity, and the second CXL.mem M2S request comprises a second physical address belonging to a second HPA space utilized by the second entity. The physical address translation between HPA spaces may involve mapping memory locations from the CXL host's address space to corresponding locations in the address space utilized by the second entity. The computer may maintain address translation tables, implement base-and-offset calculations, or utilize programmable mapping functions to convert between addresses from the different address spaces. The first and second HPA spaces may differ in size, base addresses, memory layouts, or granularity, and the translation algorithm may accommodate these differences while preserving memory operation semantics.

In some implementations of the method, the at least one field comprises the MemOpcode and the Tag, the first CXL.mem M2S request comprises a first opcode and a first Tag, and the second CXL.mem M2S request comprises a second opcode and a second Tag. The first and second opcodes may correspond to different memory access behaviors, and the first and second Tags may belong to different transaction identifier queues.

In some implementations of the method, the first opcode is selected from MemRd, MemRdData, MemRdTEE, MemRdDataTEE, and MemSpecRd; and wherein the second opcode is selected from MemInv, MemRd, MemRdData, MemRdTEE, MemRdDataTEE, MemInvTEE, MemSpecRd, MemInvNT, MemInvP, MemClnEvct, MemInvPTEE, MemSpecRdTEE, MemClnEvctTEE, or MemClnEvctU. Different opcodes are typically associated with different values or different encodings of an opcode field, such as MemOpcode in CXL.mem M2S Req. For example, according to CXL 3.2 specification, MemRdData is associated with the value 0010b of MemOpcode, whereas MemRd is associated with the value 0001b of MemOpcode. The translation from MemRdData to MemRd may enable protocol adaptation between different CXL device types, wherein MemRdData may be associated with CXL Type-3 device operations while MemRd may be associated with CXL Type-2 device operations. The Tag translation may involve maintaining a bidirectional mapping between the host-side and device-side transaction identifiers.

In some implementations, the method further comprises initiating a third CXL.mem M2S request, and sending the third CXL.mem M2S request to the second entity. The computer may generate additional requests, such as speculative memory read requests or predictive read requests that may facilitate data readiness before, or without, the CXL host explicitly requesting it. The decision to initiate the additional operations may be based on pattern recognition algorithms analyzing the CXL host's memory access behavior, statistical models predicting future access locations, configurable prefetch policies defining aggressiveness and scope of speculation, and/or bandwidth availability assessments determining when additional operations that may be speculative, predictive, or performed on a best-effort basis, will not interfere with requests originated by the CXL host.

In some implementations of the method, the third CXL.mem M2S request comprises MemSpecRd; or wherein the third CXL.mem M2S request comprises MemRd*, and further comprising receiving, from the second entity, a CXL.mem S2M DRS comprising MemData. The computer may generate speculative read requests, such as CXL.mem M2S requests comprising MemSpecRd opcodes, to start a memory access before, or without, the CXL host explicitly requesting it. Speculative reads may enable latency savings, such as when the memory resource exhibits long access times, e.g., due to slow memory media, or when the memory read address references remote memory resources over a fabric or a network. Additionally or alternatively, the computer may further generate prefetch read requests, such as CXL.mem M2S requests comprising MemRd* opcodes, to prefetch data before, or without, the CXL host explicitly requesting it. The prefetched data may be stored in the computer's local buffers or caches for rapid delivery when subsequently requested.

In some implementations, the method further comprises detecting sequential access patterns in physical addresses of prior CXL.mem M2S requests received from the first entity, and initiating the third CXL.mem M2S request targeting a next sequential physical address. The computer may track physical addresses from consecutive CXL.mem M2S requests received from the CXL host to identify sequential access patterns indicative of linear memory traversal. Upon detecting that the CXL host has accessed certain addresses in sequence, the computer may speculatively prefetch data from subsequent addresses before the CXL host explicitly requests them. The sequential pattern detection may account for cacheline boundaries, page boundaries, or other memory organization units to optimize prefetch granularity.

In some implementations, the method further comprises detecting strided access patterns in physical addresses of prior CXL.mem M2S requests received from the first entity, calculating a stride distance between accessed addresses, and initiating the third CXL.mem M2S request targeting a physical address offset by the stride distance. The computer may identify non-sequential but regular access patterns wherein the CXL host accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the at least one field comprises the Address, the first CXL.mem M2S request comprises a first physical address and first MemSpecRd, and the second CXL.mem M2S request comprises a second physical address and second MemSpecRd; and further comprising translating the first physical address to the second physical address.

In some implementations of the method, the at least one field further comprises the MemOpcode, and the value of the MemOpcode is different between the first and second CXL.mem M2S requests; or wherein the first CXL.mem M2S request conforms to a first CXL specification revision, and the second CXL.mem M2S request conforms to a second CXL specification revision; and further comprising exposing, by the computer, a CXL Type-2 device or CXL Type-3 device to the first entity via a first interface, and exposing a root port to the second entity via a second interface. When the CXL host initiates its own speculative reads using MemSpecRd opcodes, the computer may perform physical address translation while preserving the speculative semantics of the request. The translation enables the host-initiated speculative operations to target the correct memory locations in the address space utilized by the second entity, enabling end-to-end speculative prefetching across different address domains. Additionally or alternatively, the translation between different CXL specification revisions may involve adapting message formats, field encodings, and protocol semantics between the revisions. For example, CXL 1.1 to CXL 2.0 translations may require handling new fields introduced in CXL 2.0, managing deprecated features from CXL 1.1, adjusting field widths or bit positions, and/or converting between different opcode encodings used in each version. The asymmetric interface configuration enables the computer to present different protocol roles to each connected entity. By exposing a CXL Type-2 or Type-3 device to the CXL host, the computer can receive memory requests as a subordinate device. By exposing a root port to the second entity (which may be a CXL device), the computer can initiate memory requests as a master. This dual-role architecture enables the computer to bridge protocols that would otherwise be incompatible due to both entities expecting to communicate with complementary protocol endpoints.

In some implementations of the method, the at least one field comprises the Address and the Tag; wherein the first CXL.mem M2S request comprises MemRd*, a first Tag, and a first physical address; and wherein the second CXL.mem M2S request comprises a second Tag and a second physical address; and further comprising receiving from the second entity a first CXL.mem Subordinate-to-Master Data Response (S2M DRS) comprising the second Tag; translating the first CXL.mem S2M DRS to a second CXL.mem S2M DRS comprising the first Tag; and sending the second CXL.mem S2M DRS to the first entity. The response translation may reverse the Tag mapping performed during request translation, ensuring that the CXL host receives responses with Tags matching its original requests. The computer may maintain a Tag translation table or utilize algorithmic Tag generation to translate between device-side Tags (second Tag) and host-side Tags (first Tag). Additionally, the computer may consolidate or filter response messages, potentially absorbing No Data Response messages while forwarding only Data Response messages to simplify the message flow.

In some implementations of the method, the second entity comprises a Global Fabric-Attached Memory (G-FAM) or a Global Fabric-Attached Memory Device (GFD); and wherein there is no CXL switch positioned between the computer and the second entity; and further comprising receiving, from a third entity, a third CXL.mem M2S request, translating the third CXL.mem M2S request to a fourth CXL.mem M2S request, and sending the fourth CXL.mem M2S request to the second entity; and wherein there is no CXL switch positioned between the computer and the third entity. The CXL specification mandates that GFDs connect through a Virtual CXL Switch (VCS) for proper protocol handling and routing. This implementation bypasses that requirement by having the computer perform the applicable translations and routing functions, eliminating the CXL switch from the topology. Removing the switch traversal delays may reduce latency, reduce cost by eliminating switch hardware, and/or simplify system configuration by reducing the number of CXL components requiring management. The translation of requests from multiple entities to a common destination entity, without an intervening CXL switch, may enable topologies where the computer aggregates traffic from multiple sources. The computer may maintain separate translation contexts for each source entity to preserve transaction isolation and enable independent address mappings.

In some implementations of the method, the third entity comprises a second CXL host, the second entity comprises a CXL device, and there is no CXL switch positioned between the third entity and the second entity. The computer enables multi-host access the same CXL device, without the CXL switch typically required for such multi-host configurations, by implementing separate translation contexts for each host, including independent address mappings, Tag translations, and transaction queues. The computer may also implement arbitration algorithms to fairly schedule requests from multiple hosts, coherency protocols to manage shared memory access, and isolation algorithms to prevent unauthorized cross-host memory access.

In some implementations, the method further comprises receiving, from a third entity, a third CXL.mem M2S request, translating the third CXL.mem M2S request to a fourth CXL.mem M2S request, and sending the fourth CXL.mem M2S request to the second entity; wherein the second entity exposes memory, and there is no CXL switch positioned between the computer and the second entity. The memory-exposing entity, such as a memory-exposing CXL device, may be accessed by hosts through the computer's translations without requiring a CXL switch. The computer may implement memory virtualization to present each host with its own view of the device's memory, memory partitioning to allocate specific regions to each host, or memory pooling to dynamically assign memory resources based on demand. The translation may ensure that each host's memory operations target the appropriate memory regions while maintaining isolation and coherency as required.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second entities; a computer configured to:
receive a first CXL.mem Master-to-Subordinate (M2S) request from the first entity, wherein CXL denotes Compute Express Link; translate the first CXL.mem M2S request to a second CXL.mem M2S request, wherein value of at least one field, selected from MemOpcode, Tag, or Address, is different between the first and second CXL.mem M2S requests; and send the second CXL.mem M2S request to the second entity. The translation enables communication between components that may utilize different addressing schemes, Tag management conventions, and/or memory operation types, which enables flexible system topologies where entities need not share compatible protocol parameters.

In some implementations of the system, the second entity comprises a second CXL device of a second type, the computer exposes resources associated with the second entity to the first entity via a first CXL device of a first type, and the first type and the second type are different. The translation may further enable abstraction of component identities, such as exposing resources associated with a CXL Type-3 device as a CXL Type-2 device, or exposing resources associated with a CXL Type-2 device as a CXL Type-1 device.

In some implementations of the system, the second entity comprises a CXL Type-3 device, and wherein the computer exposes resources associated with the second entity to the first entity via a CXL Type-2 device. Exposing resources associated with a CXL Type-3 device as a CXL Type-2 device may enable different caching behaviors or coherency models than those natively supported by the Type-3 device.

In some implementations of the system, the second entity comprises a CXL Type-2 device, and wherein the computer exposes memory resources associated with the second entity to the first entity via a CXL Type-3 device. Exposing memory resources associated with a CXL Type-2 device as a CXL Type-3 device may enable simplified memory access semantics for hosts that do not require the full capabilities of Type-2 devices, potentially reducing complexity in system configurations.

In some implementations, the system further comprises a third entity, wherein the computer is further configured to: receive a third CXL.mem M2S request from the third entity; translate the third CXL.mem M2S request to a fourth CXL.mem M2S request, wherein value of at least one field, selected from MemOpcode, Tag, or Address, is different between the third and fourth CXL.mem M2S requests; and send the fourth CXL.mem M2S request to the second entity. The ability of the computer to aggregate and translate requests from multiple sources to a common destination entity enables the multi-host or multi-initiator configuration with the third entity. The computer may perform independent translations for each source entity, enabling per-entity address mapping, Tag namespace management, and/or opcode policies. This enables the second entity, such as a CXL memory device, to serve multiple initiators through the same physical interface while maintaining logical separation of their respective transactions.

In some implementations of the system, the first entity comprises a first host, the third entity comprises a second host, the second entity comprises a CXL device, and there is no CXL switch positioned between the CXL device and the first and second hosts. The CXL specification requires SLDs, MLDs, and GFDs to connect to multiple hosts through a VCS within a CXL switch. This implementation eliminates the requirement for a CXL switch by using the computer to perform the applicable translations, routing decisions, and multi-host coordination functions. The computer may implement the logical equivalent of VCS functionality while operating as a translation unit rather than a switch component, enabling new deployment models and system architectures not contemplated by the standard CXL topology requirements.

In some implementations of the system, the computer is further configured to maintain separate address translation tables for the first and third entities, mapping first and third addresses from first and third address spaces utilized by the first and third entities, respectively, to second addresses within a second address space utilized by the second entity. The separate address translation tables may enable memory isolation between the entities, such as between hosts, preventing unauthorized cross-host memory access. Each translation table may map a host's virtual view of a CXL device to distinct physical regions, implementing hardware-enforced memory protection without requiring CXL switch-based isolation mechanisms. Mapping to non-overlapping regions may enable memory pooling and ensure that memory operations from one host cannot inadvertently or maliciously access another host's allocated memory space, whereas mapping to overlapping regions may enable memory sharing between hosts.

In some implementations of the system, the second entity comprises a second CXL device, and wherein the computer exposes resources associated with the second entity to the first entity via a first CXL device and to the third entity via a third CXL device. The virtualization of the single physical CXL device, such as a memory expander, into multiple virtual devices enables each host to operate as if it has exclusive access to a dedicated memory expander. The computer may present different capacity values, latency characteristics, bandwidth allocations, or feature sets to each host through the virtual device abstraction. This virtualization may include managing separate configuration spaces, capability registers, and control interfaces for each virtual device instance.

In various implementations, a method for enabling multi-host access to a Compute Express Link (CXL) device, comprising: receiving, from a first entity, a first CXL.mem Master-to-Subordinate (M2S) request carrying a first physical address; receiving, from a second entity, a second CXL.mem M2S request carrying a second physical address; translating the first and second physical addresses to third and fourth physical addresses within an address space utilized by a CXL device; generating third and fourth CXL.mem M2S requests comprising the third and fourth physical addresses, respectively; and sending the third and fourth CXL.mem M2S requests to the CXL device. A standard CXL switch typically uses HDM decoders for routing purposes in order to determine which downstream port (DPID/Port ID) should receive the request, and then forwards the original request containing the HPA. Additionally, the standard CXL switch does not perform the HPA-to-DPA translation itself when acting as a router to an endpoint device like an MLD/MHD. This implementation overcomes these limitations by interposing address translation and request routing logic between the CXL hosts and the CXL device. The translation of physical addresses may enable each host to maintain its own memory view while the CXL device may utilize a separate address space, with the translation logic managing the mapping between addresses from the host address spaces and the address space utilized by the CXL device.

In some implementations of the method, the first and second entities comprise first and second CXL hosts, respectively, the CXL device comprises a CXL memory expander, the first and second physical addresses from the first and second CXL hosts target overlapping memory regions, and further comprising implementing coherency control between the first and second CXL hosts for the overlapping memory regions. When hosts access overlapping memory regions, the computer may implement coherency mechanisms including snoop filtering to track which host has cached copies of specific memory lines, invalidation broadcasting to notify hosts when shared data is modified, and/or lock management to serialize concurrent access to the same memory locations. These coherency controls operate independently of CXL switch-based coherency mechanisms, implementing coherency protocols within the translation logic.

In some implementations of the method, the CXL device comprises a CXL memory expander, and further comprising implementing quality-of-service (QoS) policies associated with the first and second entities, wherein the QoS policies comprise bandwidth allocation or latency prioritization for memory accesses to the CXL memory expander. The QoS implementation may prevent an entity (such as a CXL host) from monopolizing the memory expander's resources while guaranteeing minimum performance levels for predetermined workloads. Bandwidth allocation may utilize token bucket algorithms, rate limiting mechanisms, or credit-based flow control to regulate the rate of requests forwarded from each entity. Latency prioritization may involve request reordering based on configured priority levels, deadline scheduling for time-sensitive operations, and/or preferential queue management for high-priority entities.

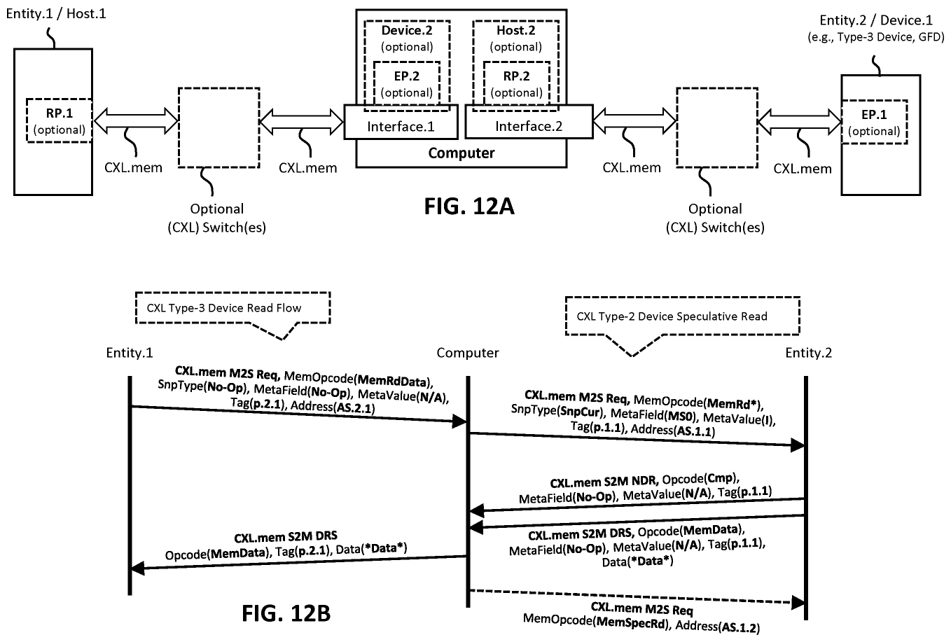

FIG. 12A illustrates an example of a system comprising a computer coupled between a first interface (Interface.1) and a second interface (Interface.2), wherein both the first and second interfaces may communicate according to CXL.mem. The first interface may expose resources associated with a second device (Device.2), such as a CXL type-2 device or a CXL type-3 device, optionally comprising a second endpoint (EP.2), and may communicate according to CXL.mem with a first entity (Entity.1), such as a first host (Host.1), possibly via a first root port (RP.1) of the first host. The second interface may expose a root port (RP.2), via which the computer may communicate as a second host (Host.2) according to CXL.mem with a second entity (Entity.2), such as a first CXL device (Device.1), which may include a first endpoint (EP.1). Additionally or alternatively, the first CXL device may include a Global Fabric-Attached Memory (G-FAM) Device (GFD). The computer may extract physical addresses from messages received via the first interface, wherein these addresses may be from a first HPA space utilized by the first host; translate these addresses; and generate messages carrying the translated physical addresses for transmission via the second interface; wherein these translated addresses may correspond to a physical address space exposed by the computer over the second interface. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 12B illustrates an example of a transaction flow diagram (TFD) demonstrating translations, optionally performed by a computer, between first CXL.mem messages received from a first entity (Entity.1), such as a first host (Host.1), that may utilize a first CXL.mem, and second CXL.mem messages, sent to a second entity (Entity.2), such as a first CXL device (Device.1), that may utilize a second CXL.mem, possibly enabling the computer to abstract resources of the second entity, and possibly enabling the first entity to access resources of the second entity utilizing different memory flow types, such as utilizing optimized type-3 memory flows, instead of type-2 memory flows that may be utilized by the second entity. Additionally or alternatively, the computer may further initiate speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemRdData), SnpType(No-Op), MetaField(No-Op), MetaValue(N/A), Tag(p.2.1), and Address(AS.2.1). The computer may translate the first CXL.mem transaction to a second CXL.mem transaction that may include a second CXL.mem M2S Req comprising MemOpcode(MemRd*), SnpType(SnpCur), MetaField(MS0), MetaValue(I), Tag(p.1.1), and Address(AS.1.1), and may send the second CXL.mem M2S Req to the second entity. Upon receiving one or more responses from the second entity, that may include a CXL.mem S2M NDR comprising Opcode(Cmp), MetaField(No-Op), MetaValue(NA), and Tag(p.1.1), and may further include a first CXL.mem S2M DRS comprising Opcode(MemData), MetaField(No-Op), MetaValue(NA), Tag(p.1.1), and Data(*Data*), the computer may translate the one or more responses from the second entity to a second CXL.mem S2M DRS comprising Opcode(MemData), Tag(p.2.1), and Data(*Data*), and may send the second CXL.mem S2M DRS to the first entity.

One example of a speculative memory read targeting the second entity includes a CXL.mem M2S Req comprising MemOpcode(MemSpecRd) and Address(AS.1.2), which may utilize the speculative memory reads, optionally on behalf of the first entity, to facilitate data prefetches and potentially reduce read latency from the second entity. When utilizing MemSpecRd, some of the CXL.mem M2S Req fields, such as Tag, MetaField, MetaValue, and SnpType, may be reserved. The computer may perform further translations, such as opcode translations, e.g., translating between a first CXL.mem M2S Req opcode, such as MemRdData, and a second CXL.mem M2S Req opcode, such as MemRd. The computer may further perform other translations, such as field translations between messages conforming to the first CXL.mem and messages conforming to the second CXL.mem, such as translations between CXL.mem Tags of the two protocols, translations between values of reserved fields of the two protocols, and translations between values of reserved and non-reserved fields of the two protocols. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

In some examples, the computer may act as a second device (Device.2), such as a CXL type-3 device or CXL type-2 device optionally comprising a protocol endpoint, and terminate the first CXL.mem transaction. The computer may then issue the second CXL.mem transaction, optionally acting as an independent protocol initiator, such as a second host (Host.2), and may utilize translated fields from the first CXL.mem transaction for constructing the second CXL.mem transaction. In other examples, the computer may maintain, at least partly, an end-to-end transaction context along the path between the first entity and the second entity, optionally without terminating CXL.mem transactions received from the first entity, such as by preserving, at least partly, transaction-related identification fields. In one example, the computer may reuse CXL.mem Tags received from the first entity for constructing CXL.mem Tags sent to the second entity, hence optionally preserving, at least partly, a transaction identifier over the path between the first entity and the second entity, for maintaining, at least partly, an end-to-end transaction context along that path.

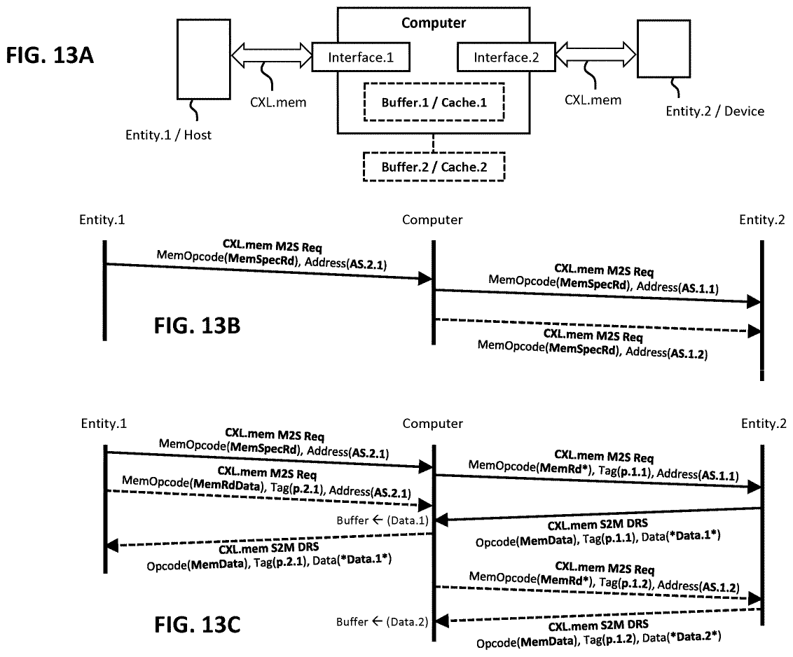

FIG. 13A illustrates an example of a system comprising a computer coupled between a first interface (Interface.1) and a second interface (Interface.2), wherein both the first and second interfaces may communicate according to CXL.mem. The first interface may communicate according to first CXL.mem with a first entity (Entity.1), such as a host. The second interface may communicate according to second CXL.mem with a second entity (Entity.2), such as a device, such as a CXL type-3 device or a Global Fabric-Attached Memory (G-FAM) Device (GFD). The computer may extract field values, such as addresses, opcodes, or Tags, from messages received via the first interface; translate one or more of these field values; and generate messages carrying the translated field values for transmission via the second interface. The computer may include a first buffer (Buffer.1) or a first cache (Cache.1), and may be coupled to a second buffer (Buffer.2) or a second cache (Cache.2). The computer may utilize the buffers or caches for storing data, such as data read from the second entity, data written to the second entity, or data prefetched by the computer from the second entity. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 13B illustrates an example of a TFD demonstrating translations, optionally performed by a computer, between CXL.mem M2S MemSpecRd requests received from a first entity (Entity.1), such as a host, that may utilize a first CXL.mem, and CXL.mem M2S MemSpecRd requests sent to a second entity (Entity.2), such as a CXL device, that may utilize a second CXL.mem, possibly enabling the computer to facilitate data readiness and reduce read latency from the second entity. Additionally or alternatively, the computer may initiate further speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemSpecRd) and Address(AS.2.1). When utilizing MemSpecRd, some of the CXL.mem M2S Req fields, such as Tag, MetaField, MetaValue, and SnpType, may be reserved. The computer may translate the first CXL.mem transaction to a second CXL.mem transaction that may include a second CXL.mem M2S Req comprising MemOpcode(MemSpecRd) and Address(AS.1.1), and may send the second CXL.mem M2S Req to the second entity. In some examples, the computer may further translate the first CXL.mem transaction to a third CXL.mem transaction that may include a third CXL.mem M2S Req comprising MemOpcode(MemSpecRd) and Address(AS.1.2), and may send the third CXL.mem M2S Req to the second entity, possibly facilitating the readiness of further data reads that may be expected from the first entity. The computer may further perform other translations, such as translations between messages conforming to the first CXL.mem and messages conforming to the second CXL.mem, translations between reserved fields, and/or translations between reserved and non-reserved fields. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

FIG. 13C illustrates an example of a TFD demonstrating translations between CXL.mem messages received from a first entity (Entity.1), such as a host, that may utilize a first CXL.mem, and CXL.mem messages sent to a second entity (Entity.2), such as a CXL device, that may utilize a second CXL.mem, possibly enabling the computer to abstract resources of the second entity and to facilitate data readiness and reduce read latency by prefetching data from the second entity. The first entity may initiate a speculative memory read by initiating a first CXL.mem transaction that may include a first CXL.mem M2S Req comprising MemOpcode(MemSpecRd) and Address(AS.2.1), wherein the first entity may send the first CXL.mem M2S Req to the computer. When utilizing MemSpecRd, some of the CXL.mem M2S Req fields, such as Tag, MetaField, MetaValue, and SnpType, may be reserved. The computer may translate the speculative memory read to a demand read, such as by translating the first CXL.mem transaction to a second CXL.mem transaction that may include a second CXL.mem M2S Req comprising MemOpcode(MemRd*), Tag(p.1.1), and Address(AS.1.1), wherein the computer may send the second CXL.mem M2S Req to the second entity.

Upon receiving one or more responses from the second entity, that may include a first CXL.mem S2M DRS comprising Opcode(MemData), Tag(p.1.1), and Data(*Data.1*), the computer may store *Data.1* in a buffer or a cache, and may further respond to an outstanding read request, if exists, from the first entity, such as a third CXL.mem transaction that may include a third CXL.mem M2S Req comprising MemOpcode(MemRdData), Tag(p.2.1), and Address(AS.2.1), wherein the computer may respond to this request with a second CXL.mem S2M DRS comprising Opcode(MemData), Tag(p.2.1), and Data(*Data.1*), and may send the second CXL.mem S2M DRS to the first entity. Optionally, such as in order to prefetch the next data from the second entity, the computer may further translate the first CXL.mem transaction to a fourth CXL.mem transaction that may include a fourth CXL.mem M2S Req comprising MemOpcode(MemRd*), Tag(p.1.2), and Address(AS.1.2), and may send the fourth CXL.mem M2S Req to the second entity. Upon receiving one or more responses from the second entity, that may include a third CXL.mem S2M DRS comprising Opcode(MemData), Tag(p.1.2), and Data(*Data.2*), the computer may store *Data.2* in the buffer or the cache, wherein the prefetched *Data.2* may be ready for consumption by the first entity, potentially reducing read latency from the second entity as perceived from the first entity. The computer may perform further translations, such as opcode translations, e.g., translating between a first CXL.mem M2S Req opcode, such as MemSpecRd, and a second CXL.mem M2S Req opcode, such as MemRd*.

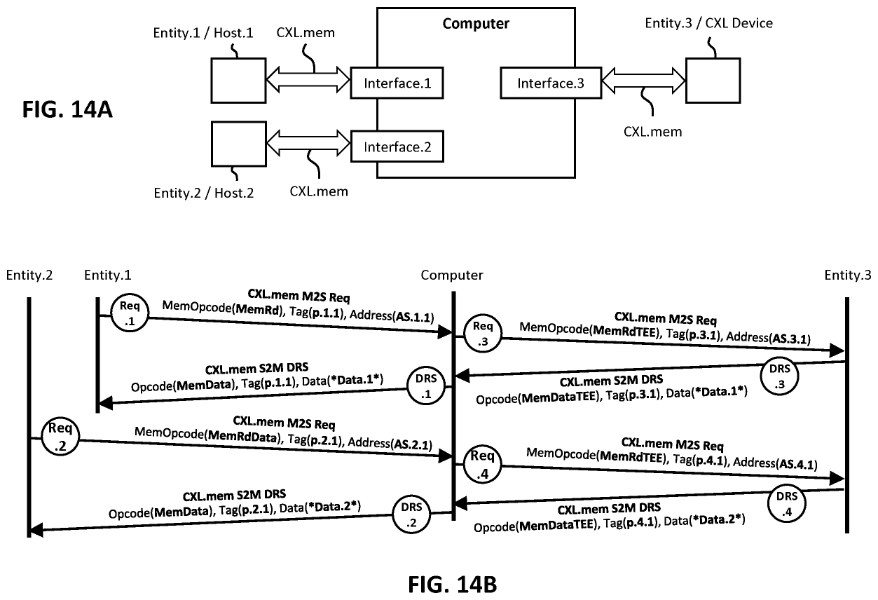

FIG. 14A illustrates an example of a system comprising a computer coupled to a first interface (Interface.1), a second interface (Interface.2), and a third interface (Interface.3). The computer may: (i) receive, via the first interface, a first CXL.mem Master-to-Subordinate request (M2S request) from a first entity (Entity.1), such as a first host (Host.1); (ii) receive, via the second interface, a second CXL.mem M2S request from a second entity (Entity.2), such as a second host (Host.2); (iii) translate the first and second CXL.mem M2S requests to third and fourth CXL.mem M2S requests, respectively; and (iv) send, via the third interface, the third and fourth CXL.mem M2S requests to a third entity (Entity.3), such as a CXL device, that may include an endpoint (EP). Additionally or alternatively, the CXL device may include a Global Fabric-Attached Memory (G-FAM) Device (GFD). In some examples, the computer may further: (i) extract first values of fields, such as first addresses, first opcodes, or first Tags, from messages received via the first interface, translate these first values, and generate messages carrying the translated first values for transmission via the third interface; and/or (ii) extract second values of fields, such as second addresses, second opcodes, or second Tags, from messages received via the second interface, translate these second values, and generate messages carrying the translated second values for transmission via the third interface. In some examples, the computer and at least one of the first entity, the second entity, and the third entity, may be included within the same IC package, optionally coupled via one or more UCIe links.

FIG. 14B illustrates an example of a TFD demonstrating translations, such as translations, optionally performed by a computer, between CXL.mem M2S requests received from a first entity (Entity.1) and a second entity (Entity.2), and CXL.mem M2S requests sent to a third entity (Entity.3), such as a CXL device, possibly enabling the computer to abstract resources of the third entity, such as memory resources, and to expose these resources to the first entity, which may be a first host (Host.1), and to the second entity, which may be a second host (Host.2). In some examples, the translations may enable two hosts to access memory resources of a CXL device. The first entity may initiate a first CXL.mem M2S request (marked as Req.1) comprising MemOpcode(MemRd), Tag(p.1.1), and Address(AS.1.1). The computer may translate the first CXL.mem M2S request to a third CXL.mem M2S request (marked as Req.3) comprising MemOpcode(MemRdTEE), Tag(p.3.1), and Address(AS.3.1), and may send the third CXL.mem M2S request to the third entity. Upon receiving one or more responses from the third entity, which may include a third CXL.mem S2M DRS (marked as DRS.3) comprising Opcode(MemDataTEE), Tag(p.3.1), and Data(*Data.1*), the computer may translate the third CXL.mem S2M DRS to a first CXL.mem S2M DRS (marked as DRS.1) comprising Opcode(MemData), Tag(p.1.1), and Data(*Data.1*), and may send the first CXL.mem DRS to the first entity.

Similarly, the second entity may initiate a second CXL.mem M2S request (marked as Req.2) comprising MemOpcode(MemRdData), Tag(p.2.1), and Address(AS.2.1). The computer may translate the second CXL.mem M2S request to a fourth CXL.mem M2S request (marked as Req.4) comprising MemOpcode(MemRdTEE), Tag(p.4.1), and Address(AS.4.1), and may send the fourth CXL.mem M2S request to the third entity. Upon receiving one or more responses from the third entity, which may include a fourth CXL.mem S2M DRS (marked as DRS.4) comprising Opcode(MemDataTEE), Tag(p.4.1), and Data(*Data.2*), the computer may translate the fourth CXL.mem S2M DRS to a second CXL.mem S2M DRS (marked as DRS.2) comprising Opcode(MemData), Tag(p.2.1), and Data(*Data.2*), and may send the second CXL.mem DRS to the second entity. The computer may perform further translations, such as opcode translations, e.g., translating between CXL.mem M2S request comprising MemRdData, and CXL.mem M2S request comprising MemRdTEE, possibly enabling confidential computing and Trusted Execution Environment (TEE), such as by protecting data-at-rest via encryption. The computer may further perform other translations, such as Tag translations between CXL.mem messages, translations between reserved fields, and/or translations between reserved and non-reserved fields. In some examples, the computer may translate between CXL.mem conforming to different CXL revisions, such as translating between transactions of CXL.mem conforming to CXL 1.1, which may be utilized by the first entity, and transactions of CXL.mem conforming to CXL 4.0, which may be utilized by the third entity.

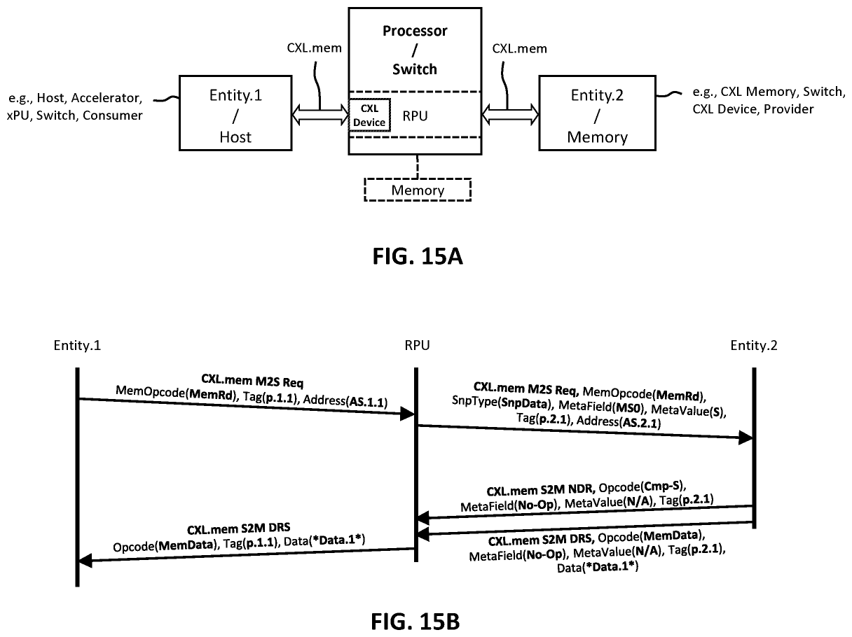

FIG. 15A illustrates an example of a system comprising a processor or a switch, which may include or may be coupled to memory, and may further include an RPU with a CXL device, such as a Global Fabric-Attached Memory (G-FAM) Device (GFD), or a Type-3/2/1 CXL device, enabling external entities to access resources coupled to the processor via the CXL device. The processor is coupled to a first entity (Entity.1), which may be a host, an accelerator, an xPU, or a second switch, wherein the processor may communicate with the first entity according to a first CXL.mem. The processor is further coupled to a second entity (Entity.2), which may be a CXL memory, a CXL device, or a third switch, wherein the processor may communicate with the second entity according to a second CXL.mem. In some examples, the first and second CXL.mem may be associated with first and second physical address spaces, respectively, wherein the RPU may perform address translations between addresses within the first and second physical address spaces, respectively. In other examples, the first and second CXL.mem may be associated with the same physical address space, wherein the RPU may perform address translations between addresses within the same physical address space.

The RPU may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The RPU may further perform other translations, such as translations between messages conforming to the first and second CXL.mem, such as Tag translations and traffic class (TC) translations. In some examples, the RPU may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second entity. In some examples, the RPU may translate between CXL.mem type-3 memory flows and CXL.mem type-2 memory flows, such as CXL.mem transactions that may include CXL.mem S2M NDR responses.

FIG. 15B illustrates an example of a TFD demonstrating translations performed by a processor, a switch, or by an RPU, between a first CXL.mem utilized for communicating with a first entity (Entity.1), such as a host, and a second CXL.mem utilized for communicating with a second entity (Entity.2), such as a CXL device or CXL memory. The first entity may initiate a first CXL.mem transaction that includes a first CXL.mem M2S request comprising MemOpcode(MemRd*), Tag(p.1.1), and Address(AS.1.1). The RPU may translate the first CXL.mem transaction to a second CXL.mem transaction that includes a second CXL.mem M2S request comprising MemOpcode(MemRd), SnpType(SnpData), MetaField(MS0), MetaValue(S), Tag(p.2.1), and Address(AS.2.1), wherein the RPU may send the second CXL.mem M2S request to the second entity. The second entity may respond to the second CXL.mem M2S request with a CXL.mem S2M NDR comprising Opcode(Cmp-S), MetaField(No-Op), MetaValue(NA), and Tag(p.2.1), and may further respond with a first CXL.mem S2M DRS comprising Opcode(MemData), MetaField(No-Op), MetaValue(NA), Tag(p.2.1), and Data(*Data.1*), wherein the RPU may translate the first CXL.mem S2M DRS to a second CXL.mem S2M DRS comprising Opcode(MemData), Tag(p.1.1), and Data(*Data.1*). Optionally, the RPU may act as a protocol endpoint and terminate the first CXL.mem transaction. The RPU may issue the second CXL.mem transaction, optionally acting as an independent protocol initiator, such as a CXL host, and may utilize translated fields from the first CXL.mem transaction for constructing the second CXL.mem transaction. In other examples, the RPU may maintain end-to-end transaction contexts of CXL.mem between the first entity and the second entity, without terminating the CXL.mem transactions, such as by preserving transaction-related identifications such as Tags, and optionally translating other fields such as address fields.

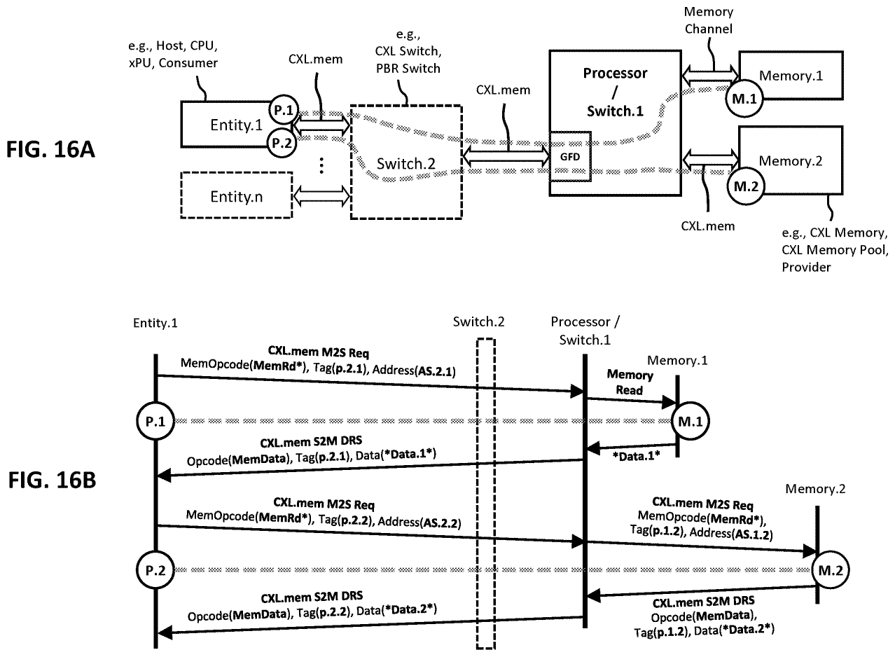

FIG. 16A illustrates an example of a system comprising a processor or a first switch (Switch.1), which may be coupled to a first memory (Memory.1), such as DRAM, via a memory channel, and may be further coupled to a second memory (Memory.2), such as CXL memory, a CXL memory pool, or a CXL-based provider. The processor may include a Global Fabric-Attached Memory (G-FAM) Device (GFD), which may be coupled to one or more entities, such as first entity (Entity.1), optionally via a second switch (Switch.2), such as a CXL switch or a PBR switch, enabling the one or more entities to access, via the GFD, resources coupled to the processor, such as via one or more of the two illustrated paths denoted as (P.1)-(M.1) and (P.2)-(M.2). In some examples, the number of entities, denoted by the parameter n of (Entity.n) may exceed 16. The processor may communicate with the first entity, which may be a host, a CPU, an xPU, or a consumer, according to a first CXL-based protocol, such as a first CXL.mem. The processor may communicate with the second memory, according to a second CXL-based protocol, such as a second CXL.mem.

In some examples, the first and second CXL.mem may be associated with first and second physical address spaces, respectively, such as first and second Host Physical Address (HPA) spaces, wherein the processor may perform address translations between addresses within the first and second physical address spaces, respectively. In other examples, the first and second CXL.mem may be associated with the same physical address space, wherein the processor may perform address translations between addresses within the same physical address space. The processor may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The processor may further perform other translations, such as translations between messages conforming to the first and second CXL.mem, traffic class (TC) translations, and/or Tag translations. The processor may maintain tracking between Tags associated with the first CXL.mem and Tags associated with the second CXL.mem, such as in order to associate responses with their corresponding requests. In some examples, the processor may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second memory.

FIG. 16B illustrates an example of a TFD demonstrating two CXL.mem transactions between a first entity (Entity.1), such as a host, and a processor, or a first switch (Switch.1), corresponding to two distinct memory read paths denoted as (P.1)-(M.1) and (P.2)-(M.2), each associated with a different physical address mapped to different memory resources. The drawing further illustrates translations performed by the processor (or by Switch.1), between a first CXL.mem utilized for communicating with the first entity, and a second CXL.mem utilized for communicating with a second memory (Memory.2), such as a CXL memory, wherein the communication between the processor and the first entity may be performed via a Global Fabric-Attached Memory (G-FAM) Device (GFD) and optionally via a second switch (Switch.2).

The first CXL.mem transaction received by the processor from the first entity includes a first CXL.mem M2S request comprising MemOpcode(MemRd*), Tag(p.2.1), and Address(AS.2.1), which the processor may translate and forward, optionally via an internal interconnect of the processor, via a memory controller, and via a memory channel, to a first memory (Memory.1), resulting in the retrieval of *Data.1*, that the processor sends to the first entity via a first CXL.mem S2M DRS comprising Opcode(MemData), Tag(p.2.1), and Data(*Data.1*).

The second CXL.mem transaction received by the processor from the first entity includes a second CXL.mem M2S request comprising MemOpcode(MemRd*), Tag(p.2.2), and Address(AS.2.2), which the processor may translate to a third CXL.mem transaction that may include a third CXL.mem M2S request comprising MemOpcode(MemRd*), Tag(p.1.2), and Address(AS.1.2), wherein the processor may send the third CXL.mem M2S request to the second memory. Upon receiving a response from the second memory, that may include a second CXL.mem S2M DRS comprising Opcode(MemData), Tag(p.1.2), and Data(*Data.2*), the processor may translate the second CXL.mem S2M DRS to a third CXL.mem S2M DRS comprising Opcode(MemData), Tag(p.2.2), and Data(*Data.2*). The processor may perform further translations, such as opcode translations, e.g., translating between MemRd opcodes in requests conforming to the first CXL.mem, and MemRdTEE opcodes in requests conforming to the second CXL.mem, enabling CXL memory accesses with the Trusted Execution Environment (TEE) attribute.

In some examples, the processor may act as a protocol endpoint and terminate the CXL.mem transactions received from the first entity. The processor may issue CXL.mem transactions to the second memory, optionally acting as an independent protocol initiator, such as a CXL host, and may utilize translated fields from the CXL.mem transactions received from the first entity for constructing the CXL.mem transactions sent to the second memory. In other examples, the processor may maintain end-to-end transaction contexts of the CXL.mem between the first entity and the second memory, without terminating the CXL.mem transactions, such as by preserving transaction-related identification fields such as Tags, and optionally translating other fields such as address.

Heterogeneous computing architectures may incorporate systems wherein entities utilize different protocols while requiring coordinated access to shared resources. In such environments, a first entity operating with CXL.mem may need to access resources coupled to a second entity operating with PCIe. For example, a newer generation server may utilize CXL.mem to access data on a non-CXL server populated with DDR4, where translations between CXL.mem and PCIe enable utilizing the non-CXL server as a memory pool. Translations between CXL.mem messages and PCIe TLPs may facilitate memory operations, data transfers, and resource sharing across different domains while maintaining the requirements of each protocol. Such translations may be performed by a computer, an apparatus, a cable, or other suitable devices positioned between the first entity and the second entity.

In various implementations, a method for translating between Compute Express Link (CXL) messages and Peripheral Component Interconnect Express (PCIe) Transaction Layer Packets (TLPs), comprising: receiving, by a computer from a first entity, a CXL.mem Master-to-Subordinate (M2S) request; translating, by the computer, the CXL.mem M2S request to a PCIe memory request; sending, by the computer to a second entity, the PCIe memory request; receiving, by the computer from the second entity, a PCIe Completion corresponding to the PCIe memory request; translating, by the computer, the PCIe Completion to a CXL.mem Subordinate-to-Master (S2M) response; and sending, by the computer to the first entity, the CXL.mem S2M response. The translation process may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information, such as pending transaction tables or tracker entries, to correlate incoming PCIe Completions with previously transmitted PCIe memory requests and with pending CXL.mem transactions. Additionally, the elements may communicate through one or more intermediary components, such as a switch, a retimer, or other suitable entity that facilitates information transfer.

In some implementations of the method, the CXL.mem M2S request comprises a first physical address belonging to a first physical address space utilized by the first entity, and wherein translating the CXL.mem M2S request to the PCIe memory request comprises generating the PCIe memory request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the CXL.mem M2S request comprises MemRd* and a first Tag, the PCIe memory request comprises a non-UIO Memory Read request comprising a second Tag, the PCIe Completion comprises a Completion with Data (CplD) comprising Data, and the CXL.mem S2M response comprises an S2M Data Response (S2M DRS) comprising MemData, the Data, and the first Tag. The computer may maintain a mapping between the first Tag associated with the CXL.mem transaction and the second Tag associated with the PCIe transaction, wherein this mapping may be stored in a tracker entry, a translation table, or similar data structure. Upon receiving the CplD from the second entity, the computer may utilize the second Tag to identify the corresponding pending transaction and retrieve the first Tag for inclusion in the S2M DRS. The non-UIO Memory Read request may conform to non-UIO PCIe memory read semantics as defined in applicable PCIe specifications.

In some implementations, the method further comprises receiving, by the computer from the first entity, a CXL.mem M2S request with Data (M2S RwD) comprising a MemWr* and write data; translating the CXL.mem M2S RwD to a PCIe non-UIO Memory Write request comprising the write data; sending the PCIe non-UIO Memory Write request to the second entity; and sending a CXL.mem S2M No Data Response (S2M NDR) to the first entity. The PCIe non-UIO Memory Write request may be a posted write that may not require a completion from the second entity. The S2M NDR may include Cmp* indicating successful acceptance of the write request by the computer. The computer may include a DevLoad in the S2M NDR to provide telemetry information or to throttle subsequent requests from the first entity.

In some implementations of the method, the computer sends the CXL.mem S2M NDR to the first entity before sending the non-UIO Memory Write request to the second entity. Sending the S2M NDR before the PCIe Memory Write request may reduce latency observed by the first entity and may allow the first entity to proceed with subsequent operations without waiting for the write to propagate to the second entity. The computer may buffer the write data and transmit the PCIe Memory Write request asynchronously, optionally implementing flow control or ordering mechanisms to maintain consistency guarantees.

In some implementations, the method further comprises receiving, by the computer from the first entity, a CXL.mem M2S request with Data (M2S RwD) comprising a MemWr* and write data; translating the CXL.mem M2S RwD to a PCIe UIO Memory Write request (UIOMWr) comprising the write data; sending the PCIe (UIOMWr) to the second entity; receiving, from the second entity, a PCIe UIO Write Completion (UIOWrCpl); and sending a CXL.mem S2M No Data Response (S2M NDR) comprising Cmp* to the first entity. PCIe UIO may provide enhanced capabilities compared to non-UIO PCIe, including support for non-posted writes that return completions. The UIOWrCpl may indicate successful completion of the write operation by the second entity and may carry additional information.

In some implementations of the method, the CXL.mem S2M NDR comprises a DevLoad, and wherein the computer populates the DevLoad with information derived from at least one of the PCIe UIOWrCpl, or telemetry information. In some revisions of the CXL specification, CXL.mem S2M NDR messages may include a DevLoad. The computer may populate the DevLoad of the CXL.mem S2M NDR with information derived from the UIOWrCpl or with telemetry information generated by the computer.

In some implementations of the method, the PCIe UIOWrCpl comprises a CXL DevLoad (CDL) comprising Quality-of-Service (QoS) telemetry, and wherein the computer translates the QoS telemetry carried in the CDL of the PCIe UIOWrCpl to a DevLoad of the CXL.mem S2M NDR, enabling the first entity to receive QoS information originating from the second entity. The CDL may carry telemetry information, such as device load indicators, queue depth information, or latency metrics generated by the second entity. By translating the CDL to the DevLoad, the computer may propagate QoS telemetry across the protocol boundary, enabling the first entity to make informed decisions regarding request pacing, load balancing, or resource allocation based on conditions at the second entity. The translation may involve copying, scaling, adjusting, or mapping of the telemetry values between the CDL and DevLoad field formats.

In some implementations of the method, the CXL.mem M2S request comprises MemRd* and a first Tag, the PCIe memory request comprises a UIO Memory Read (UIOMRd) request comprising a second Tag, the PCIe Completion comprises a UIO Read Completion with Data (UIORdCplD) comprising Data, and the CXL.mem S2M response comprises an S2M Data Response (S2M DRS) comprising MemData, the Data, and the first Tag. The UIOMRd may provide enhanced semantics compared to non-UIO PCIe memory read operations, such as support for out-of-order completions or additional metadata fields. The UIORdCplD may carry the requested data along with status information or telemetry. The computer may extract the data from the UIORdCplD and format it according to CXL.mem S2M DRS requirements for delivery to the first entity.

In some implementations of the method, the CXL.mem S2M response comprises a DevLoad, wherein the computer populates the DevLoad with telemetry information or utilizes the DevLoad to throttle CXL.mem M2S requests from the first entity, wherein the first entity comprises a first host, and wherein the second entity comprises a second host or a PCIe device. The DevLoad may enable the computer to communicate backpressure, congestion indicators, or performance metrics to the first host. The first host may utilize this information to adjust its request rate, implement adaptive flow control, or make scheduling decisions. The second entity may include various types of devices, such as a server, a memory expander, a GPU, a NIC, a storage device, or other PCIe-attached resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a first interface configured to communicate with a first entity based on CXL.mem, wherein CXL denotes Compute Express Link; a second interface configured to communicate with a second entity based on Peripheral Component Interconnect Express (PCIe); a computer coupled to the first interface and the second interface, the computer configured to: receive, via the first interface, a CXL.mem Master-to-Subordinate (M2S) request comprising a first physical address belonging to a first physical address space utilized by the first entity; translate the CXL.mem M2S request to a PCIe memory request comprising a second physical address belonging to a second physical address space utilized by the second entity; and send, via the second interface, the PCIe memory request to the second entity. The apparatus may be implemented as a semiconductor device, a card, a module, an active cable, or other suitable form factor. The first interface may expose the apparatus to the first entity as a CXL switch, or as a CXL device, such as a CXL Type-2 device or a CXL Type-3 device. The second interface may expose the apparatus to the second entity as a PCIe switch, as a PCIe device, or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.mem Subordinate-to-Master (S2M) response; and send, via the first interface, the CXL.mem S2M response to the first entity; wherein the first interface exposes to the first entity one of the following: a CXL switch, a CXL Type-2 device, or a CXL Type-3 device; and wherein the second interface exposes to the second entity one of the following: a PCIe switch, a PCIe device, or a root port. When the second interface exposes a root port, the apparatus may function as a host toward the second entity, enabling the apparatus to initiate PCIe transactions to downstream PCIe devices. When the second interface exposes a PCIe device, the apparatus may function as an endpoint toward the second entity, such as when coupled to another host.

In some implementations of the apparatus, the first physical address space comprises the second physical address space. The second physical address space may be a PCIe Memory Address Space, a DMA address space, an IO virtual address (IOVA) space, or a system address space, and may further be a subset of the first physical address space or identical to the first physical address space.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The cable may conform to various industry standards or specifications, such as those defined by the Optical Internetworking Forum (OIF), the Small Form Factor Committee (SFF), or the IEEE.

In some implementations of the apparatus, the physical medium comprises a twinaxial cable, a multimode fiber (MMF), or a single-mode fiber (SMF); and wherein the cable is configured to couple to the first entity or the second entity via a connector selected from Octal Small Form Factor Pluggable Module (OSFP), Octal Small Form Factor eXtra Dense Pluggable Module (OSFP-XD), Quad Small Form-Factor Pluggable (QSFP), or Quad Small Form-Factor Pluggable Double Density (QSFP-DD). The twinaxial cable may be suitable for shorter reach applications within a rack or between adjacent racks, while fiber options may enable longer reach connectivity. The MMF may be utilized for distances up to several hundred meters, while SMF may be utilized for longer distances. The connector type may be selected based on bandwidth requirements, density considerations, and deployment environment. The cable may be implemented as an Active Optical Cable (AOC) or an Active Copper Cable (ACC) depending on the physical medium utilized.

In various implementations, a system comprising: a first entity coupled to a first memory; a second entity coupled to a second memory, wherein the second entity comprises a Central Processing Unit (CPU) configured to support Peripheral Component Interconnect Express (PCIe) but not Compute Express Link (CXL); and a computer coupled between the first entity and the second entity, the computer configured to: receive, from the first entity, a CXL.mem Master-to-Subordinate (M2S) request; translate the CXL.mem M2S request to a PCIe memory request; send, to the second entity, the PCIe memory request to access the second memory; receive, from the second entity, a PCIe Completion; and send, to the first entity, a CXL.mem Subordinate-to-Master (S2M) response corresponding to the PCIe Completion. The system may enable the first entity to access memory resources coupled to CPUs that do not support CXL, thereby extending the reach of CXL-based memory pooling to include legacy and/or non-CXL infrastructure. The CPU of the second entity may be a processor from a generation that predates CXL support, or may be a processor that uses its CXL capabilities for other purposes. The second memory may be attached to the second entity via memory controllers integrated in the CPU, and the computer may enable the first entity to access this memory utilizing PCIe transactions that the CPU can process.

In some implementations of the system, the second entity and the second memory form a memory pool, and wherein the computer is configured to expose the memory pool to the first entity. The memory pool may appear to the first entity as CXL-attached memory, even though the underlying memory is coupled to a non-CXL CPU. The computer may expose the memory pool by responding to CXL.mem initialization and configuration operations from the first entity and by translating subsequent memory access requests to PCIe transactions directed to the second entity. Multiple second entities and their associated memories may be aggregated into a larger memory pool that the computer exposes to one or more first entities.

In some implementations of the system, the second memory comprises DDR4 memory, and wherein the first memory comprises DDR5 memory. The system may enable tiered memory architectures wherein the first entity utilizes higher-performance memory technologies, such as DDR5, for latency-sensitive operations, while utilizing DDR4 memory coupled to the second entity for capacity-oriented workloads. The computer may enable the first entity to transparently access the DDR4 memory tier utilizing CXL.mem, and memory management software executing on the first entity may place data across tiers based on access patterns, SLA requirements, tenant identities, temperature thresholds, or other policies.

In some implementations of the system, The system of claim 20 wherein the CPU comprises a pre-CXL generation CPU, and the pre-CXL generation CPU is installed in a datacenter server. The pre-CXL generation CPU may include processors that were manufactured or designed before CXL became available, or processors that do not include CXL capability. The datacenter server may be a server that has been decommissioned from primary compute duties but retains functional memory and PCIe connectivity. The system may enable repurposing of such servers as memory pool contributors, thereby extending the useful life of datacenter infrastructure and reducing electronic waste while providing additional memory capacity to CXL-enabled first entities.

In multi-host environments, there may be scenarios where first entities operating with CXL.mem need to access memory or other resources coupled to a second entity operating with PCIe. For example, newer generation servers may utilize CXL.mem to access data on a non-CXL server, where translations between CXL.mem and PCIe enable utilizing the non-CXL server as a shared memory pool. Translations between CXL.mem messages and PCIe TLPs may facilitate memory operations, data transfers, and resource sharing across different protocol domains while maintaining the requirements of each protocol and routing responses to the appropriate requesting entities.

In various implementations, a method for translating between Compute Express Link (CXL) messages and Peripheral Component Interconnect Express (PCIe) Transaction Layer Packets (TLPs), comprising: receiving, by a computer, CXL.mem Master-to-Subordinate (M2S) requests from first entities; translating, by the computer, the CXL.mem M2S requests to PCIe memory requests; sending, by the computer to a second entity, the PCIe memory requests; receiving, by the computer from the second entity, PCIe Completions corresponding to the PCIe memory requests; translating, by the computer, the PCIe Completions to CXL.mem Subordinate-to-Master (S2M) responses; and sending, by the computer, each of the CXL.mem S2M responses to a corresponding one of the first entities. The translation process may encompass various aspects of the protocol messages, including opcodes, addresses, and transaction identifiers, thereby enabling communication between CXL.mem-capable entities and a PCIe-capable entity. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information to correlate incoming PCIe Completions with previously transmitted PCIe memory requests and with the originating first entities, enabling responses to be routed to the correct requester. The first entities may include hosts, accelerators, GPUs, NICs, or other CXL-capable devices that share access to resources coupled to the second entity. Additionally, the elements may communicate through one or more intermediary components, such as a switch, a retimer, or other suitable entity that facilitates information transfer.

In some implementations of the method, the computer maintains separate tracking structures for each of the first entities, and wherein the computer processes CXL.mem M2S requests received from different ones of the first entities in parallel, by storing transaction information in the respective separate tracking structures. The separate tracking structures may enable the computer to manage outstanding transactions from different first entities without interference. Each tracking structure may store information such as CXL.mem Tags, addresses, opcodes, and timestamps associated with transactions from the corresponding first entity. By maintaining separate structures, the computer may support concurrent processing wherein a CXL.mem M2S request from one first entity may be translated and sent while awaiting a PCIe Completion for a request from another first entity. The tracking structures may be implemented as tables, queues, linked lists, content-addressable memories, or other data structures suitable to associate PCIe Completions with their originating CXL.mem transactions and first entities.

In some implementations of the method, the computer sequentially processes the CXL.mem M2S requests received from the first entities by queuing the CXL.mem M2S requests and translating each queued CXL.mem M2S request in order, wherein the computer completes sending one of the PCIe memory requests before translating a subsequent one of the CXL.mem M2S requests. Sequential processing may be utilized in implementations where simplicity, determinism, and/or resource constraints favor processing one request at a time. The computer may queue incoming CXL.mem M2S requests in a first-in-first-out (FIFO) buffer or other queuing structure and may process each request to completion before beginning the next, which may reduce the complexity of tracking concurrent transactions and may provide predictable ordering of memory operations. Sequential processing may be suitable for scenarios where the first entities have relatively low aggregate request rates or where strict ordering guarantees are desired.

In some implementations of the method, a first one of the first entities utilizes a first Host Physical Address (HPA) space, wherein a second one of the first entities utilizes a second HPA space different from the first HPA space, and wherein translating the CXL.mem M2S requests to the PCIe memory requests comprises translating addresses from the first HPA space and addresses from the second HPA space to corresponding addresses in a physical address space utilized by the second entity. The address translation may accommodate scenarios where different first entities operate with independent HPA spaces that may have overlapping address ranges. The computer may maintain separate translation tables or functions for each first entity, mapping addresses from each first entity's HPA space to non-overlapping regions of the second entity's physical address space. Alternatively, the computer may utilize a unified translation mechanism that incorporates first entity identifiers as part of the address mapping. The second entity's physical address space may be a PCIe Memory Address Space, a system address space, or a DMA address space. The translation may involve base-and-offset calculations, page table lookups, or programmable translation functions.

In some implementations of the method, the computer allocates PCIe Tags for the PCIe memory requests, wherein the computer associates the PCIe Tags with identifiers of the corresponding ones of the first entities, and wherein the computer utilizes the PCIe Tags in the PCIe Completions to identify the corresponding ones of the first entities. PCIe Tags serve as transaction identifiers that enable completers to associate completions with their originating requests. The computer may allocate PCIe Tags from a pool and may record, for each allocated Tag, the identifier of the first entity that originated the corresponding CXL.mem M2S request. When a PCIe Completion arrives, the computer may extract the Tag from the completion, look up the associated first entity identifier, and route the translated CXL.mem S2M response to that first entity. The computer may also maintain a mapping between PCIe Tags and CXL.mem Tags to populate the correct Tag in the S2M response.

In some implementations of the method, the computer detects a timeout condition when a PCIe Completion corresponding to one of the PCIe memory requests is not received within a threshold duration, and wherein responsive to detecting the timeout condition, the computer sends a CXL.mem S2M response comprising an error indication to the corresponding one of the first entities. The timeout detection may provide a mechanism for handling non-responsive or failed transactions, preventing indefinite waiting by the first entities. The computer may associate a timestamp or timer with each outstanding PCIe memory request and may periodically check whether any pending transactions have exceeded the threshold duration. The threshold duration may be configurable and may be selected based on expected latencies, system policies, or protocol requirements. Upon detecting a timeout, the computer may release resources associated with the timed-out transaction, such as allocated Tags or tracking structure entries, and may generate an S2M response with an error opcode to notify the first entity of the failure. The timeout mechanism may also trigger logging, alerting, or error recovery procedures.

In some implementations of the method, at least one of the PCIe Completions comprises an error status indicating an Unsupported Request (UR) or a Completer Abort (CA), and wherein the computer translates the error status to an error indication in a corresponding one of the CXL.mem S2M responses. PCIe defines completion status values that indicate error conditions encountered by the completer. An Unsupported Request (UR) status indicates that the completer does not support the request type or that the request targeted an invalid address range. A Completer Abort (CA) status indicates that the completer encountered an error that prevented completion of the request. Other PCIe completion statuses, such as Configuration Request Retry Status (CRS), may also be translated to appropriate CXL.mem error indications. The computer may map these PCIe error statuses to CXL.mem S2M NDR messages with error opcodes or to S2M DRS messages with poison indicators, depending on the nature of the original request and the error encountered. The translation may preserve error semantics to enable the first entity to take appropriate recovery actions.

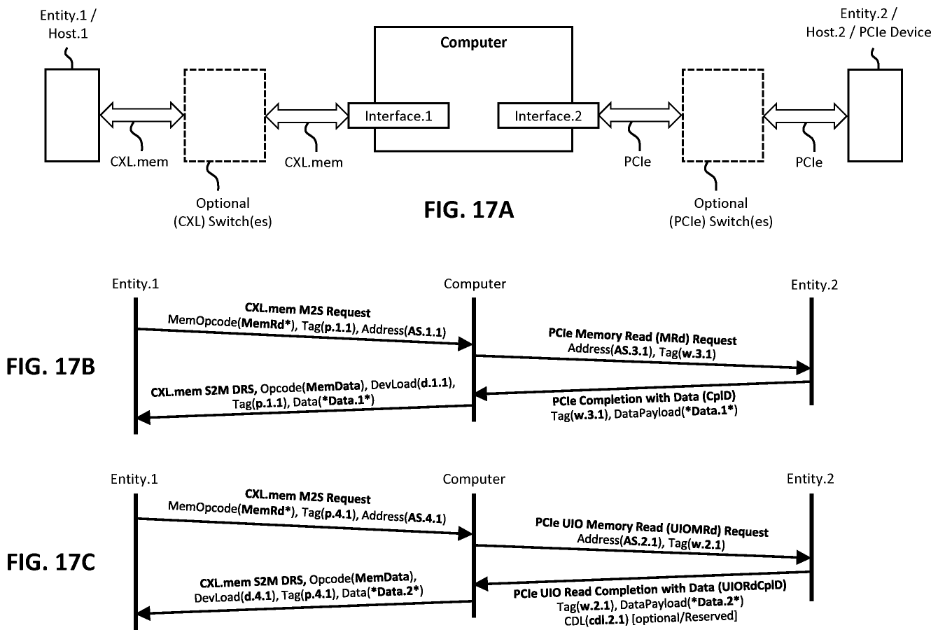

FIG. 17A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). In some examples, the second interface may expose a PCIe device, and may communicate according to PCIe with a second entity (Entity.2), such as a second host (Host.2) or another PCIe device. In other examples, the second interface may expose a root port (RP) and may communicate according to PCIe with a PCIe device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity. Similarly, optional PCIe switch(es) may be positioned between the second interface and the second entity.

FIG. 17B illustrates an example of a transaction flow diagram (TFD) demonstrating translations, performed by a computer, between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that includes a CXL.mem M2S request comprising MemOpcode(MemRd*), Tag(p.1.1), and Address(AS.1.1). The computer may translate the CXL.mem transaction to a PCIe transaction, which may include a PCIe Memory Read (MRd) request comprising Address(AS.3.1) and Tag(w.3.1), and may send the PCIe MRd to the second entity. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to PCIe. The computer may populate the DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification.

FIG. 17C illustrates an example of a TFD demonstrating translations between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request comprising MemOpcode(MemRd*), Tag(p.4.1), and Address(AS.4.1). The computer may translate the CXL.mem transaction to a PCIe transaction, which may include a PCIe UIO Memory Read (UIOMRd) request comprising Address(AS.2.1) and Tag(w.2.1), and may send the PCIe UIOMRd to the second entity. Upon receiving a response or completion from the second entity, which may include a PCIe UIO Read Completion with Data (UIORdCplD) comprising Tag(w.2.1), DataPayload(*Data.2*), and optionally CDL(cdl.2.1), the computer may translate the PCIe UIORdCplD to a CXL.mem S2M DRS comprising Opcode(MemData), DevLoad(d.4.1), Tag(p.4.1), and Data(*Data.2*) and may send the CXL.mem S2M DRS to the first entity. The optional CDL in the PCIe UIORdCplD, when not reserved, may be populated by the second entity with information such as QoS telemetry. The computer may translate the information carried in the optional CDL of the PCIe UIORdCplD received from the second entity, and populate the translated information in the DevLoad of the CXL.mem S2M DRS sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

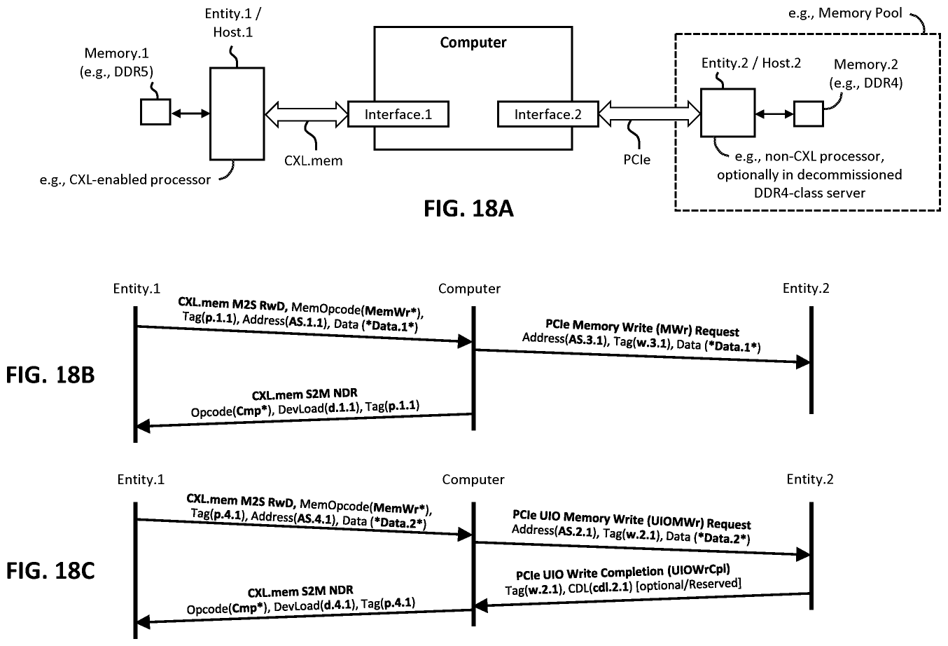

FIG. 18A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). The second interface may expose a PCIe device, and may communicate according to PCIe with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, such as DDR4, wherein the computer may utilize the memory pool to expose a DDR4 memory tier to the first entity which may be coupled to a first memory, such as DDR5. In some examples, the second entity may not support CXL, or may be configured not to support CXL, potentially preventing the computer from utilizing CXL for accessing the second memory. In some examples, the second entity may include a server, such as a DDR4-class datacenter server, wherein the server may include a non-CXL processor that may not support CXL, such as a pre-CXL generation processor configured to support PCIe but not CXL, and wherein the non-CXL processor may enable the computer to access the second memory by utilizing PCIe.

FIG. 18B illustrates an example of a TFD demonstrating translations, optionally performed by a computer, between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a PCIe transaction, which may include a PCIe Memory Write request (MWr) comprising Address(AS.3.1), Tag(w.3.1), and Data (*Data.1*), and may send the PCIe MWr to the second entity. In some examples, the PCIe MWr may be a posted write that may not be followed by a response or completion from the second entity. The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the PCIe MWr to the second entity. Alternatively, the computer may send the CXL.mem S2M NDR to the first entity in parallel to sending the PCIe MWr to the second entity, or the computer may send the CXL.mem S2M NDR to the first entity after sending the PCIe MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

FIG. 18C illustrates an example of a TFD demonstrating translations between CXL.mem requests received from a first entity (Entity.1), such as a first host (Host.1), and PCIe UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). A computer may translate the CXL.mem M2S RwD transaction to a PCIe transaction, which may include a PCIe UIO Memory Write request (UIOMWr) comprising Address(AS.2.1), Tag(w.2.1), and Data (*Data.2*), and may send the PCIe UIOMWr to the second entity. Upon receiving a response or completion from the second entity, which may include a PCIe UIO Write Completion (UIOWrCpl) comprising Tag(w.2.1) and optionally CDL(cdl.2.1), the computer may translate the PCIe UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The optional CDL in the PCIe UIOWrCpl, when not reserved, may be populated by the second entity with information such as QoS telemetry. The computer may translate the information carried in the optional CDL of the PCIe UIOWrCpl received from the second entity, and populate the translated information in the DevLoad of the CXL.mem S2M NDR sent to the first entity. DevLoad in CXL messages may be optional and may not exist in some revisions of the CXL specification. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to PCIe.

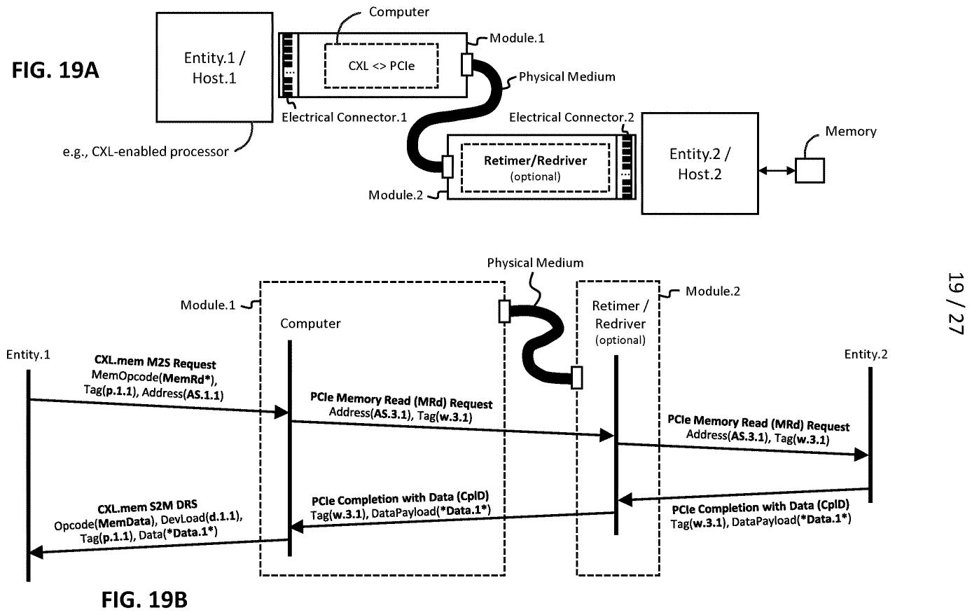

FIG. 19A illustrates an example of a system comprising a cable, such as an active cable, that may include a first module (Module.1), a second module (Module.2), and a physical medium coupling the first module and the second module. The physical medium may include a twinaxial cabling (also known as twinax cable), a multimode fiber (MMF), or a single-mode fiber (SMF). The cable may further include a computer that translates between CXL-based traffic, such as CXL.mem traffic, and a PCIe-based traffic, such as a PCIe or a PCIe-over-Ethernet traffic. The cable may enable a first entity (Entity.1) to access resources coupled to a second entity (Entity.2), such as a second host (Host.2). The first entity (Entity.1), which may be a first host (Host.1), may include a CXL-enabled processor. The access may be via the first module, the physical medium, and the second module. The resources may be memory coupled to the second entity, and the second entity may be a second host that may include a server, such as a DDR4-class datacenter server that may include a non-CXL processor that does not support CXL, such as a pre-CXL generation processor configured to support PCIe.

The cable may communicate with the first entity according to a CXL-based protocol, such as CXL.mem, and may communicate with the second entity according to a PCIe-based protocol. In some examples, messages conforming to the CXL-based protocol, such as CXL.mem, may be associated with a first address space, such as a first Host Physical Address (HPA) space; and messages conforming to the PCIe-based protocol may be associated with a second address space, such as a PCIe Memory Address Space, a DMA address space, an IO virtual address (IOVA) space, a system address space, or a second HPA space; wherein the cable may perform address translations between addresses within the first and second address spaces, respectively, such as between addresses within the first HPA space and addresses within the second HPA space. In other examples, messages conforming to the CXL-based protocol and messages conforming to the PCIe-based protocol may be associated with the same address space, wherein the cable may perform address translations between addresses within the same address space. Additionally, or alternatively, the system may perform further address translations, such as by an I/O Memory Management Unit (IOMMU), a System Memory Management Unit (SMMU), or a DMA address translation. The cable may perform further translations, such as protocol translations, opcode translations, command translations, TLP translations, or field translations between the CXL-based domain and the PCIe-based domain, such as translations of Tags and translations of error indications (e.g. data corruption indications such as poison).

The cable may further include a redriver or a retimer, such as a PCIe retimer, a CXL retimer, a dual-protocol CXL/PCIe retimer, a PAM4 retimer, or a retimer PHY. The cable, such as an OSFP copper cable, an OSFP-XD copper cable, an OSFP Active Optical Cable (AOC), or an OSFP-XD AOC cable, may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. In some examples, the cable may be coupled to the first entity via a first electrical connector (Connector.1) and may be further coupled to the second entity via a second electrical connector (Connector.2), whereas in other examples, the cable may be coupled to the first entity and/or to the second entity via optical connectors.

FIG. 19B illustrates an example of a TFD demonstrating translations performed by a cable, such as an active cable comprising a computer and optionally a retimer or a redriver. The cable may include a first module (Module.1), a second module (Module.2), and a physical medium coupling the first module and the second module. The translations may be between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that may include a CXL.mem M2S request comprising MemOpcode(MemRd*), Tag(p.1.1), and Address(AS.1.1). The computer included in the cable may translate the CXL.mem transaction to a PCIe transaction, which may include a PCIe Memory Read (MRd) request comprising Address(AS.3.1) and Tag(w.3.1). The computer may send the PCIe MRd to the second entity, optionally via the second module that may include a retimer or a redriver. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*). The computer may send the CXL.mem S2M DRS to the first entity. The computer may populate DevLoad of CXL.mem S2M messages with telemetry information, metadata, or other types of information collected or generated by the cable, or may utilize the DevLoad of CXL.mem S2M messages to throttle CXL.mem requests from the first entity, enabling the cable to control, limit, shape, or throttle the rate of data communications between the first entity and the second entity. The computer may perform further translations, such as protocol translations, opcode translations, command translations, TLP type translations, or field translations, such as Tag translations, between messages conforming to CXL.mem and TLPs conforming to PCIe.

In environments where entities may utilize different protocols while requiring coordinated access to shared resources, there may be scenarios where a first entity communicating according to CXL.mem, such as a CXL host, needs to access memory resources residing in a UALink domain, such as memory coupled to accelerators or accessible via a UALink network. An RPU or other suitable device may translate between CXL.mem and UPLI to facilitate memory operations, data transfers, and resource sharing across different protocol domains while maintaining the requirements of each protocol. The translation may involve converting CXL.mem M2S requests to UPLI requests, and converting UPLI responses to CXL.mem S2M responses, including translations of opcodes, commands, addresses, Tags, and additional fields. The RPU may further perform address translations between different address spaces, such as between a Host Physical Address (HPA) space utilized by CXL-based traffic and a Network Physical Address (NPA) space utilized by UALink-based traffic, or between addresses within the same address space. The RPU may include a cache for storing fetched data and may operate as a CXL Type-2 device, a CXL Type-3 device, or may expose both HDM-D and HDM-H memory regions concurrently.

In various implementations, a method for translating from Compute Express Link (CXL) requests to Ultra Accelerator Link (UALink) Protocol Level Interface (UPLI) requests, comprising: communicating with a first entity according to CXL.mem; communicating with a second entity according to UPLI; receiving, from the first entity, a CXL.mem Master-to-Subordinate (M2S) request comprising a MemRd* and a first physical address; translating the CXL.mem M2S request to a UPLI request comprising a read command and a second physical address; sending the UPLI request to the second entity; receiving, from the second entity, a UPLI read response (RdRsp) comprising data; translating the UPLI RdRsp to a CXL.mem Subordinate-to-Master Data Response (S2M DRS) comprising the data; and sending the CXL.mem S2M DRS to the first entity. The translation may enable entities communicating according to CXL.mem to access memory resources coupled to entities communicating according to UPLI, such as HBM and/or High-Bandwidth Flash (HBF) coupled to an accelerator, or memory accessible via a UALink network. The method may be implemented in hardware, firmware, software, or combinations thereof, and may be performed by various types of devices, such as a processor, a switch, a bridge, an RPU, or a semiconductor device. The first physical address may be associated with a first address space, such as an HPA space, and the second physical address may be associated with a second address space, such as an NPA space, wherein the translating may include translating the first physical address to the second physical address. Additionally or alternatively, the first and second physical addresses may be associated with the same address space, such as a global address space, a partitioned global address space (PGAS), a pod address space, a virtual pod address space, or a fabric address space.

In some implementations of the method, the CXL.mem M2S request further comprises a MemOpcode field comprising the MemRd*, a Tag field, and an Address field comprising the first physical address; and wherein the UPLI request further comprises a ReqCmd field comprising the read command, a ReqAddr field comprising the second physical address, a ReqSrcPhysAccID field, a ReqDstPhysAccID field, a ReqLen field, and a ReqTag field; and further comprising translating the Tag to the ReqTag. The Tag translation may involve maintaining a bidirectional mapping between CXL.mem Tag values and UPLI ReqTag values, enabling proper correlation of UPLI responses with their corresponding CXL.mem requests. The ReqSrcPhysAccID and ReqDstPhysAccID fields may carry identifiers utilized for routing the UPLI request to the target accelerator. When the ReqLen indicates a transfer size exceeding a CXL.mem cacheline size (e.g., 64 Bytes), CXL.mem M2S requests may be consolidated into a UPLI request supporting transfer sizes up to 256 Bytes.

In some implementations of the method, the UPLI RdRsp further comprises a RdRspSrcPhysAccID field, a RdRspDstPhysAccID field, a RdRspTag field, and RdRspData comprising the data; and wherein the CXL.mem S2M DRS further comprises an Opcode field comprising MemData and the Tag. The RdRspDstPhysAccID may correspond to the ReqSrcPhysAccID from the original UPLI request, reflecting the routing path for the response. The RdRspTag may be utilized to retrieve the corresponding CXL.mem Tag from the bidirectional mapping maintained during request translation. In some examples, the UPLI RdRsp may carry data across multiple beats, and the RPU may accumulate the beats before constructing the CXL.mem S2M DRS.

In some implementations of the method, the UPLI RdRsp further comprises a RdRspDataError field, and the CXL.mem S2M DRS further comprises a Poison field; and further comprising translating the RdRspDataError field of the UPLI RdRsp to the Poison field of the CXL.mem S2M DRS. The RdRspDataError field in UPLI may serve as a per-beat data poison indicator. The Poison field in CXL.mem S2M DRS may indicate that the returned data contains an error. The translation of error indications across protocol boundaries may enable the first entity to detect data corruption that originated in the UALink domain, and to take appropriate recovery actions.

In some implementations, the method further comprises storing the data from the UPLI RdRsp in a cache; and sending a CXL.mem Subordinate-to-Master No Data Response (S2M NDR) comprising Cmp-S to the first entity, wherein the Cmp-S indicates a shared cacheline state. By storing the fetched data in the cache, the RPU may maintain a local copy of the cacheline and participate in coherency management with the first entity. The S2M NDR comprising Cmp-S may inform the first entity that the RPU retains a shared copy, enabling both the first entity and the RPU to hold cached copies concurrently. This behavior may correspond to CXL Type-2 device semantics utilizing an HDM-D memory region, wherein the device coherency engine (DCOH) manages cacheline state on behalf of the device.

In some implementations of the method, the CXL.mem M2S request further comprises a SnpType field comprising SnpData, a MetaField field comprising Meta0-State (MS0), and a MetaValue field comprising Shared (S); and wherein the CXL.mem M2S request targets a Host-managed Device Memory (HDM-D) memory region. The SnpType(SnpData), MetaField(MS0), and MetaValue(S) combination may indicate an intent by the first entity to acquire a shared copy of the cacheline. The RPU may utilize these fields to determine the coherency behavior and to select the Cmp-S opcode for the S2M NDR.

In some implementations of the method, the CXL.mem M2S request further comprises a SnpType field comprising No-Op and a MetaField field comprising No-Op; and wherein the CXL.mem S2M DRS is sent to the first entity without sending a CXL.mem Subordinate-to-Master No Data Response (S2M NDR) to the first entity; and wherein the CXL.mem M2S request targets a Host-managed Device Memory (HDM-H) memory region. The No-Op values for SnpType and MetaField may indicate that no snoop or metadata operation is involved, corresponding to CXL Type-3 device semantics. In this flow, the RPU may act as a passthrough that forwards data from the UALink domain to the first entity without maintaining a cached copy and without participating in coherency management.

In some implementations, the method further comprises sending a CXL.mem Subordinate-to-Master No Data Response (S2M NDR) comprising Cmp-S to the first entity without storing the data in a cache. The RPU may respond with Cmp-S even when the RPU does not have a cache or does not store the data. This may be beneficial in scenarios where the first entity does not support CXL Type-3 device flows and only supports CXL Type-2 device flows. By emulating Type-2 behavior, the RPU may maintain compatibility with hosts that lack Type-3 support.

In some implementations of the method, the first physical address is associated with a first address space, the second physical address is associated with a second address space different from the first address space, and the translating further comprises translating the first physical address to the second physical address; and wherein the first address space comprises a Host Physical Address (HPA) space or a System Physical Address (SPA) space, and the second address space comprises a Network Physical Address (NPA) space. The address translation may be implemented utilizing lookup tables, page tables, base-and-offset calculations, range-based mapping, and/or programmable translation functions. The HPA or SPA may represent addresses within the CXL domain, and the NPA may represent addresses within the UALink network that may span multiple accelerators or nodes. In some examples, the first and second address spaces may be the same address space, and the RPU may perform routing without address translation.

In some implementations of the method, the first entity comprises a CXL host, the second entity comprises an accelerator or a UALink switch, and the read command comprises a Read command or a Read Class Vendor Defined Command. Read Class VDCs may correspond to ReqCmd encodings that enable vendor-specific memory access operations extending beyond the standard UPLI read commands. The CXL host may include a CPU or other CXL-capable entity. The accelerator may include a GPU, a TPU, or other processing device coupled to a UALink network.

In some implementations, the method further comprises receiving, from the first entity, a CXL.mem Master-to-Subordinate Request with Data (M2S RwD) comprising MemWr* and write data; translating the CXL.mem M2S RwD to a UPLI request comprising a write command; sending the UPLI request and the write data to the second entity; receiving, from the second entity, a UPLI write response (WrRsp); translating the UPLI WrRsp to a CXL.mem Subordinate-to-Master No Data Response (S2M NDR) comprising Cmp; and sending the CXL.mem S2M NDR to the first entity. MemWr* may refer to MemWr, MemWrPtl, MemWrTEE, MemWrPtlTEE, or other memory write opcode variants defined or to be defined in CXL.mem. The write data may be transferred from the CXL.mem domain to the UPLI domain via the Originator Data Channel, optionally with byte enable manipulation utilizing OrigDataByteEn when the MemWr* refers to MemWrPtl for partial writes. The UPLI write command may include a Write or WriteFull command as defined by the UPLI specification. The UPLI WrRsp may carry a WrRspTag and WrRspStatus indicating the completion status of the write operation.

In some implementations, the method further comprises receiving, from the first entity, a CXL.mem M2S request comprising MemSpecRd; and translating the CXL.mem M2S request comprising MemSpecRd to a UPLI request. The MemSpecRd opcode may indicate a speculative read issued by the first entity before coherence resolution, and the RPU may translate it to a UPLI read request directed to the second entity. When utilizing the MemSpecRd opcode, some of the CXL.mem M2S Req fields, such as MetaField, MetaValue, and SnpType, may be reserved. Additionally or alternatively, the RPU may initiate speculative UPLI requests on its own to prefetch data from the second entity, based on access pattern recognition or configurable prefetch policies.

In some implementations of the method, the method is performed by a device that exposes a first memory region utilizing CXL Type-2 device memory flows associated with a Host-managed Device Memory-Device coherent (HDM-D) region, and a second memory region utilizing CXL Type-3 device memory flows associated with a Host-managed Device Memory-Host coherent (HDM-H) region. The CXL specification allows a device to expose both HDM-D and HDM-H memory regions concurrently. For example, local memory such as HBM and/or HBF coupled to an accelerator may be exposed as an HDM-D region utilizing CXL Type-2 memory flows with coherency management, while remote memory accessible via the UALink network may be exposed as an HDM-H region utilizing CXL Type-3 memory flows. The RPU may select the appropriate memory flow based on the address of the CXL.mem M2S request.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In computing environments where a host communicating according to CXL.mem may need to access memory resources in a UALink domain, such as memory coupled to accelerators or accessible via a UALink network, an RPU may bridge the two protocol domains by translating between CXL.mem and UPLI. The RPU may include a CXL port for communicating with the host and a UALink port for communicating with accelerators or a UALink switch. The RPU may translate CXL.mem M2S requests to UPLI requests and translate UPLI responses to CXL.mem S2M responses. The RPU may include a cache for storing fetched data and may operate as a CXL Type-2 device or a CXL Type-3 device. The RPU may be a discrete component, an IP block embedded within an accelerator, or a chiplet within an IC package.

In various implementations, a system comprising: a resource provisioning unit (RPU) comprising a Compute Express Link (CXL) port configured to communicate with a first entity according to CXL.mem, and an Ultra Accelerator Link (UALink) port configured to communicate with a second entity according to a UALink-based protocol; wherein the RPU is configured to: receive, from the first entity via the CXL port, a CXL.mem Master-to-Subordinate (M2S) request; translate the CXL.mem M2S request to a UPLI request; and send the UPLI request to the second entity via the UALink port. The RPU may serve as a protocol translation bridge that enables entities in the CXL domain to access resources in the UALink domain. The CXL port may support CXL.mem M2S and S2M channels, while the UALink port may support UPLI request, read response/data, write response, and Originator Data channels. The RPU may translate between CXL.mem and UPLI including translations of opcodes, addresses, Tags, and additional fields. The first entity may include a CXL host such as a CPU, and the second entity may include an accelerator, a UALink switch, or other UALink-capable device. The RPU may be coupled to the first entity directly or via a CXL fabric, and may be coupled to the second entity directly or via a UALink switch. The system may be implemented within an IC package, across IC packages, or as a combination of discrete and integrated components.

In some implementations of the system, the RPU is further configured to: receive a UPLI read response (RdRsp) from the second entity via the UALink port; translate the UPLI RdRsp to a CXL.mem Subordinate-to-Master Data Response (S2M DRS); and send the CXL.mem S2M DRS to the first entity via the CXL port. The RPU may translate UPLI RdRsp fields to CXL.mem S2M DRS fields, including mapping the RdRspTag back to the corresponding CXL.mem Tag and formatting the RdRspData as CXL.mem data. The RPU may accumulate data from multiple UPLI response beats before constructing the S2M DRS.

In some implementations of the system, the RPU further comprises a cache; and wherein the RPU is further configured to store data from the UPLI RdRsp in the cache and send a CXL.mem Subordinate-to-Master No Data Response (S2M NDR) comprising Cmp-S to the first entity. By maintaining the fetched data in its cache, the RPU may participate in coherency management with the first entity and may respond to subsequent accesses to the same cacheline without issuing additional UPLI requests. The RPU with a cache may operate as a CXL Type-2 device.

In some implementations of the system, the first entity comprises a CXL host, the second entity comprises an accelerator; and wherein the RPU is configured to operate as at least one of a CXL Type-2 device or a CXL Type-3 device. The RPU may operate as a CXL Type-2 device utilizing HDM-D memory regions with device-managed coherency, or as a CXL Type-3 device utilizing HDM-H memory regions with host-managed coherency. In some examples, the RPU may expose both HDM-D and HDM-H regions concurrently, operating as a CXL Type-2 device for some memory regions and as a CXL Type-3 device for others.

In some implementations, the system further comprises a UALink switch coupled to the UALink port; wherein the RPU is configured to send the UPLI request to the second entity via the UALink switch. The UALink switch may route the UPLI request to the second entity based on a Destination Accelerator ID carried in the UPLI request. The RPU may appear to entities in the UALink domain as a UALink endpoint identified by an Accelerator ID.

In some implementations of the system, the RPU is further configured to: receive, from the first entity via the CXL port, a CXL.mem Master-to-Subordinate Request with Data (M2S RwD) comprising MemWr*; translate the CXL.mem M2S RwD to a UPLI request comprising a write command; and send the UPLI request and write data to the second entity via the UALink port. The RPU may translate CXL.mem write opcodes to UPLI write commands and transfer the write data from the CXL.mem domain to the UPLI Originator Data Channel. When the MemWr* refers to MemWrPtl for partial writes, the RPU may translate the CXL.mem byte enables to UPLI OrigDataByteEn fields.

In computing environments where a host, such as a CPU, may need to access memory resources residing in a UALink domain, such as HBM and/or HBF coupled to accelerators in a UALink pod, the host may communicate via CXL.mem with an RPU that translates requests to UPLI for delivery to the accelerators via a UALink switch. The UALink pod may include accelerators coupled to a UALink switch, forming a high-bandwidth interconnect fabric for inter-accelerator communication. The RPU may be embedded within one of the accelerators, or may be a discrete component coupled to the UALink switch. In some configurations, the system may include a CXL fabric coupling the host to the RPU and to CXL memory devices such as GFDs, memory expanders, or memory pools, enabling the host to access both CXL domain resources and UALink domain resources. The multi-path topology may enable the host to access different accelerators and memory resources via different translation paths, supporting workloads such as AI inference where data may be staged from CXL memory to accelerator memory.

In various implementations, a system comprising: a host; a UALink pod comprising a UALink switch and accelerators coupled to the UALink switch, wherein the accelerators communicate according to a UALink-based protocol; a resource provisioning unit (RPU) coupled to the host via CXL.mem and coupled to the UALink switch; and wherein the RPU is configured to receive a CXL.mem Master-to-Subordinate (M2S) request from the host, translate the CXL.mem M2S request to a UPLI request, and send the UPLI request to an accelerator of the accelerators via the UALink switch. The system may enable the host to access memory resources residing in the UALink domain, such as HBM and/or HBF coupled to the accelerators, DRAM within the accelerators, or memory accessible via the UALink network. The RPU may translate between CXL.mem and UPLI including translations of opcodes, addresses, Tags, and additional fields. The UALink switch may route the UPLI request to the target accelerator based on a Destination Accelerator ID. The host may utilize CXL.mem M2S requests comprising memory read or write opcodes, and the RPU may translate these to corresponding UPLI read or write commands. The system may support workloads where the host stages data between CXL memory resources and accelerator memory, such as populating KV cache entries into accelerator HBM and/or HBF for AI inference workloads. The RPU may be implemented as a discrete component, as an IP block embedded within one of the accelerators, or as a chiplet within an IC package.

In some implementations of the system, the RPU is embedded within a first accelerator of the accelerators, and the first accelerator is coupled to the host via CXL.mem; and wherein the UPLI request is sent from the first accelerator to a second accelerator of the accelerators via the UALink switch. The embedded RPU may share the first accelerator's silicon die or IC package and may utilize the first accelerator's CXL port for communication with the host. The first accelerator may serve as both an accelerator in the UALink pod and as a translation bridge for the host to reach other accelerators.

In some implementations of the system, the RPU is separate from the accelerators and is coupled to the UALink switch via a UALink port. The discrete RPU may function as a standalone protocol translation component that does not perform accelerator compute functions. This configuration may enable the RPU to be deployed independently of the accelerator design, potentially supporting different generations of accelerators or different UALink pod configurations.

In some implementations, the system further comprises a CXL fabric coupling the host to the RPU; and further comprising a CXL memory device coupled to the host via the CXL fabric, wherein the host is configured to access the CXL memory device via CXL.mem. The CXL fabric may include one or more CXL switches and may provide connectivity between the host, the RPU, and CXL memory devices. The host may access the CXL memory device via CXL.mem without protocol translation, while accessing accelerator memory in the UALink pod via the RPU with protocol translation.

In some implementations of the system, the CXL memory device comprises at least one of: a Global Fabric-Attached Memory Device (GFD), a CXL memory expander, or a CXL memory pool. The GFD may provide large-capacity memory resources accessible via CXL.mem, and may be shared among the host and other CXL entities. The host may stage data between the CXL memory device and accelerator memory via the RPU, such as migrating KV cache entries for AI inference workloads.

In some implementations of the system, the RPU is further configured to receive a UPLI read response (RdRsp) from the accelerator via the UALink switch, translate the UPLI RdRsp to a CXL.mem Subordinate-to-Master Data Response (S2M DRS), and send the CXL.mem S2M DRS to the host; and wherein the host comprises a central processing unit (CPU), and the accelerators comprise graphics processing units (GPUs) or tensor processing units (TPUs). The CPU may utilize the CXL.mem response to populate data structures, migrate data between memory tiers, or perform orchestration tasks on behalf of AI or HPC workloads. The GPUs or TPUs may serve as computational accelerators within the UALink pod.

In some implementations, the system further comprises a second RPU coupled to the host via CXL.mem and coupled to the UALink switch; wherein the RPU is configured to translate CXL.mem M2S requests from the host to UPLI requests targeting a first accelerator of the accelerators, and the second RPU is configured to translate CXL.mem M2S requests from the host to UPLI requests targeting a second accelerator of the accelerators. The RPUs may enable the host to access different accelerators through dedicated translation paths, potentially supporting different address ranges, different coherency policies, or different quality-of-service configurations for each path. The first and second RPUs may be discrete components or may include one embedded RPU and one discrete RPU.

In some implementations of the system, the UALink switch comprises a route table, and the UALink switch routes the UPLI request from the RPU to the accelerator based on a Destination Accelerator ID carried in the UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the target accelerator. The route table may be programmed by a Pod Controller or other management entity. The RPU may populate the ReqDstPhysAccID based on the address of the CXL.mem M2S request or based on a preconfigured mapping.

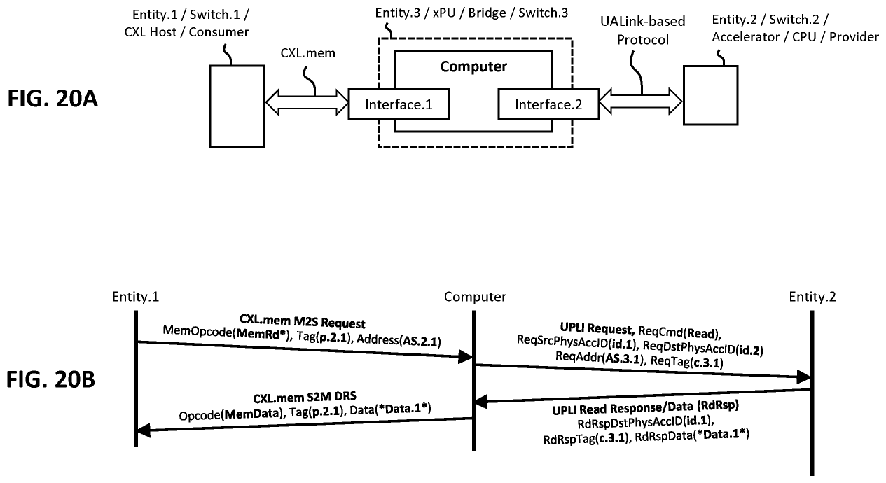

FIG. 20A illustrates an example of a block diagram showing a computer (Entity.3) coupled between a first entity (Entity.1) and a second entity (Entity.2). The first entity communicates with the computer via CXL.mem through a first interface (Interface.1), and the computer communicates with the second entity via a UALink-based protocol through a second interface (Interface.2). The first entity may include a CXL host, a switch, or a consumer of memory resources. The second entity may include an accelerator, a switch, or a provider of memory resources. The computer may include an xPU, a bridge, a switch, or an RPU.

FIG. 20B illustrates an example of a TFD demonstrating translations from a CXL.mem request from Entity.1 to a UPLI request sent to Entity.2, and from a UPLI read response from Entity.2 to a CXL.mem S2M DRS sent to Entity.1. The CXL.mem M2S request carries MemOpcode, Tag, and Address fields, and the UPLI request carries ReqCmd, ReqSrcPhysAccID, ReqDstPhysAccID, ReqAddr, and ReqTag fields. The UPLI read response carries RdRspDstPhysAccID, RdRspTag, and RdRspData fields, and the CXL.mem S2M DRS carries Opcode, Tag, and Data fields.

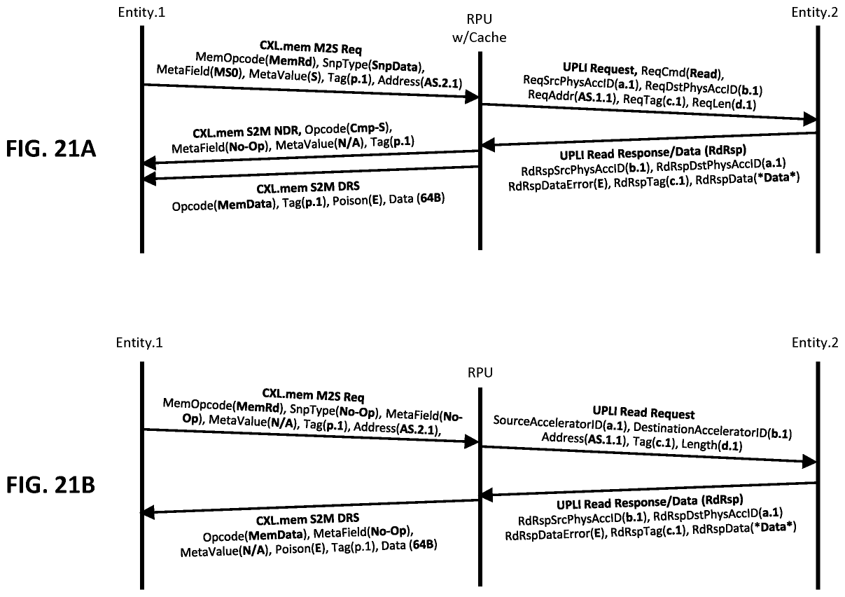

FIG. 21A illustrates an example of a TFD demonstrating an RPU comprising a cache (RPU w/Cache) that exposes a CXL Type-2 device utilizing an HDM-D memory region. Entity.1 sends a CXL.mem M2S request with SnpType(SnpData), MetaField(MS0), and MetaValue(S) to request a shared copy of a cacheline. The RPU translates the request to a UPLI request and receives a UPLI read response from Entity.2. The RPU stores the fetched data in its cache and sends a CXL.mem S2M NDR comprising Cmp-S to Entity.1, indicating a shared cacheline state, followed by a CXL.mem S2M DRS comprising MemData and the data.

FIG. 21B illustrates an example of a TFD demonstrating an RPU without a cache that exposes a CXL Type-3 device utilizing an HDM-H memory region. Entity.1 sends a CXL.mem M2S request with SnpType(No-Op) and MetaField(No-Op). The RPU translates the request to a UPLI request and receives a UPLI read response from Entity.2. The RPU translates the UPLI read response to a CXL.mem S2M DRS comprising MemData and the data, and sends the S2M DRS to Entity.1 without sending an S2M NDR.

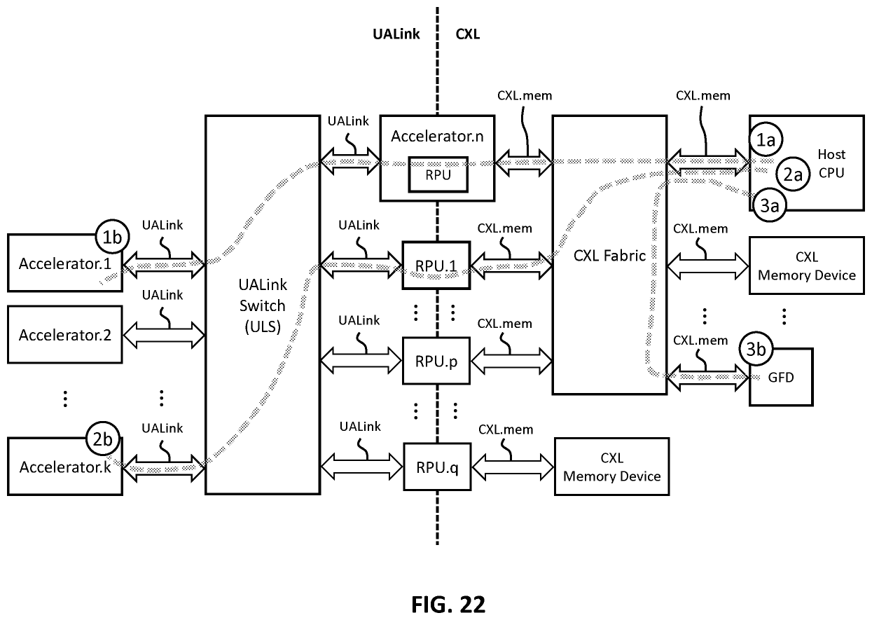

FIG. 22 illustrates an example of a system comprising a host CPU, a CXL fabric, a UALink switch, accelerators, and RPUs. Path 1 (1a to 1b) illustrates the host accessing Accelerator.1 via Accelerator.n that comprises an embedded RPU, wherein the host communicates with Accelerator.n via CXL.mem and Accelerator.n communicates with Accelerator.1 via UALink through the UALink switch. Path 2 (2a to 2b) illustrates the host accessing Accelerator. k via a discrete RPU (RPU.1) coupled to the UALink switch, wherein the host communicates with RPU.1 via CXL.mem and RPU.1 communicates with Accelerator. k via UALink. Path 3 (3a to 3b) illustrates the host accessing a GFD via CXL.mem through the CXL fabric.

In heterogeneous computing architectures, entities may utilize different PCIe revisions while requiring coordinated access to shared resources. PCIe Unordered IO (UIO) is an optional capability that addresses limitations of PCI/PCIe fabric-based ordering rules, enabling multi-path routing, improved performance, and simplified fabric elements. However, PCIe specifications define UIO for Flit Mode (FM), and require that the entire path from requester to completer uses FM, supports UIO, and has UIO enabled. In environments where a first entity utilizing one PCIe revision needs to access resources coupled to a second entity utilizing a different PCIe revision, translations between PCIe UIO TLPs and PCIe non-UIO TLPs may facilitate memory operations and data transfers across different domains. Such translations may be performed by a computer, an apparatus, a cable, or other suitable devices positioned between the first entity and the second entity. The translations may further enable communication over split flit-mode/non-flit-mode paths, wherein the UIO portion utilizes flit-based encoding while the non-UIO portion may utilize non-flit-based encoding.

In various implementations, a method for translating between Peripheral Component Interconnect Express (PCIe) Transaction Layer Packets (TLPs), comprising: receiving, from a first entity, a first PCIe Memory Read request comprising a first address and a first Tag; translating, by a computer, the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; sending, to a second entity, the second PCIe Memory Read request; receiving, from the second entity, a second PCIe Completion comprising the second Tag and a data payload; translating, by the computer, the second PCIe Completion to a first PCIe Completion comprising the first Tag and the data payload; and sending, to the first entity, the first PCIe Completion. The translation process may encompass various aspects of the protocol messages, including opcodes, addresses, Tags, and other TLP fields, thereby enabling communication between entities that utilize different PCIe revisions. The computer may maintain state information, such as pending transaction tables or tracker entries, to correlate incoming PCIe Completions with previously transmitted PCIe Memory Read requests and with pending transactions. The method may be implemented in hardware, firmware, software, or combinations thereof, and may be performed by various types of devices, such as semiconductor devices, switches, bridges, or active cables. Additionally, the elements may communicate through one or more intermediary components, such as a switch, a retimer, or other suitable entity that facilitates information transfer.

In some implementations of the method, the first PCIe Memory Read request comprises the non-UIO MRd, the second PCIe Memory Read request comprises the UIO Memory Read (UIOMRd) request, the second PCIe Completion comprises a UIO Read Completion with Data (UIORdCplD), and the first PCIe Completion comprises a non-UIO Completion with Data (CplD). The non-UIO to UIO translation may enable a first entity that does not support UIO capabilities to access resources coupled to a second entity via a UIO-enabled path. The computer may translate the MRd to a UIOMRd, which may traverse a path supporting multi-path routing or out-of-order completion delivery. Upon receiving the UIORdCplD from the second entity, the computer may translate it to a CplD conforming to non-UIO PCIe completion expected by the first entity.

In some implementations of the method, the UIORdCplD comprises a CXL DevLoad (CDL), and wherein the computer extracts information from the CDL for at least one of: populating a CDL in a response to another entity, throttling subsequent requests, or storing Quality-of-Service (QoS) telemetry. The CDL in the UIORdCplD may carry telemetry information such as device load indicators, queue depth information, or latency metrics populated by the second entity or intermediate components. The computer may extract this information and utilize it for various purposes, such as propagating QoS telemetry to upstream components, implementing adaptive flow control by throttling the rate of subsequent requests, or storing the telemetry for monitoring and analysis. This extraction may enable the computer to make informed decisions regarding request pacing, load balancing, or resource allocation based on conditions observed at the second entity.

In some implementations of the method, the first PCIe Memory Read request comprises the UIO Memory Read (UIOMRd) request, the second PCIe Memory Read request comprises the non-UIO MRd, the second PCIe Completion comprises a non-UIO Completion with Data (CplD), and the first PCIe Completion comprises a UIO Read Completion with Data (UIORdCplD). The UIO to non-UIO translation may enable a first entity utilizing PCIe UIO to access resources coupled to a second entity that does not support UIO capabilities. The computer may translate the UIOMRd to a PCIe MRd, which may extend the reach of UIO-capable devices to legacy PCIe infrastructure or to devices that have not implemented UIO support.

In some implementations of the method, the UIORdCplD comprises a CXL DevLoad (CDL), and wherein the computer populates the CDL with Quality-of-Service (QoS) telemetry information based on at least one of: queue depth at the computer, observed latency, congestion indicators, or bandwidth utilization metrics. When translating from PCIe non-UIO completions that do not include a CDL, the computer may populate the CDL in the UIORdCplD to provide telemetry information to the first entity. The QoS telemetry information may be generated by the computer based on locally observed conditions. Queue depth may indicate the number of pending transactions awaiting completion. Observed latency may reflect the time elapsed between sending requests and receiving completions. Congestion indicators may signal backpressure conditions in downstream paths. Bandwidth utilization metrics may indicate the degree to which available bandwidth is being consumed. The first entity may utilize this telemetry information to make informed decisions about subsequent memory operations, such as throttling request rates, adjusting request priorities, or selecting alternative resources based on observed loading conditions. The computer may thus provide telemetry to the first entity even when the second entity does not support telemetry reporting.

In some implementations of the method, the first address is associated with a first physical address space utilized by the first entity, and wherein the second address is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations, the method further comprises receiving, from the first entity, a PCIe non-UIO Memory Write request (MWr) comprising a third address and write data; translating, by the computer, the PCIe MWr to a PCIe UIO Memory Write request (UIOMWr) comprising a fourth address and the write data; sending, to the second entity, the PCIe UIOMWr; and receiving, from the second entity, a PCIe UIO Write Completion (UIOWrCpl). The translation from non-UIO to UIO write may involve converting a posted write (MWr) that does not expect a completion into a non-posted write (UIOMWr) that receives a UIOWrCpl from the second entity. The UIOMWr may traverse a path supporting multi-path routing, potentially improving write performance in fabric topologies with multiple paths between source and destination. The computer may utilize the UIOWrCpl for flow control, error recovery, transaction ordering, or as a basis for generating a write acknowledgment to the first entity, as described in dependent claims.

In some implementations of the method, the computer buffers the write data prior to sending the PCIe UIOMWr, and wherein the computer utilizes the UIOWrCpl for at least one of: flow control, error recovery, or transaction ordering. The computer may buffer the write data internally to decouple the timing of receiving the MWr from the first entity and sending the UIOMWr to the second entity. The UIOWrCpl received from the second entity may provide confirmation that the write data has been accepted, which the computer may utilize for flow control by releasing buffer space, for error recovery by detecting and handling failed writes, or for transaction ordering by confirming completion of writes before allowing subsequent dependent operations.

In some implementations, the method further comprises receiving, from the first entity, a PCIe UIO Memory Write request (UIOMWr) comprising a third address, a third Tag, and write data; translating, by the computer, the PCIe UIOMWr to a PCIe non-UIO Memory Write request (MWr) comprising a fourth address and the write data; sending, to the second entity, the PCIe MWr; and sending, to the first entity, a PCIe UIO Write Completion (UIOWrCpl) comprising the third Tag. The translation from UIO to non-UIO write may involve converting a non-posted write (UIOMWr) that expects a completion into a posted write (MWr) that does not return a completion from the second entity. The computer may generate the UIOWrCpl to acknowledge receipt of the write data to the first entity, even though the second entity does not provide a completion for the posted MWr. This translation may enable UIO-capable devices to write to legacy PCIe devices while maintaining the non-posted write semantics expected by the first entity.

In some implementations of the method, the computer sends the UIOWrCpl to the first entity at one of: before sending the PCIe MWr to the second entity, in parallel with sending the PCIe MWr to the second entity, or after sending the PCIe MWr to the second entity; and wherein the UIOWrCpl comprises a CXL DevLoad (CDL) populated by the computer. The timing of the UIOWrCpl may provide different trade-offs between latency and ordering guarantees. Sending the UIOWrCpl before sending the MWr may reduce latency observed by the first entity and may allow the first entity to proceed with subsequent operations without waiting for the write to propagate to the second entity. Sending the UIOWrCpl in parallel with or after sending the MWr may provide stronger ordering guarantees at the cost of increased latency. The computer may populate the CDL with QoS telemetry information based on locally observed conditions, providing telemetry to the first entity even though the second entity does not return a completion.

In some implementations of the method, the computer buffers the write data, and wherein the computer is configured to retry sending the PCIe MWr to the second entity upon detecting a transmission error. The computer may retain the write data in a buffer after generating the UIOWrCpl to the first entity, enabling error recovery if the posted MWr encounters transmission errors on the path to the second entity. The computer may implement retry logic that re-sends the MWr upon detecting errors, thereby providing reliability guarantees to the first entity even though the posted write on the non-UIO path does not inherently provide acknowledgment. The buffer may be released after the computer determines that the MWr has been successfully transmitted or accepted by downstream components.

In some implementations of the method, communication between the computer and the first entity utilizes a first encoding mode, communication between the computer and the second entity utilizes a second encoding mode different from the first encoding mode, one of the first encoding mode and the second encoding mode comprises flit-based encoding and the other comprises non-flit-based encoding, the first entity comprises at least one of a PCIe host or a PCIe device, and the second entity comprises at least one of a PCIe host or a PCIe device. The split flit/non-flit path may enable communication between entities operating in different encoding modes. PCIe specifications define UIO for flit-based encoding, and do not permit direct translation of UIO TLPs to non-flit-based encoding. By performing TLP type translation, the computer may bridge these incompatible modes, enabling PCIe UIO transactions to reach PCIe devices operating in non-flit mode, or enabling non-flit PCIe devices to access resources via UIO-enabled paths. The first entity and second entity may include various types of hosts and devices, such as servers, processors, GPUs, NICs, storage controllers, memory expanders, or accelerators.

In various implementations, a system for translating between Peripheral Component Interconnect Express (PCIe) Transaction Layer Packets (TLPs), comprising: a first interface configured to communicate with a first entity; a second interface configured to communicate with a second entity; and a computer coupled between the first interface and the second interface, the computer configured to: receive, via the first interface, a first PCIe Memory Read request comprising a first address and a first Tag; translate the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; send, via the second interface, the second PCIe Memory Read request; receive, via the second interface, a second PCIe Completion comprising the second Tag and a data payload; translate the second PCIe Completion to a first PCIe Completion comprising the first Tag and the data payload; and send, via the first interface, the first PCIe Completion. The system may be implemented as a semiconductor device, a switch, a bridge, an active cable, or other suitable device positioned between the first entity and the second entity. The first interface and second interface may include physical layer components, link layer components, and transaction layer components configured based on PCIe specifications. The computer may include translation logic, address translation tables, Tag mapping structures, and pending transaction trackers to perform the translation between PCIe UIO and non-UIO TLPs.

In some implementations of the system, the first interface is configured to operate in a first encoding mode, wherein the second interface is configured to operate in a second encoding mode different from the first encoding mode, and wherein one of the first encoding mode and the second encoding mode comprises flit-based encoding and the other comprises non-flit-based encoding. The system may bridge flit-based and non-flit-based encoding modes, enabling UIO transactions originating from or destined to entities operating in Flit Mode to traverse paths operating in Non-Flit Mode, or vice versa. The first interface and second interface may each include encoding and decoding logic appropriate for their respective encoding modes, and the computer may handle the conversion between the different TLP header formats associated with each mode.

In some implementations of the system, the computer comprises: translation logic configured to translate between the UIOMRd and the MRd, and tracker entries, each configured to store a mapping between the first Tag and the second Tag for a pending transaction. The translation logic may include opcode mapping tables, address translation units, and field manipulation circuits to convert between UIO and non-UIO TLP formats. The tracker entries may be implemented as registers, memory structures, or content-addressable memory entries that associate incoming Tags with outgoing Tags and with other transaction state information. The tracker entries may enable the computer to handle concurrent transactions, with each entry tracking a separate pending read or write operation.

In some implementations of the system, the computer is configured to translate between a first physical address belonging to a first physical address space utilized by the first entity and a second physical address belonging to a second physical address space utilized by the second entity; wherein the first entity comprises at least one of a GPU, a Network Interface Card (NIC), a DMA engine, an accelerator, or a PCIe host; and wherein the second entity comprises at least one of a memory device, a memory expander, a memory pool, a storage controller, or a PCIe device. The address translation may be implemented utilizing lookup tables, translation lookaside buffers, page table walkers, or programmable translation functions. The address translation functionality may be configured by system software, firmware, or hardware configuration to establish mappings between the first and second physical address spaces. The computer may support various address space configurations, including identity mapping, offset-based translation, or arbitrary mapping based on page tables or similar structures.

In some implementations of the system, the first interface exposes a first endpoint to the first entity; wherein the second interface exposes a second endpoint to the second entity; and wherein the computer is implemented in an integrated circuit package comprising high-speed differential input/output (I/O) connections positioned according to a ball grid array (BGA) layout. The first endpoint may appear to the first entity as a PCIe device or a PCIe root port, depending on the system configuration. The second endpoint may similarly appear to the second entity as a PCIe device or a PCIe root port. The endpoints may implement capability structures, configuration space registers, and link management functions based on PCIe specifications, enabling the first entity and second entity to discover and communicate with the system using standard PCIe enumeration and configuration mechanisms. Additionally or alternatively, the IC package may conform to PCIe Retimer Supplemental Features and Standard BGA Footprint Specification or similar industry specifications. The BGA layout may facilitate integration of the system into standard PCIe card edge connector configurations, add-in card designs, or motherboard layouts. The high-speed differential I/O connections may support data rates such as 32.0 GT/s or higher as specified by PCIe Revision 6.0 or later specifications.

In various implementations, a method for enabling Unordered Input/Output (UIO) transactions over a split flit-mode/non-flit-mode path, comprising: receiving, via a first interface operating in a first data stream mode, a first Peripheral Component Interconnect Express (PCIe) Transaction Layer Packet (TLP); translating, by a computer, the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and sending, via a second interface operating in a second data stream mode different from the first data stream mode, the second PCIe TLP; wherein one of the first data stream mode and the second data stream mode comprises Flit Mode (FM), and the other comprises Non-Flit Mode (NFM). PCIe specifications define UIO for Flit Mode, and no translations of UIO TLPs to Non-Flit Mode are permitted according to the PCIe Revision 6.2 specification. The method may enable communication between a first entity and a second entity utilizing UIO over a split FM/NFM path, wherein the UIO TLPs may traverse a path that utilizes FM, whereas the non-UIO TLPs may traverse a path that utilizes NFM. Such split FM/NFM path setup is not permitted in standard PCIe Revision 6.2 environments, and may be enabled by the translation capabilities of the computer. The Data Stream mode may be determined during initial Link training, wherein each PCIe Link is set up following a negotiation of Link width, data rate, and Flit mode by the two agents at each end of the Link.

In some implementations of the method, the first data stream mode comprises FM, the second data stream mode comprises NFM, the first PCIe TLP comprises a UIO TLP, and the second PCIe TLP comprises a non-UIO TLP. The FM-to-NFM direction may enable a first entity operating in Flit Mode with UIO capabilities to access resources coupled to a second entity operating in Non-Flit Mode. The computer may translate the UIO TLP received via the FM interface to a non-UIO TLP for transmission via the NFM interface, thereby bridging the encoding mode boundary while adapting the TLP type to conform to the capabilities of the NFM path.

In some implementations of the method, the first data stream mode comprises NFM, the second data stream mode comprises FM, the first PCIe TLP comprises a non-UIO TLP, and the second PCIe TLP comprises a UIO TLP. The NFM-to-FM direction may enable a first entity operating in Non-Flit Mode to access resources coupled to a second entity via a Flit Mode path that supports UIO. The computer may translate the non-UIO TLP received via the NFM interface to a UIO TLP for transmission via the FM interface, thereby enabling the first entity to benefit from UIO capabilities such as multi-path routing even though the first entity operates in NFM.

In some implementations, the method further comprises receiving, via the second interface, a third PCIe TLP comprising a PCIe Completion corresponding to the second PCIe TLP; translating, by the computer, the third PCIe TLP to a fourth PCIe TLP; and sending, via the first interface, the fourth PCIe TLP to a first entity. The completion flow may complete the transaction initiated by the first PCIe TLP. The third PCIe TLP may include a UIO completion or a non-UIO completion depending on the TLP type of the second PCIe TLP. The computer may translate the third PCIe TLP to the fourth PCIe TLP, which may include a UIO completion or a non-UIO completion corresponding to the TLP type of the first PCIe TLP, thereby maintaining protocol consistency on each side of the computer.

In some implementations of the method, the first PCIe TLP comprises a UIO Memory Read (UIOMRd) request, the second PCIe TLP comprises a non-UIO Memory Read (MRd) request, the third PCIe TLP comprises a non-UIO Completion with Data (CplD), the fourth PCIe TLP comprises a UIO Read Completion with Data (UIORdCplD) comprising a CXL DevLoad (CDL), and wherein the computer populates the CDL. When translating from a CplD that does not include a CDL to a UIORdCplD that includes a CDL, the computer may populate the CDL with QoS telemetry information based on locally observed conditions. This population may enable the first entity to receive telemetry feedback even when the second entity does not support UIO or telemetry reporting.

In some implementations of the method, the first PCIe TLP comprises a non-UIO Memory Read (MRd) request, the second PCIe TLP comprises a UIO Memory Read (UIOMRd) request, the third PCIe TLP comprises a UIO Read Completion with Data (UIORdCplD) comprising a CXL DevLoad (CDL), and the fourth PCIe TLP comprises a non-UIO Completion with Data (CplD). When translating from a UIORdCplD that includes a CDL to a CplD that does not include a CDL, the computer may extract the information from the CDL and utilize it for purposes such as throttling subsequent requests, implementing adaptive flow control, or storing the telemetry for monitoring and analysis.

In some implementations of the method, the first PCIe TLP comprises a PCIe Memory Write request, and wherein the method further comprises: receiving, via the second interface, a third PCIe TLP comprising a PCIe UIO Write Completion (UIOWrCpl) when the second PCIe TLP comprises a UIO Memory Write request (UIOMWr); translating, by the computer, the third PCIe TLP to a fourth PCIe TLP; and sending, via the first interface, the fourth PCIe TLP. When the first PCIe TLP comprises a UIOMWr transmitted via an FM interface, the second PCIe TLP may include a MWr transmitted via an NFM interface as a posted write. The computer may generate a UIOWrCpl to send to the first entity even though the second entity does not return a completion for the posted MWr. Conversely, when the first PCIe TLP comprises a MWr, the computer may translate it to a UIOMWr and receive a UIOWrCpl from the second entity.

In some implementations of the method, the first PCIe TLP comprises a first physical address in a first physical address space, the second PCIe TLP comprises a second physical address in a second physical address space, a first entity coupled to the first interface comprises at least one of a GPU, a Network Interface Card (NIC), a DMA engine, or an accelerator, and wherein a second entity coupled to the second interface comprises at least one of a memory device, a memory expander, a memory pool, a storage controller, or a PCIe host. GPUs may utilize PCIe memory transactions to access large memory pools for graphics rendering, machine learning inference, or general-purpose GPU computing workloads. NICs may utilize PCIe memory transactions to access memory buffers for network packet processing, RDMA, or storage traffic handling. DMA engines may utilize PCIe memory transactions to transfer data between memory regions on behalf of other system components. The address translation may enable these devices to access resources utilizing addresses within their native address space while the second entity operates within its own address space.

In some implementations of the method, the first interface exposes a first endpoint to a first entity, wherein the second interface exposes a second endpoint to a second entity, wherein the first PCIe TLP comprises a first physical address in a first physical address space utilized by the first entity, and wherein the second PCIe TLP comprises a second physical address in a second physical address space utilized by the second entity. The first endpoint may be configured as a PCIe endpoint that appears to the first entity as a PCIe device operating in the first data stream mode. The second endpoint may be configured as a PCIe endpoint that appears to the second entity as a PCIe device operating in the second data stream mode. The endpoints may handle link training, flow control initialization, and capability negotiation according to their respective data stream modes. The address translation between the first physical address space and the second physical address space may be implemented utilizing lookup tables, page tables, base-and-offset calculations, or programmable translation functions.

In various implementations, a system for enabling Unordered Input/Output (UIO) transactions over a split flit-mode/non-flit-mode path, comprising: a first interface configured to operate in a first data stream mode and to communicate with a first entity; a second interface configured to operate in a second data stream mode different from the first data stream mode and to communicate with a second entity; wherein one of the first data stream mode and the second data stream mode comprises Flit Mode (FM), and the other comprises Non-Flit Mode (NFM); and a computer coupled between the first interface and the second interface, the computer configured to: receive, via the first interface, a first Peripheral Component Interconnect Express (PCIe) Transaction Layer Packet (TLP); translate the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and send, via the second interface, the second PCIe TLP. The system may bridge Flit Mode and Non-Flit Mode encoding boundaries while performing TLP type translation between UIO and non-UIO formats. The first interface and second interface may each include physical layer components configured for their respective data stream modes, including different scrambling, encoding, and framing mechanisms. The computer may include translation logic to convert between the different TLP header formats and field arrangements associated with FM and NFM operation.

In some implementations of the system, the first interface is configured to perform link training to establish the first data stream mode with the first entity, and wherein the first entity comprises at least one of a legacy PCIe device operating in NFM, a GPU, or a NIC; and wherein the second interface is configured to perform link training to establish the second data stream mode with the second entity, and wherein the second entity comprises at least one of a UIO-capable memory device, a memory pool operating in FM, or a fabric switch. The link training may include negotiation of Link width, data rate, and Flit mode between each interface and its respective entity. The first interface may negotiate FM with the first entity if both support FM, or may fall back to NFM otherwise. The second interface may independently negotiate FM or NFM with the second entity. The system may thus establish different data stream modes on each interface based on the capabilities of the connected entities. Additionally, legacy PCIe devices may operate in NFM due to hardware generation or design choices, and may benefit from access to UIO-enabled paths through the system's translation capabilities. GPUs and NICs may operate in either FM or NFM depending on their capabilities and may utilize the system to access memory resources across encoding mode boundaries. Memory pools and fabric switches operating in FM with UIO support may provide high-bandwidth, low-latency memory access that becomes accessible to NFM devices through the system.

In some implementations of the system, the first interface supports a first data rate, wherein the second interface supports a second data rate different from the first data rate, and wherein FM is selected when a data rate exceeds a threshold data rate. PCIe specifications may require FM for data rates exceeding 32.0 GT/s. The system may support different data rates on each interface, with the first interface potentially operating at a higher data rate in FM while the second interface operates at a lower data rate in NFM, or vice versa. This capability may enable the system to connect entities with different performance capabilities while providing translation between encoding modes.

In some implementations of the system, the computer comprises: translation logic configured to translate between UIO TLPs and non-UIO TLPs; and an address translation unit configured to translate between a first physical address belonging to a first physical address space utilized by the first entity and a second physical address belonging to a second physical address space utilized by the second entity. The translation logic may include opcode mapping circuits, header format converters, and field manipulation logic to transform TLPs between UIO and non-UIO formats while also converting between FM and NFM header layouts. The address translation unit may operate in conjunction with the translation logic to modify addresses during the TLP translation process.

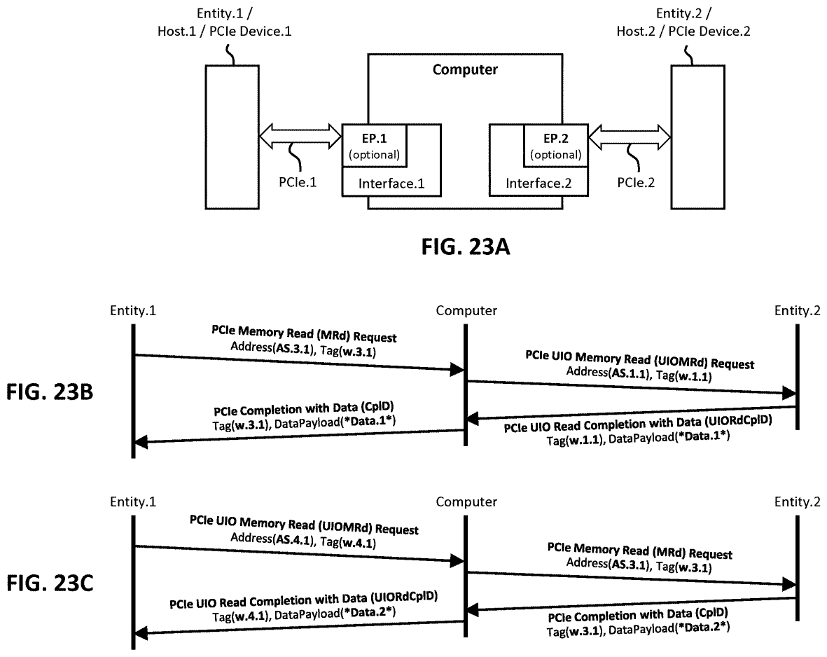

FIG. 23A illustrates an example of a system comprising a computer coupled between first and second interfaces. The first interface (Interface.1) may communicate according to a first PCIe-based protocol, such as PCIe Specification Revision 5.0. The second interface (Interface.2) may communicate according to a second PCIe-based protocol, such as PCIe Specification Revision 6.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first PCIe-based protocol with a first entity (Entity.1), which may be a first host (Host.1) or a first PCIe device (PCIe Device.1). The second interface may expose a second endpoint (EP.2) and may communicate according to the second PCIe-based protocol, with a second entity (Entity.2), which may be a second host (Host.2) or a second PCIe device (PCIe Device.2). The computer may extract physical addresses from first PDUs, such as first TLPs, received via the first interface, wherein these addresses may refer to a first physical address space utilized by the first entity; translate these addresses; and generate second PDUs, such as second TLPs, carrying the translated physical addresses for transmission via the second interface; wherein these translated addresses may correspond to a second physical address space utilized by the second entity.

FIG. 23B illustrates an example of a transaction flow diagram (TFD) demonstrating translations between TLPs associated with a first PCIe, received from a first entity (Entity.1), which may be a first host (Host.1) or a first PCIe device (PCIe Device.1), and UIO TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe transaction that includes a PCIe Memory Read (MRd) request comprising Address(AS.3.1) and Tag(w.3.1). A computer may translate the PCIe transaction to a PCIe UIO transaction that includes a PCIe UIO Memory Read (UIOMRd) request comprising Address(AS.1.1) and Tag(w.1.1), and may send the PCIe UIOMRd to the second entity. Upon receiving a completion from the second entity, which may include a PCIe UIO Read Completion with Data (UIORdCplD) comprising Tag(w.1.1), and DataPayload(*Data.1*), the computer may translate the PCIe UIORdCplD to a PCIe Completion with Data (CplD) comprising Tag(w.3.1) and DataPayload(*Data.1*), and send the PCIe CplD to the first entity.

The computer may perform further translations, such as protocol translations, opcode translations, command translations, TLP type translations, Tag translations, length translations, or field translations. Recent PCIe hosts and devices may utilize the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. Some PCIe revisions, such as PCIe Revision 6.2, may use two Data Stream modes: Flit Mode (FM), and Non-Flit Mode (NFM). Support of Data Stream in NFM may be mandatory, while support of Data Stream in FM may be mandatory for example only if data rate that exceeds 32.0 GT/s is supported. The Data Stream mode may be determined during initial Link training, wherein each PCIe Link is set up following a negotiation of Link width, data rate, and Flit mode by the two agents at each end of the Link. If FM is not disabled, and if both the Ports (and all Pseudo-Ports, if any) support it, FM may be chosen. Otherwise, NFM may be chosen. The current PCIe specifications define PCIe UIO for FM, and no translations of UIO TLPs to NFM are permitted. According to PCIe Revision 6.2 specifications, UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

FIG. 23C illustrates an example of a TFD demonstrating translations between UIO TLPs associated with a first PCIe, received from a first entity (Entity.1), which may be a first host (Host.1) or a first PCIe device (PCIe Device.1), and TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe UIO transaction that includes a PCIe UIOMRd comprising Address(AS.4.1) and Tag(w.4.1). A computer may translate the PCIe UIO transaction to a PCIe transaction that includes a PCIe MRd comprising Address(AS.3.1) and Tag(w.3.1), and may send the PCIe MRd to the second entity. Upon receiving a completion from the second entity, which may include a PCIe CplD comprising Tag(w.3.1) and DataPayload(*Data.2*), the computer may translate the PCIe CplD to a PCIe UIORdCplD comprising Tag(w.4.1), and DataPayload(*Data.2*), and send the PCIe UIORdCplD to the first entity. The computer may perform further translations, such as protocol translations, opcode translations, command translations, TLP type translations, Tag translations, length translations, or field translations.

The PCIe specification Revision 6.2 defines PCIe UIO for FM, no translations of UIO TLPs to NFM are permitted, and UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

In heterogeneous computing architectures, entities may utilize different protocols while requiring coordinated access to shared resources. PCIe UIO and CXL UIO define wire semantics and TLP types to enable multi-path fabrics and improved performance. In environments where a first entity supporting CXL.io UIO needs to access resources coupled to a second entity supporting PCIe, translations between CXL.io UIO TLPs and PCIe TLPs may facilitate memory operations and data transfers across different domains. Such translations may be performed by a computer, an apparatus, a cable, or other suitable devices positioned between the first entity and the second entity. The translations may further enable communication over split flit/non-flit paths, wherein the CXL.io UIO portion utilizes flit-based encoding while the PCIe portion may utilize non-flit-based encoding.

In various implementations, a method for translating between Compute Express Link (CXL) Transaction Layer Packets (TLPs) and Peripheral Component Interconnect Express (PCIe) TLPs, comprising: receiving, from a first entity, a CXL.io Unordered Input/Output (UIO) Memory Read (UIOMRd) request comprising a first address and a first Tag; translating, by a computer, the CXL.io UIOMRd to a PCIe memory request comprising a second address and a second Tag; sending, to a second entity, the PCIe memory request; receiving, from the second entity, a PCIe Completion corresponding to the PCIe memory request; translating, by the computer, the PCIe Completion to a CXL.io UIO Read Completion with Data (UIORdCplD) comprising the first Tag and a data payload; and sending, to the first entity, the CXL.io UIORdCplD. The translation process may encompass various aspects of the protocol messages, including opcodes, addresses, Tags, and other TLP fields, thereby enabling communication between entities that utilize different protocols. The computer may maintain state information, such as pending transaction tables or tracker entries, to correlate incoming PCIe Completions with previously transmitted PCIe memory requests and with pending CXL.io transactions. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io UIOMRd to the PCIe memory request comprises generating the PCIe memory request comprising the second address that is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the PCIe memory request comprises a PCIe UIO Memory Read (UIOMRd) request, the PCIe Completion comprises a PCIe UIORdCplD, and the CXL.io UIORdCplD comprises a CXL DevLoad (CDL) populated by the computer with Quality-of-Service (QoS) telemetry information. The UIO-to-UIO path may preserve UIO semantics across the protocol boundary, enabling multi-path routing and out-of-order completion capabilities on both sides of the computer. The CDL in CXL.io UIO completions may carry telemetry information such as device load indicators, queue depth information, or latency metrics. The computer may populate the CDL with information derived from the PCIe UIORdCplD, from the computer itself, or from intermediate components. This telemetry propagation may enable the first entity to make informed decisions regarding request pacing, load balancing, or resource allocation.

In some implementations of the method, the PCIe memory request comprises a PCIe non-UIO Memory Read (MRd) request, and the PCIe Completion comprises a PCIe non-UIO Completion with Data (CplD). The UIO-to-non-UIO translation may enable a first entity utilizing CXL.io UIO to access resources coupled to a second entity that does not support UIO capabilities. The computer may translate the UIOMRd to MRd that conforms to non-UIO PCIe memory read. This translation may extend the reach of UIO-capable devices to legacy PCIe infrastructure or to devices that have not implemented UIO support.

In some implementations of the method, the CXL.io UIORdCplD comprises a CXL DevLoad (CDL), and wherein the computer populates the CDL with Quality-of-Service (QoS) telemetry information. When translating from PCIe non-UIO completions that do not include a CDL, the computer may generate QoS telemetry information based on locally observed conditions, such as queue depths, latency measurements, or congestion indicators. The computer may thus provide telemetry to the first entity even when the second entity does not support telemetry reporting.

In some implementations of the method, communication between the computer and the first entity utilizes flit-based encoding, and wherein communication between the computer and the second entity utilizes non-flit-based encoding. The split flit/non-flit path may enable communication between entities operating in different encoding modes. PCIe specifications define UIO for flit-based encoding, and do not permit direct translation of UIO TLPs to non-flit-based encoding. The translations may enable the computer to bridge these incompatible modes, enabling CXL.io UIO transactions to reach PCIe devices operating in non-flit mode. This capability may extend the utility of UIO-based systems to include legacy PCIe infrastructure.

In some implementations, the method further comprises receiving, from the first entity, a CXL.io UIO Memory Write request (UIOMWr) comprising a third address, a third Tag, and write data; translating, by the computer, the CXL.io UIOMWr to a PCIe UIOMWr comprising a fourth address, a fourth Tag, and the write data; sending, to the second entity, the PCIe UIOMWr; receiving, from the second entity, a PCIe UIO Write Completion (UIOWrCpl) comprising the fourth Tag; translating, by the computer, the PCIe UIOWrCpl to a CXL.io UIOWrCpl comprising a CXL DevLoad (CDL) and the third Tag; and sending, to the first entity, the CXL.io UIOWrCpl. UIO write transactions may provide non-posted write with completion acknowledgment, unlike non-UIO PCIe memory writes that are posted. The computer may maintain a mapping between the third Tag associated with the CXL.io transaction and the fourth Tag associated with the PCIe transaction. Upon receiving the PCIe UIOWrCpl from the second entity, the computer may utilize the fourth Tag to identify the corresponding pending transaction and retrieve the third Tag for inclusion in the CXL.io UIOWrCpl.

In some implementations of the method, the third address is associated with a first physical address space, wherein the fourth address is associated with a second physical address space, and wherein the computer translates between the third address and the fourth address. The computer may track both read and write transactions in the same tracker entries or may maintain separate tracking structures for different transaction types.

In some implementations, the method further comprises receiving, from the first entity, a CXL.io UIO Memory Write request (UIOMWr) comprising a third address and write data; translating, by the computer, the CXL.io UIOMWr to a PCIe non-UIO Memory Write request (MWr) comprising a fourth address and the write data; and sending, to the second entity, the PCIe MWr. The PCIe non-UIO Memory Write request may be a posted write that does not require a completion from the second entity. The computer may synthesize a CXL.io UIOWrCpl to send to the first entity upon accepting the write request, since CXL.io UIOMWr is non-posted and the first entity expects a completion, while the underlying PCIe non-UIO MWr is a posted write that does not generate a PCIe completion. The translation from non-posted UIO to posted non-UIO may involve buffering the write data and managing ordering requirements.

In some implementations of the method, the third address is associated with a first physical address space utilized by the first entity; wherein the fourth address is associated with a second physical address space utilized by the second entity; wherein the first entity comprises a CXL host or a CXL device; and wherein the second entity comprises a PCIe host or a PCIe device. The first entity may include CXL hosts such as processors or CXL devices such as accelerators, memory expanders, or NICs. The second entity may include PCIe hosts such as processors or PCIe devices such as GPUs, storage controllers, or network adapters. The address translation may accommodate the different address space configurations utilized by these various entity types.

In various implementations, an apparatus comprising: a first interface configured to communicate with a first entity based on CXL.io Unordered Input/Output (UIO), wherein CXL denotes Compute Express Link; a second interface configured to communicate with a second entity based on Peripheral Component Interconnect Express (PCIe); and a computer coupled to the first interface and the second interface, the computer configured to: receive, via the first interface, a CXL.io UIO Memory Read (UIOMRd) request comprising a first address and a first Tag; translate the CXL.io UIOMRd to a PCIe memory request comprising a second address and a second Tag; and send, via the second interface, the PCIe memory request to the second entity. The apparatus may be implemented as a semiconductor device, a card, a module, an active cable, or other suitable form factor. The first interface may expose the apparatus to the first entity as a CXL device, such as a CXL Type-2 device or a CXL Type-3 device. The second interface may expose the apparatus to the second entity as a PCIe device or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.io UIO Read Completion with Data (UIORdCplD) comprising the first Tag and a data payload; and send, via the first interface, the CXL.io UIORdCplD to the first entity. The computer may maintain tracker entries or similar data structures to associate incoming PCIe Completions with their corresponding CXL.io requests. The translation may include extracting the data payload from the PCIe Completion and formatting it for CXL.io UIORdCplD.

In some implementations of the apparatus, the first address is associated with a first physical address space utilized by the first entity, the second address is associated with a second physical address space utilized by the second entity, and wherein the computer is further configured to translate between the first address and the second address. The apparatus may include address translation logic, which may be implemented using lookup tables, content-addressable memory, translation lookaside buffers, or programmable translation functions. The translation may enable the first entity to access resources using addresses within its native address space while the second entity operates within its own address space.

In some implementations of the apparatus, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The apparatus may extract CDL information from the PCIe UIORdCplD or may generate telemetry based on locally observed conditions. The CDL may enable end-to-end QoS telemetry propagation across the protocol boundary.

In some implementations of the apparatus, the PCIe memory request comprises a PCIe non-UIO Memory Read (MRd) request, the PCIe Completion comprises a PCIe non-UIO Completion with Data (CplD), wherein communication via the first interface utilizes flit-based encoding, and wherein communication via the second interface utilizes non-flit-based encoding. The apparatus may bridge flit-based and non-flit-based encoding modes, enabling CXL.io UIO transactions to reach legacy PCIe devices. The computer may handle the different header formats and encoding requirements of each mode.

In some implementations of the apparatus, the first interface exposes a first endpoint to the first entity, and wherein the second interface exposes a second endpoint to the second entity. The first endpoint may be configured as a CXL endpoint that appears to the first entity as a CXL device. The second endpoint may be configured as a PCIe endpoint that appears to the second entity as a PCIe device. The apparatus may thus function as a bridge between CXL and PCIe domains while presenting standard endpoint interfaces to both entities.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The physical medium may include twinaxial cable, multimode fiber (MMF), or single-mode fiber (SMF). The cable may be implemented as an Active Optical Cable (AOC) or an Active Copper Cable (ACC).

In various implementations, a system comprising: a first entity configured to communicate based on CXL.io Unordered Input/Output (UIO), wherein CXL denotes Compute Express Link; a second entity configured to communicate based on Peripheral Component Interconnect Express (PCIe); and a computer coupled between the first entity and the second entity, the computer configured to: receive, from the first entity, a CXL.io UIO Memory Read (UIOMRd) request comprising a first address; translate the CXL.io UIOMRd to a PCIe memory request comprising a second address; send, to the second entity, the PCIe memory request; receive, from the second entity, a PCIe Completion corresponding to the PCIe memory request; translate the PCIe Completion to a CXL.io UIO Read Completion with Data (UIORdCplD); and send, to the first entity, the CXL.io UIORdCplD. The system may be deployed in datacenters, HPC environments, or AI/ML training and inference clusters. The system architecture may enable CXL-based hosts or devices to access PCIe-attached resources using CXL.io UIO transactions, which may provide performance benefits such as multi-path routing and out-of-order completions. The computer may function as a bridge that maintains the requirements of each protocol while enabling interoperability.

In some implementations of the system, the first address is associated with a first physical address space utilized by the first entity, the second address is associated with a second physical address space utilized by the second entity, wherein the first entity comprises a CXL host or a CXL device, and wherein the second entity comprises at least one of a memory device, a memory expander, a memory pool, a Graphics Processing Unit (GPU), a Network Interface Card (NIC), an accelerator, a PCIe host, or a PCIe device. GPUs may be accessed via the system for AI/ML workloads, graphics rendering, or general-purpose GPU computing. NICs may be accessed for network packet processing, RDMA, or storage traffic handling. Memory devices, memory expanders, or memory pools may provide expanded memory capacity beyond what is directly attached to the first entity. The address translation may enable the first entity to access these diverse resources using a unified address space.

In some implementations of the system, the PCIe memory request comprises a PCIe non-UIO Memory Read (MRd) request, the PCIe Completion comprises a PCIe non-UIO Completion with Data (CplD), and wherein the CXL.io UIORdCplD comprises a CXL DevLoad (CDL) populated by the computer with Quality-of-Service (QoS) telemetry information. The system may enable CXL.io UIO-capable entities to access legacy PCIe devices while still receiving QoS telemetry in the completion. The computer may generate telemetry information based on observed system conditions when the second entity does not provide such information.

In some implementations of the system, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The UIO-to-UIO system configuration may preserve UIO semantics end-to-end, enabling multi-path routing and enhanced performance on both sides of the computer. QoS telemetry may be propagated from the second entity through the computer to the first entity.

In some implementations of the system, communication between the computer and the first entity utilizes flit-based encoding, and wherein communication between the computer and the second entity utilizes non-flit-based encoding. The system may enable deployment scenarios where newer CXL infrastructure utilizing flit-based encoding needs to communicate with legacy PCIe infrastructure utilizing non-flit-based encoding. The computer may handle the encoding mode differences transparently to the first and second entities.

In heterogeneous computing architectures, entities may communicate using different revisions of CXL.io, wherein earlier protocol revisions may lack support for UIO capabilities present in newer protocol revisions. CXL.io UIO defines wire semantics and TLP types to enable multi-path fabrics and improved performance. In environments where a first entity supporting a first CXL.io needs to access resources coupled to a second entity supporting a second CXL.io with UIO capabilities, translations between CXL.io non-UIO TLPs and CXL.io UIO TLPs may facilitate memory operations and data transfers across incompatible domains. Such translations may be performed by a computer, an apparatus, a cable, or other suitable devices positioned between the first entity and the second entity.

In various implementations, a method for translating between Compute Express Link (CXL) Transaction Layer Packets (TLPs), comprising: receiving, from a first entity, a CXL.io Memory Read (MRd) request comprising a first address and a first Tag; translating, by a computer, the CXL.io MRd to a CXL.io Unordered Input/Output (UIO) Memory Read (UIOMRd) request comprising a second address and a second Tag; sending, to a second entity, the CXL.io UIOMRd; receiving, from the second entity, a CXL.io UIO Read Completion with Data (UIORdCplD) comprising the second Tag and a data payload; translating, by the computer, the CXL.io UIORdCplD to a CXL.io Completion with Data (CplD) comprising the first Tag and the data payload; and sending, to the first entity, the CXL.io CplD. The translation process may encompass various aspects of the protocol messages, including opcodes, addresses, Tags, and other TLP fields, thereby enabling communication between entities that utilize different CXL.io revisions. The computer may convert non-UIO TLP formats to UIO TLP formats for the request path and convert UIO TLP formats back to non-UIO TLP formats for the completion path. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io MRd to the CXL.io UIOMRd comprises generating the CXL.io UIOMRd comprising the second address that is associated with a second physical address space utilized by the second entity. The address translation may be implemented utilizing mechanisms such as lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include a first HPA space utilized by a first host, and the second physical address space may include a second HPA space utilized by a second host or an address space utilized by a CXL device.

In some implementations of the method, the computer maintains state information comprising tracker entries or pending transaction tables to correlate the CXL.io UIORdCplD with the CXL.io UIOMRd and to associate the second Tag with the first Tag. The computer may allocate tracker entries upon receiving the CXL.io MRd and may store information including the first Tag, the first address, and transaction metadata. When the computer generates the CXL.io UIOMRd, it may assign the second Tag and record the mapping between the first Tag and the second Tag in the tracker entry. Upon receiving the CXL.io UIORdCplD comprising the second Tag, the computer may utilize the state information to identify the corresponding pending transaction and retrieve the first Tag for inclusion in the CXL.io CplD. The tracker entries may be implemented in hardware registers, content-addressable memory, or other suitable storage structures.

In some implementations of the method, the CXL.io UIORdCplD comprises a CXL DevLoad (CDL) field carrying Quality-of-Service (QoS) telemetry information, the second entity utilizes the CDL field for throttling requests from the computer, and the computer does not propagate the CDL field to the first entity in the CXL.io CplD. The CDL in CXL.io UIO completions may carry telemetry information such as device load indicators, queue depth information, or latency metrics populated by the second entity. The second entity may utilize the CDL to communicate its current load state to the computer, enabling the computer to adjust request pacing or implement congestion management. Because the CXL.io utilized by the first entity does not support UIO, the CXL.io CplD does not include a CDL field, and the computer may drop the CDL information when performing the translation and/or log or utilize the CDL information internally for its own traffic management decisions.

In some implementations of the method, a first CXL.io utilized for communicating the CXL.io MRd is an earlier revision than a second CXL.io utilized for communicating the CXL.io UIOMRd, and wherein a first interface utilized by the computer to communicate with the first entity and a second interface utilized by the computer to communicate with the second entity each comprise a CXL endpoint or a switch port. The first CXL.io may conform to an earlier CXL specification revision, such as CXL Specification Revision 1.1, that does not support UIO capabilities, while the second CXL.io may conform to a later CXL specification revision, such as CXL Specification Revision 3.2, that supports UIO capabilities. The first interface may expose a first CXL endpoint or a first switch port to the first entity, and the second interface may expose a second CXL endpoint or a second switch port to the second entity. The computer may thus function as a bridge between different CXL.io revisions while presenting CXL interfaces to both entities. Optionally, the computer may be implemented in an IC package having high-speed differential I/O balls positioned according to a ball grid array layout defined by a PCIe Retimer Supplemental Features and Standard BGA Footprint Specification.

In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

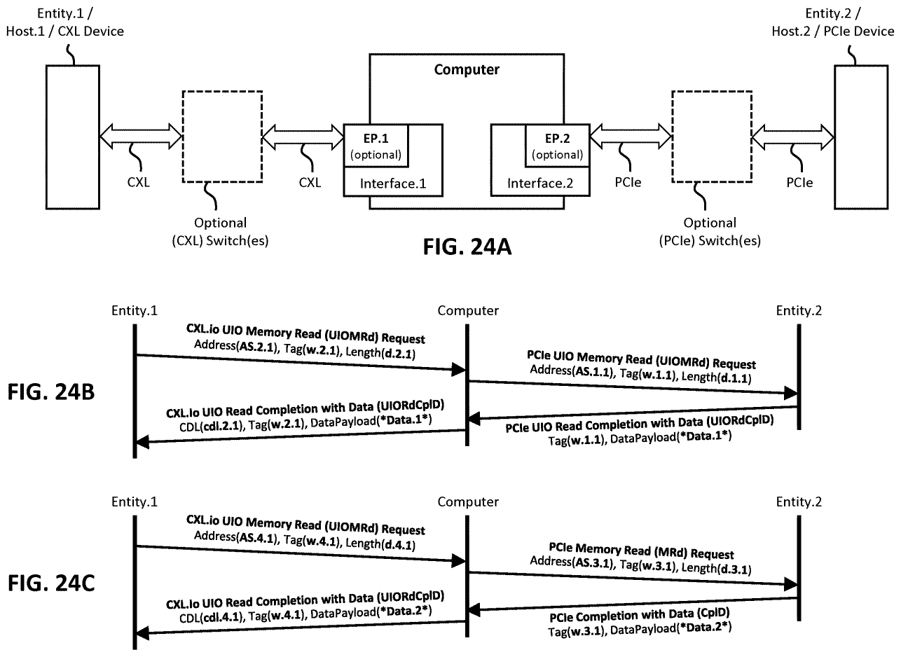

FIG. 24A illustrates an example of a system comprising a computer coupled between a first interface (Interface.1) that may communicate according to a CXL-based protocol, such as CXL.io, CXL.mem, or CXL.cache, and a second interface (Interface.2) that may communicate according to a PCIe-based protocol, such as a protocol conforming to PCI Express Base Specification Revision 6.2. The computer may be implemented in an IC package having high-speed differential I/O balls positioned according to a ball grid array layout defined by the PCIe Retimer Supplemental Features and Standard BGA Footprint Specification. The first interface may expose a first endpoint (EP.1) and may communicate according to a CXL-based protocol with a first entity (Entity.1), which may be a first host (Host.1) or a CXL device. The second interface may expose a second endpoint (EP.2) and may communicate according to a PCIe-based protocol, with a second entity (Entity.2), which may be a second host (Host.2) or a PCIe device. The computer may extract physical addresses from TLPs, PDUs, or messages, received via the first interface, wherein these addresses may refer to a first HPA space utilized by the first entity; translate these addresses; and generate TLPs, PDUs, or messages carrying the translated physical addresses for transmission via the second interface; wherein these translated addresses may correspond to a second HPA space utilized by the second entity. Optional switch(es), such as CXL switches, may be positioned between the first interface and the first entity. Additionally or alternatively, optional switch(es), such as PCIe switches, may be positioned between the second interface and the second entity.

FIG. 24B illustrates an example of a TFD demonstrating translations, performed by a computer, between CXL-based protocol data units (PDUs), such as CXL.io TLPs, received from a first entity (Entity.1), which may be a first host (Host.1) or a CXL device, and PCIe TLPs, sent to a second entity (Entity.2), which may be a second host (Host.2) or a PCIe device, possibly enabling the first entity to access resources mapped to an address space utilized by the second entity. The first entity may initiate a CXL.io transaction that includes a CXL.io UIO Memory Read (UIOMRd) request comprising Address(AS.2.1), Tag(w.2.1), and Length(d.2.1). The computer may translate the CXL.io transaction to a PCIe transaction that includes a PCIe UIOMRd comprising Address(AS.1.1), Tag(w.1.1), and Length(d.1.1), and may send the PCIe UIOMRd to the second entity. Upon receiving a completion from the second entity, which may include a PCIe UIO Read Completion with Data (UIORdCplD) comprising Tag(w.1.1) and DataPayload(*Data.1*), the computer may translate the PCIe UIORdCplD to a CXL.io UIORdCplD comprising CDL(cdl.2.1), Tag(w.2.1), and DataPayload(*Data.1*), wherein the CDL may be populated by the computer with information related to QoS, such as QoS telemetry value or values. The computer may perform further translations, such as protocol translations, opcode translations, command translations, or TLP type translations, e.g., translating between CXL.io UIO TLPs, such as CXL.io UIOMRd TLP, and PCIe non-UIO TLPs, such as PCIe MRd.

Recent PCIe hosts and devices may leverage the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. The computer may further perform other translations, such as field translations between TLPs conforming to CXL.io and TLPs conforming to PCIe, translations between CXL.io Tags and PCIe Tags, translations between reserved fields, and/or translations between reserved and non-reserved fields.

FIG. 24C illustrates an example of a TFD demonstrating translations between CXL.io TLPs, received from a first entity (Entity.1), and PCIe TLPs, sent to a second entity (Entity.2), possibly enabling the first entity to access resources mapped to an address space utilized by the second entity. The computer may perform further translations, such as protocol translations, opcode translations, command translations, TLP type translations, or field translations, between CXL.io TLPs and PCIe TLPs. The first entity may initiate a CXL.io transaction that includes a CXL.io UIOMRd comprising Address(AS.4.1), Tag(w.4.1), and Length(d.4.1). The computer may translate the CXL.io transaction to a PCIe transaction that includes a PCIe Memory Read (MRd) request comprising Address(AS.3.1), Tag(w.3.1), and Length(d.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to a CXL.io UIORdCplD comprising CDL(cdl.4.1), Tag(w.4.1), and DataPayload(*Data.2*), wherein the CDL may be populated by the computer with information related to QoS.

The translations may further enable communication between the first entity and the second entity over a split flit/non-flit path, wherein the CXL.io UIO portion of the path may utilize CXL protocol flits, whereas the PCIe non-UIO portion of the path may utilize Non-Flit Mode (NFM). Such split flit/non-flit path setup is not allowed in standard PCIe Revision 6.2 environments when the whole path utilizes PCIe. In the context of PCIe, Flit Mode (FM) and NFM may use different header formats, wherein routing elements may be required to translate between the FM TLP and NFM TLP formats when the Ingress Port and Egress Port are in different modes. The current PCIe specifications define PCIe UIO for FM, and no translations of UIO TLPs to NFM are permitted.

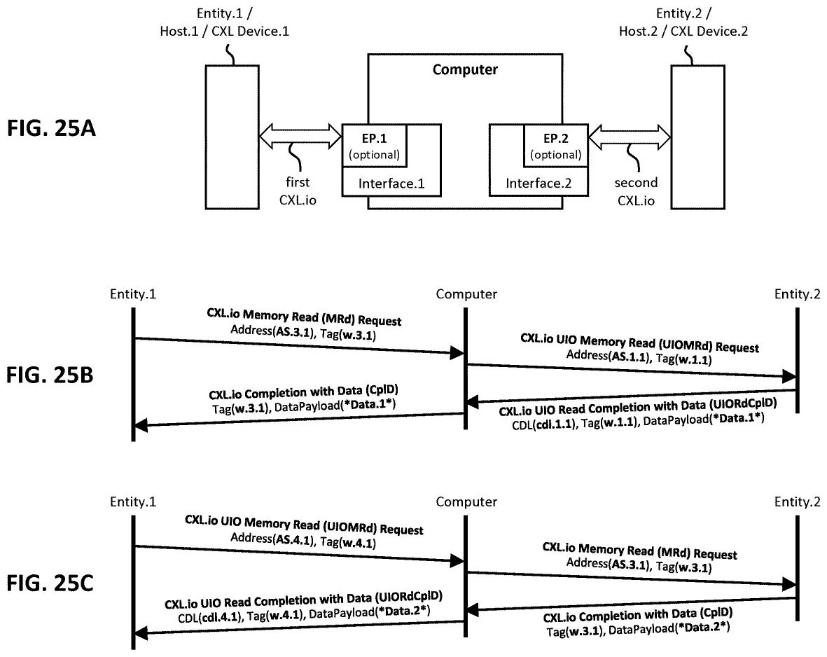

FIG. 25A illustrates an example of a system comprising a computer coupled between first and second interfaces. The first interface (Interface.1) may communicate according to first CXL.io, such as CXL.io conforming to CXL Specification Revision 1.1. The second interface (Interface.2) may communicate according to second CXL.io, such as CXL.io conforming to CXL Specification Revision 3.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first CXL.io with a first entity (Entity.1), which may be a first host (Host.1) or a first CXL device (CXL Device.1). The second interface may expose a second endpoint (EP.2) and may communicate according to the second CXL.io, with a second entity (Entity.2), which may be a second host (Host.2) or a second CXL device (CXL Device.2). The computer may extract physical addresses from first PDUs, such as first CXL.io TLPs, received via the first interface, wherein these addresses may refer to a first physical address space utilized by the first entity; translate these addresses; and generate second PDUs, such as second CXL.io TLPs, carrying the translated physical addresses for transmission via the second interface; wherein these translated addresses may correspond to a second physical address space utilized by the second entity.

FIG. 25B illustrates an example of a TFD demonstrating translations between CXL.io non-UIO TLPs associated with first CXL.io, received from a first entity (Entity.1), which may be a first host (Host.1) or a first CXL device (CXL Device.1), and CXL.io UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io non-UIO transaction that may include a CXL.io Memory Read (MRd) request comprising Address(AS.3.1) and Tag(w.3.1). A computer may translate the CXL.io non-UIO transaction to a CXL.io UIO transaction that may include a CXL.io UIO Memory Read (UIOMRd) request comprising Address(AS.1.1) and Tag(w.1.1), and may send the CXL.io UIOMRd to the second entity. Upon receiving a completion from the second entity, which may include a CXL.io UIO Read Completion with Data (UIORdCplD) comprising CDL(cdl.1.1), Tag(w.1.1), and DataPayload(*Data.1*), the computer may translate the CXL.io UIORdCplD to a CXL.io Completion with Data (CplD) comprising Tag(w.3.1) and DataPayload(*Data.1*), and send the CXL.io CplD to the first entity. CDL in CXL.io UIO completions may be populated with information related to QoS, such as QoS telemetry value or values. The second entity may utilize the CDL for throttling requests from the computer. The computer may perform additional translations, such as protocol translations, opcode translations, command translations, TLP type translations, Tag translations, length translations, or field translations.

Translations from CXL.io non-UIO to CXL.io UIO may enable CXL hosts and CXL devices to utilize additional capabilities on top of capabilities provided by CXL.io non-UIO, such as peer-to-peer flows to CXL.mem regions, QoS telemetry via CDL Devload (CDL) field in UIO completions, non-posted UIO writes, access to Global-Fabric-Attached Memory Devices (GFDs), use of the Global Integrated Memory (GIM), and cross-domain UIO accesses over a CXL fabric.

FIG. 25C illustrates an example of a TFD demonstrating translations between CXL.io UIO TLPs associated with first CXL.io, received from a first entity (Entity.1), which may be a first host (Host.1) or a first CXL device (CXL Device.1), and CXL.io non-UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io UIO transaction that may include a CXL.io UIOMRd comprising Address(AS.4.1) and Tag(w.4.1). A computer may translate the CLX.io UIO transaction to a CLX.io non-UIO transaction that may include a CXL.io MRd comprising Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to a CXL.io UIORdCplD comprising CDL(cdl.4.1), Tag(w.4.1), and DataPayload(*Data.2*), and send the CXL.io UIORdCplD to the first entity. CDL in CXL.io UIO completions may be populated with information related to QoS, such as QoS telemetry value or values. The computer may utilize CDL for throttling requests from the first entity. The computer may perform additional translations, such as protocol translations, opcode translations, command translations, TLP type translations, Tag translations, length translations, or field translations. Translations from CXL.io UIO to CXL.io non-UIO may enable newer CXL hosts and CXL devices to utilize legacy non-UIO resources over CXL fabrics and mixed CXL/PCIe fabrics.

PCIe UIO is a capability that enables fabrics with multiple paths between a source and destination, more closely matching the semantics of common IO fabrics including on-die fabrics. UIO shifts the responsibility for enforcing observed ordering from the fabric to the requester, simplifying fabric elements such as switches. All UIO requests have corresponding UIO Completions, which provide the requester with the ability and responsibility to enforce ordering requirements. However, UIO may only be used when the entire path from requester to completer uses Flit Mode, supports UIO, and has UIO enabled. In environments where requesters that do not utilize UIO need to access resources via UIO-enabled paths, or where UIO requesters need to access resources via non-UIO paths, translations between PCIe UIO and PCIe non-UIO TLPs may enable access to multi-path routing benefits or may manage the transition between different ordering models. Such translations may be performed by a computer located between the requester and completer.

In various implementations, a method for enabling multi-path routing for a requester, comprising: receiving, from a first entity that does not utilize Unordered Input/Output (UIO), a Peripheral Component Interconnect Express (PCIe) memory request; translating, by a computer, the PCIe memory request to a PCIe UIO memory request; sending the PCIe UIO memory request to a second entity via a path supporting multi-path routing; receiving, from the second entity, a PCIe UIO Completion; translating, by the computer, the PCIe UIO Completion to a PCIe non-UIO Completion; and sending the PCIe non-UIO Completion to the first entity. The translation from non-UIO to UIO may enable a first entity that does not support UIO capabilities to access resources via paths that support multi-path routing. Multi-path routing may provide benefits such as higher bandwidth through utilization of parallel paths, lower latency through selection of less congested paths, and improved fault tolerance through availability of alternative paths when failures occur. The computer may perform the translation transparently, such that the first entity is unaware that the downstream path utilizes UIO. The method may be implemented in hardware, firmware, software, or combinations thereof.

In some implementations of the method, the path supporting multi-path routing comprises a fabric providing concurrent paths between the computer and the second entity. Non-UIO PCIe fabrics typically utilize tree topologies where a single path exists between any source and destination. UIO may enable fabric topologies where concurrent paths exist between a source and destination, permitting the fabric to distribute traffic across multiple paths for load balancing or to select alternative paths based on congestion or fault conditions. The fabric providing concurrent paths may include switches, bridges, or other routing elements that support UIO and implement mechanisms to manage multi-path routing while avoiding deadlocks and loops. Such topologies may include mesh interconnects, redundant link configurations, or parallel switch fabrics.

In some implementations of the method, the PCIe UIO memory request is routed via one of the concurrent paths selected based on at least one of: load balancing, congestion avoidance, or fault tolerance. Load balancing may distribute requests across available paths to maximize aggregate bandwidth utilization. Congestion avoidance may route requests away from paths experiencing high utilization or backpressure. Fault tolerance may enable continued operation when one or more paths become unavailable due to link failures, device failures, or maintenance activities. The selection mechanism may be implemented in the fabric routing elements using techniques such as adaptive routing algorithms, weighted path selection, or explicit path specification.

In some implementations of the method, the PCIe memory request comprises a non-UIO Memory Read (MRd) request comprising a first address and a first Tag, wherein the PCIe UIO memory request comprises a UIO Memory Read (UIOMRd) request comprising a second address and a second Tag, wherein the PCIe UIO Completion comprises a UIO Read Completion with Data (UIORdCplD), and wherein the PCIe non-UIO Completion comprises a non-UIO Completion with Data (CplD). The MRd from the first entity may conform to PCIe memory read with fabric-based ordering. The computer may translate the MRd to a UIOMRd for transmission to the second entity via the multi-path fabric. Upon receiving the UIORdCplD from the second entity, the computer may translate it to a CplD in the non-UIO completion format expected by the first entity.

In some implementations, the method further comprises receiving, from the first entity, a PCIe non-UIO Memory Write request (MWr) comprising write data; translating, by the computer, the PCIe MWr to a PCIe UIO Memory Write request (UIOMWr) comprising the write data; sending the PCIe UIOMWr to the second entity via the path supporting multi-path routing; and receiving, from the second entity, a PCIe UIO Write Completion (UIOWrCpl). The translation from non-UIO to UIO write may convert a posted write that does not expect a completion into a non-posted write that receives a UIOWrCpl from the second entity. The UIOWrCpl may provide end-to-end acknowledgment that the write data has been received by the second entity, which the computer may utilize for flow control, error handling, or telemetry collection. The UIOMWr may be sent to the second entity via the path supporting multi-path routing, taking advantage of load balancing or alternative routing available on that path.

In some implementations of the method, the computer translates the PCIe MWr to multiple PCIe UIO Memory Write requests, and wherein the multiple PCIe UIO Memory Write requests are sent via respective paths to multiple second entities, wherein the write data is distributed across the second entities according to a striping scheme. The striping scheme may distribute sequential portions of the write data across the second entities, enabling parallel write operations that increase aggregate write bandwidth. The computer may split the write data into stripes based on configurable stripe sizes, address ranges, or device characteristics. Each PCIe UIO Memory Write request may carry a portion of the original write data to a respective second entity. The computer may receive UIOWrCpl from each of the second entities and may use these completions for internal flow control, error tracking, or telemetry collection.

In some implementations of the method, the computer translates the PCIe MWr to multiple PCIe UIO Memory Write requests comprising essentially identical write data, and wherein the multiple PCIe UIO Memory Write requests are sent via respective paths to multiple second entities for data mirroring. Data mirroring may provide redundancy by writing essentially identical copies of the write data to second entities. The computer may generate multiple PCIe UIO Memory Write requests each carrying essentially the same write data for transmission to different second entities. The mirroring may enable fault tolerance wherein data remains accessible from surviving second entities if one or more second entities fail.

In some implementations of the method, the computer generates parity data based on the write data, translates the PCIe MWr to multiple PCIe UIO Memory Write requests comprising data chunks and parity chunks, and sends the multiple PCIe UIO Memory Write requests via respective paths to multiple second entities. Erasure coding may provide fault tolerance with improved storage efficiency compared to mirroring. The computer may compute parity chunks from the write data using erasure coding algorithms such as Reed-Solomon coding, XOR-based parity, or other error-correction schemes. The data chunks and parity chunks may be distributed across the second entities such that the original write data can be reconstructed from a subset of the chunks if one or more second entities become unavailable.

In some implementations of the method, the PCIe memory request comprises a first physical address in a first physical address space utilized by the first entity, and wherein the PCIe UIO memory request comprises a second physical address in a second physical address space utilized by the second entity. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a legacy PCIe host, a legacy PCIe device, a GPU, or a NIC that does not support UIO; and wherein the second entity comprises at least one of a memory device, a memory expander, a memory pool, a Global Fabric-Attached Memory device (GFD), or a PCIe device supporting UIO. Legacy PCIe hosts and devices may not support UIO due to hardware generation, firmware limitations, or configuration choices. GPUs and NICs may benefit from multi-path routing for memory access operations even when they do not natively support UIO. Memory devices, memory expanders, memory pools, and GFDs may be deployed in fabric configurations that support multi-path routing to provide high-bandwidth, low-latency memory access to multiple requesters. The translation performed by the computer may enable these legacy or non-UIO devices to access the benefits of multi-path fabrics.

In various implementations, a system for enabling multi-path routing for a requester, comprising: a first interface configured to communicate with a first entity that does not utilize Unordered Input/Output (UIO); a second interface configured to communicate with one or more second entities via a path supporting multi-path routing; and a computer coupled between the first interface and the second interface, the computer configured to: receive, via the first interface, a Peripheral Component Interconnect Express (PCIe) memory request from the first entity; translate the PCIe memory request to a PCIe UIO memory request; send, via the second interface, the PCIe UIO memory request to at least one of the second entities; receive, via the second interface, a PCIe UIO Completion from the at least one of the second entities; translate the PCIe UIO Completion to a PCIe non-UIO Completion; and send, via the first interface, the PCIe non-UIO Completion to the first entity. The system may enable a first entity that does not support UIO capabilities to access resources via paths that support multi-path routing. The second interface may be coupled to the second entities, enabling the computer to distribute requests across devices for load balancing, fault tolerance, or data distribution schemes such as striping or mirroring. The system may be implemented as a semiconductor device, a switch, a bridge, or other suitable device positioned between the first entity and the second entities.

In some implementations of the system, the computer is configured to send the PCIe UIO memory request to one or more of the second entities based on at least one of: address mapping, load balancing, or a data distribution policy. The computer may select which of the second entities receives the PCIe UIO memory request based on address mapping that assigns address ranges to specific second entities, load balancing that distributes requests to minimize congestion, or a data distribution policy that implements striping, mirroring, or erasure coding across the second entities. The second interface may include ports or channels to communicate with the second entities concurrently.

In some implementations of the system, at least two of the second entities utilize different physical address spaces, and wherein the computer comprises address translation logic configured to translate a physical address from the first entity to respective physical addresses for each of the at least two of the second entities. The different physical address spaces may have different base addresses, different sizes, and/or different memory layouts. The address translation logic may maintain separate translation tables or mappings for each of the second entities, enabling the computer to translate an address from the first entity into different addresses for the respective second entities. This capability may enable unified addressing from the perspective of the first entity while accommodating heterogeneous memory configurations across the second entities.

In some implementations of the system, the computer is further configured to implement at least one of: data striping across the second entities, data mirroring to the second entities, or erasure coding with parity distribution across the second entities. The computer may include logic to split write data into stripes for distribution across the second entities, to replicate write data for mirroring to the second entities, or to compute parity chunks for erasure coding distribution. The computer may also include logic to reassemble striped read data from the second entities, to select among mirrored copies for read operations, or to reconstruct data from erasure-coded chunks when one or more of the second entities are unavailable. The computer may operate transparently to the first entity, presenting a unified memory view while implementing the selected data distribution scheme.

In some implementations of the system, the second interface is coupled to a fabric comprising physical paths to the one or more of the second entities, and wherein the computer is configured to select among the physical paths based on path availability or congestion. The fabric may include redundant links, parallel switch paths, or mesh interconnect topologies that provide concurrent paths between the computer and the one or more of the second entities. The computer may monitor path availability and congestion indicators to select paths that optimize latency, bandwidth, or reliability. Path selection may be performed per-request, per-flow, or at other granularities based on system requirements.

In various implementations, a method for managing ordering in translation, comprising: receiving, from a first entity, a Peripheral Component Interconnect Express (PCIe) Unordered Input/Output (UIO) memory request, wherein the first entity is configured to enforce ordering requirements for the PCIe UIO memory request; translating, by a computer, the PCIe UIO memory request to a PCIe non-UIO memory request; sending the PCIe non-UIO memory request to a second entity via a path that enforces fabric-based ordering; receiving, from the second entity, a PCIe non-UIO Completion; translating, by the computer, the PCIe non-UIO Completion to a PCIe UIO Completion; and sending the PCIe UIO Completion to the first entity. UIO shifts the responsibility for enforcing observed ordering from the fabric to the requester, whereas non-UIO PCIe relies on fabric-based ordering rules. When translating from UIO to non-UIO, the computer may manage this transition by translating requests from a domain where the requester enforces ordering to a domain where the fabric enforces ordering. The first entity, utilizing UIO, may issue requests with the expectation that completions may arrive in various orders and that the first entity bears responsibility for ordering requirements. The non-UIO path to the second entity may enforce ordering according to non-UIO PCIe rules. The computer may bridge these different ordering models while maintaining correct transaction semantics on each side.

In some implementations of the method, the first entity is configured to accept PCIe UIO Completions without a predetermined order, and to enforce ordering requirements based on completion arrival. UIO requesters may accept UIO Completions in various orders according to PCIe UIO specifications. The first entity may implement ordering enforcement mechanisms such as completion reordering buffers, sequence number tracking, or dependency tracking to enforce required ordering based on the order in which completions arrive. This requester-based ordering may simplify fabric elements by removing the need for in-order completion delivery while placing ordering responsibility on the endpoints.

In some implementations of the method, the path that enforces fabric-based ordering enforces producer-consumer ordering rules based on PCIe specifications, and wherein the computer is configured to track pending transactions to correlate the PCIe non-UIO Completion with the PCIe UIO memory request. PCIe fabric ordering rules may include requirements such as posted requests not passing other posted requests to the same destination, completions not being blocked by requests, and non-posted requests maintaining ordering with respect to posted requests. These producer-consumer ordering rules may enable PCIe devices to operate correctly without implementing ordering enforcement logic. The computer may maintain tracker entries or pending transaction tables to associate incoming completions with their corresponding requests, enabling correct translation of completions back to the UIO domain with appropriate Tag restoration.

In some implementations of the method, the PCIe UIO memory request comprises a UIO Memory Read (UIOMRd) request comprising a first address and a first Tag, wherein the PCIe non-UIO memory request comprises a non-UIO Memory Read (MRd) request comprising a second address and a second Tag, wherein the PCIe non-UIO Completion comprises a non-UIO Completion with Data (CplD), and wherein the PCIe UIO Completion comprises a UIO Read Completion with Data (UIORdCplD). The UIOMRd from the first entity may be issued with the expectation of out-of-order completion delivery. The computer may translate the UIOMRd to an MRd for transmission to the second entity, where the fabric may enforce ordering with respect to other transactions. Upon receiving the CplD from the second entity, the computer may translate it to a UIORdCplD for delivery to the first entity.

In some implementations, the method further comprises receiving, from the first entity, a PCIe UIO Memory Write request (UIOMWr) comprising a Tag and write data, wherein the first entity expects a UIO Write Completion (UIOWrCpl) for the UIOMWr; translating, by the computer, the PCIe UIOMWr to a PCIe non-UIO Memory Write request (MWr) comprising the write data; sending the PCIe MWr to the second entity via the path that enforces fabric-based ordering; and sending, to the first entity, a PCIe UIOWrCpl comprising the Tag. The translation from UIO to non-UIO write may involve converting a non-posted write that expects a completion into a posted write that does not return a completion from the second entity. The first entity, utilizing UIOMWr, may expect a UIOWrCpl to confirm write completion and to enforce ordering requirements. The computer may generate the UIOWrCpl to satisfy the first entity's expectation, even though the MWr sent to the second entity is posted and does not receive a completion. The fabric-based ordering on the non-UIO path may provide ordering guarantees that the first entity would otherwise need to enforce based on UIOWrCpl arrival.

In some implementations of the method, the computer sends the UIOWrCpl to the first entity at one of: before sending the PCIe MWr to the second entity, in parallel with sending the PCIe MWr to the second entity, or after the computer receives acknowledgment that the PCIe MWr has been accepted by a downstream component. Sending the UIOWrCpl before sending the MWr may reduce latency observed by the first entity, enabling the first entity to proceed with subsequent operations and enforce required ordering based on early completion notification. Sending the UIOWrCpl in parallel with the MWr may balance latency and ordering considerations. Sending the UIOWrCpl after receiving downstream acknowledgment may provide stronger guarantees that the write data has progressed toward the second entity before the first entity receives completion notification. The selection between these timing options may be configurable or may be determined dynamically based on system conditions.

In some implementations of the method, the UIOWrCpl comprises a CXL DevLoad (CDL), and wherein the computer populates the CDL with Quality-of-Service (QoS) telemetry information based on at least one of: queue depth at the computer, observed latency, or congestion indicators. The computer may populate the CDL with locally generated telemetry information since the posted MWr sent to the second entity does not return a completion carrying telemetry. The first entity may utilize this telemetry to make informed decisions about subsequent write operations, such as throttling write rates or selecting alternative destinations based on observed conditions at the computer.

In some implementations of the method, the PCIe UIO memory request comprises a first physical address in a first physical address space utilized by the first entity, and wherein the PCIe non-UIO memory request comprises a second physical address in a second physical address space utilized by the second entity. The address translation may enable the first entity to access resources at the second entity utilizing physical addresses within a physical address space utilized by the first entity, while the computer translates to physical addresses appropriate for the physical address space utilized by the second entity. The translation may be implemented utilizing lookup tables, page tables, base-and-offset calculations, or programmable translation functions.

In some implementations of the method, the first entity comprises at least one of a UIO-capable host, a UIO-capable GPU, a UIO-capable NIC, or a UIO-capable accelerator, and wherein the second entity comprises at least one of a legacy PCIe device, a legacy PCIe host, a memory device, or a storage controller that does not support UIO. UIO-capable hosts, GPUs, NICs, and accelerators may implement UIO to benefit from multi-path routing, out-of-order completion handling, or simplified fabric interactions. Legacy PCIe devices and hosts may not support UIO due to hardware generation or design choices. Memory devices and storage controllers may operate using PCIe with fabric-based ordering. The translation performed by the computer may enable UIO-capable devices to access these legacy or non-UIO resources while maintaining correct ordering on each side of the translation boundary.

In various implementations, a system for managing ordering in translations, comprising: a first interface configured to communicate with a first entity that utilizes Peripheral Component Interconnect Express (PCIe) Unordered Input/Output (UIO) and is configured to enforce ordering requirements; a second interface configured to communicate with a second entity via a path that enforces fabric-based ordering; and a computer coupled between the first interface and the second interface, the computer configured to: receive, via the first interface, a PCIe UIO memory request from the first entity; translate the PCIe UIO memory request to a PCIe non-UIO memory request; send, via the second interface, the PCIe non-UIO memory request to the second entity; receive, via the second interface, a PCIe non-UIO Completion from the second entity; translate the PCIe non-UIO Completion to a PCIe UIO Completion; and send, via the first interface, the PCIe UIO Completion to the first entity. The system may bridge different ordering models, translating between UIO where the requester enforces ordering and non-UIO where the fabric enforces ordering. The system may enable UIO-capable devices to access legacy PCIe infrastructure while maintaining correct transaction semantics on each side of the translation boundary.

In some implementations of the system, the computer comprises ordering management logic configured to receive PCIe UIO memory requests arriving at the computer without fabric-based ordering, and to send corresponding PCIe non-UIO memory requests via the path that enforces fabric-based ordering according to producer-consumer ordering rules. The ordering management logic may buffer or queue incoming PCIe UIO memory requests and may release corresponding PCIe non-UIO memory requests according to the ordering constraints of the non-UIO path. The ordering management logic may implement mechanisms to prevent deadlocks that could arise from the interaction between UIO and non-UIO ordering models.

In some implementations of the system, the computer comprises tracker entries, each tracker entry configured to store state information for a pending transaction including a mapping between a first Tag from the PCIe UIO memory request and a second Tag for the PCIe non-UIO memory request. The tracker entries may enable the computer to correlate incoming PCIe non-UIO Completions with their corresponding PCIe UIO memory requests, enabling correct restoration of Tags when translating completions back to the UIO domain. The tracker entries may support concurrent transactions, with each entry tracking a separate pending operation.

In some implementations of the system, the computer comprises completion generation logic configured to generate PCIe UIO Completions for PCIe UIO Memory Write requests when the PCIe non-UIO memory request comprises a posted write that does not receive a completion from the second entity. The completion generation logic may generate UIOWrCpl to satisfy the first entity's expectation of completion acknowledgment for non-posted UIO writes, even though the translated MWr sent to the second entity is posted and does not return a completion. The completion generation logic may determine the timing of completion generation based on configuration settings, system conditions, or ordering requirements.

In some implementations of the system, the computer is further configured to translate between a first physical address belonging to a first physical address space utilized by the first entity and a second physical address belonging to a second physical address space utilized by the second entity. The computer may utilize lookup tables, translation lookaside buffers, page table walkers, or programmable translation functions for the address translation, which may enable the first entity to access resources at the second entity utilizing physical addresses within an address space utilized by the first entity, while the second entity operates utilizing physical addresses within a different address space.

In some implementations of the system, the first entity comprises at least one of a UIO-capable GPU, a UIO-capable NIC, or a UIO-capable accelerator, and wherein the second entity comprises at least one of a legacy PCIe memory device, a legacy PCIe storage controller, or a legacy PCIe host. UIO-capable GPUs, NICs, and accelerators may implement UIO to benefit from multi-path routing, out-of-order completion handling, or simplified fabric interactions in modern datacenter and high-performance computing environments. Legacy PCIe memory devices, storage controllers, and hosts may operate using PCIe with fabric-based ordering. The system may bridge these different device generations and capabilities, enabling modern UIO-capable devices to access legacy infrastructure.

In various implementations, a system capable of changing its functionality, comprising: memory channels designed to communicate with memory; processing cores, coupled via a coherent interconnect, configured to utilize addresses within a first physical address space to access the memory via the memory channels, and to respond to snoop requests that include physical addresses within the first physical address space; memory management units (MMUs) configured to translate virtual addresses to physical addresses within the first physical address space responsive to memory access requests from the processing cores; first and second ports capable of exposing a Compute Express Link (CXL) type-3 device when the system functions as a Multi-Headed Device (MHD), or operate as switch ports when the system functions as a switch; and wherein when the system functions as the MHD, the system is configured to route data from the first and second ports to the memory channels, and when the system functions as the switch, the system is configured to route data between the first and second ports. The system may dynamically switch between operating as a Multi-Headed Device that provides memory resources to hosts and operating as a CXL switch that routes traffic between ports. The dual functionality may be configured utilizing firmware settings, hardware strapping, or software configuration.

In some implementations, the system further comprises a resource provisioning unit (RPU); wherein when the system functions as the MHD, the first and second ports are configured to be coupled to hosts, and the RPU is configured to enable the hosts to access the memory utilizing messages that at least conforming to a protocol based on CXL.mem. When functioning as an MHD, the RPU may perform address translations to enable hosts to access shared memory resources. Different hosts may view the memory through their own physical address spaces while the RPU manages the mapping to physical memory locations.

In some implementations of the system, the memory comprises dynamic random-access memory (DRAM) having a capacity of at least 32 GB coupled via at least four memory channels to the processing cores. The at least 32 GB of DRAM may be distributed across four or more memory channels to provide parallel access paths and increased memory bandwidth. The memory channels may operate separately to serve different memory requests concurrently.

In some implementations of the system, the memory comprises dynamic random-access memory (DRAM) having capacity exceeding 250 GB; and wherein the DRAM comprises mainstream DRAM modules exhibiting an average unit price per gigabyte that does not exceed three times an average unit price per gigabyte of a lowest-cost DRAM module technology in volume production for servers in data centers. Mainstream DRAM modules may refer to widely deployed memory technologies such as DDR4 or DDR5 modules in standard capacities. The pricing constraint ensures the system uses cost-effective memory solutions rather than specialized high-cost memory technologies.

In some implementations of the system, at least one of the processing cores supports Simultaneous Multithreading (SMT), and wherein the RPU is further configured to maintain separate address translation contexts for hardware threads executing on the at least one of the processing cores supporting SMT, enabling concurrent transactions based on CXL requests from the hosts. SMT support in MHD mode may enable the processing cores to handle concurrent memory requests from different hosts or different processes within hosts. Different hardware threads may have different translation contexts maintained by the RPU.

In some implementations, the system further comprises a Trusted Platform Module (TPM) interface, wherein the RPU is configured to utilize cryptographic keys stored in the TPM to authenticate CXL requests from the hosts before performing translation of physical addresses. TPM-based authentication in MHD mode may provide security for shared memory access by verifying that memory requests originate from authorized hosts. The TPM may store cryptographic keys used for request authentication and data encryption.

In some implementations, the system further comprises a resource provisioning unit (RPU); wherein when the system functions as the switch, the first and second ports are configured to forward CXL messages between hosts coupled to the first and second ports, and the RPU is configured to translate physical addresses within a host physical address space utilized by a first host coupled to the first port to a host physical address space utilized by a second host coupled to the second port. When functioning as a switch, the system may route CXL messages between ports while the RPU performs address translations to enable communication between hosts using different physical address spaces, which enables physical address space isolation between different hosts.

In some implementations of the system, the first port is configured as an upstream port and the second port is configured as a downstream port, enabling hierarchical CXL fabric connectivity. The upstream port may connect to a host or higher-level switch, while the downstream port may connect to CXL devices or lower-level switches. This configuration enables building hierarchical CXL topologies.

In some implementations, the system further comprises third and fourth ports, and wherein the third and fourth ports are configured as additional downstream ports, enabling the system to connect CXL devices in a switched fabric topology. Additional downstream ports may enable the system to function as a multi-port switch connecting several CXL devices to an upstream host. The switch may implement routing tables to direct traffic between the upstream port and appropriate downstream ports.

In some implementations of the system, the first and second ports support forwarding of CXL.mem, CXL.cache, and CXL.io traffic between the coupled hosts. Supporting the three CXL protocols in switch mode may enable the system to forward different types of CXL traffic including memory transactions CXL.mem, cache-coherent transactions CXL.cache, and I/O transactions CXL.io between coupled devices.

In some implementations of the system, the coherent interconnect is an on-chip coherent interconnect designed to couple the memory channels, the processing cores, and the MMUs, which are disposed in an integrated circuit package. The on-chip coherent interconnect may be implemented as a network-on-chip, mesh, or ring topology that provides communication paths between system components. Integration in an IC package may reduce latency and increase bandwidth compared to multi-chip implementations.

In some implementations of the system, the processing cores are configured to execute instructions compatible with an ×86 instruction set architecture, at least one of the MMUs is designed to support first-level address translation, and further comprising a secondary translation unit for second-level address translation (SLAT) for hardware-assisted virtualization. The ×86 compatibility may enable the system to run operating systems and applications designed for ×86 processors. The SLAT capability may support efficient virtualization for running virtual machines with isolated address spaces.

In some implementations, the system further comprises at least three levels of in-package cache memory, having an aggregated capacity of at least 4 MB, coupled to the coherent interconnect; and wherein each of the first and second ports comprises at least 16 lanes available for communication. The cache hierarchy may include L1, L2, and L3 caches with the 4 MB minimum referring to total cache capacity. The 16-lane ports may operate at CXL-specified speeds to provide high-bandwidth connections to external devices.

In some implementations of the system, the processing cores are configured to execute instructions compatible with a RISC-based instruction set architecture, at least one of the MMUs is designed to support first-level address translation, and further comprising at least two levels of in-package cache memory coupled to the coherent interconnect, wherein a last level of the in-package cache memory has a capacity of at least 4 MB. The RISC-based architectures may provide power-efficient processing suitable for memory-centric workloads. The two-level cache hierarchy may balance performance with area and power constraints typical of RISC implementations.

In some implementations of the system, the RISC-based instruction set architecture is selected from a group comprising ARM-class instruction set architecture or RISC-V class instruction set architecture; wherein each of the first and second ports comprises at least 16 lanes available for communication; and further comprising a stage-two translation unit configured to translate guest physical addresses to physical addresses within the first physical address space. The ARM or RISC-V architectures may support specific virtualization extensions that enable efficient virtual machine operation. The stage-two translation unit may handle guest-to-host physical address translations required for virtualization.

In some implementations of the system, the processing cores comprise at least 50 streaming multiprocessors configured to execute instructions compatible with NVIDIA's Compute Unified Device Architecture (CUDA) parallel computing platform; wherein the memory channels support at least one of Graphics Double Data Rate (GDDR) memory or High Bandwidth Memory (HBM); and further comprising at least two levels of in-package cache memory coupled to the coherent interconnect, wherein a last level of the in-package cache memory has a capacity of at least 500 KB. The CUDA-compatible streaming multiprocessors may enable the system to execute GPU workloads while providing CXL connectivity. GDDR or HBM memory interfaces may deliver the high bandwidth required for GPU computations.

In some implementations of the system, the first and second ports are configured to expose CXL devices, and the system is further configured to implement at least one of: (i) Device-to-Host (D2H) cache coherency flows; or (ii) back-invalidation snoop flows for maintaining coherency. The D2H cache coherency flows may enable the CXL devices to participate in cache coherency protocols with coupled hosts. Back-invalidation snoops may maintain cache consistency when memory contents are modified.

In some implementations of the system, the processing cores comprise level 1(L1) caches, and wherein the processing cores are configured to maintain cache coherency between the L1 caches utilizing the snoop requests. The L1 cache coherency may be maintained utilizing a coherency protocol that tracks cacheline states and generates snoop requests when cores access potentially shared data. The snoop requests ensure data consistency across the L1 caches.

To improve yield and reduce development costs, a processing unit may leverage intentional reservation of silicon area as a repurposed area (which may also be referred to as a designated area) to improve manufacturing yield and reduce time to market. Design blocks that reside in the repurposed areas are not mandatory for correct operation of the un-modified xPU, and may be replaced by other design blocks to create different types of MxPUs with different features and functional behaviors. By reserving an area in a die floorplan of an established xPU silicon design for a repurposed area, it may be possible to reuse the established silicon design, along with its core floorplan, packaging, and substrate, more rapidly compared to developing an entirely new design that removes the repurposed area from the silicon die, potentially reducing development time and associated costs while maintaining the original die size and layout. Additionally, this approach may allow for quicker adaptation of established designs to create new product variants, leveraging established manufacturing processes and potentially minimizing the need for extensive redesign and validation efforts typically associated with the development of new chip layouts, thereby streamlining the overall product development cycle.

In various implementations, a modified processing unit (MxPU) comprising: memory channels capable of communicating with memory located outside the MxPU; a silicon die comprising (i) processing cores, coupled via a coherent interconnect, configured to utilize a first physical address space to access the memory via the memory channels, and (ii) a repurposed area occupying a space equivalent to at least one processing core; a communication port, selected from a Compute Express Link (CXL) endpoint, a CXL switch port, an NVLink port, or a UALink port, configured to receive messages comprising physical addresses within a second physical address space; a resource provisioning unit (RPU) configured to translate physical addresses within the second physical address space to physical addresses within the first physical address space; and wherein the repurposed area, which was originally designed to accommodate at least one processing core, accommodates at least one of the communication port or the RPU.

In some implementations of the MxPU, the repurposed area comprises a repurposed impaired area comprising at least one electrically disabled processing core. The repurposed impaired area may be created by electrically disabling one or more processing cores that were part of the original xPU design. This electrical disabling may be accomplished utilizing various methods such as power gating, clock gating, fuse programming, or other techniques that render the core non-functional while preserving the physical silicon area. By electrically disabling one or more cores rather than physically removing them from the silicon die, the MxPU may maintain the original die dimensions and layout, potentially allowing for the reuse of established packaging, thermal solutions, and manufacturing processes while creating space for implementing alternative functional blocks such as the communication port or RPU.

In some implementations of the MxPU, the at least one of the communication port or the RPU draws operating power through a power rail originally designed to supply power to the repurposed area. The MxPU may leverage existing power distribution infrastructure by repurposing power rails that were originally designed to supply the processing cores in the repurposed area, which may enable efficient power delivery to the communication port or RPU without requiring extensive redesign of the power distribution network. The power rails may include metal layers, vias, and power delivery components that were already optimized for the original die layout, potentially reducing development time and maintaining established power integrity characteristics while supplying the newly implemented functional blocks.

In some implementations of the MxPU, the repurposed area comprises a repurposed impaired area, and wherein the at least one of the communication port or the RPU receives a clock signal through a clock distribution network originally designed to provide clock signals to the repurposed impaired area. The MxPU may utilize existing clock distribution infrastructure by tapping into clock networks that were originally designed for the processing cores in the repurposed impaired area. Clock distribution networks are typically complex structures requiring careful design to minimize skew and jitter, and redesigning these networks late in the development cycle may be costly and time-consuming. By maintaining the existing clock distribution segments and inserting appropriate buffers or clock receivers, the communication port or RPU may obtain necessary clock signals without requiring extensive clock tree re-synthesis or re-layout, potentially preserving timing closure achievements from the original design while reducing development complexity.

In some implementations of the MxPU, the at least one of the communication port or the RPU is coupled to the coherent interconnect via an interconnect port originally designed for coupling the repurposed area to the coherent interconnect. The MxPU may reuse existing interconnect infrastructure by electrically reassigning interconnect fabric ports that were originally allocated to processing cores in the repurposed area. The coherent interconnect typically includes ports for coupling various components, wherein the ports may have associated routing, arbitration circuits, and protocol interfaces. By reusing an existing interconnect port for the communication port or RPU, the MxPU design may minimize changes to global routing and interconnect topology, potentially preserving timing closure margins and reducing verification complexity. This approach may enable the new functional blocks to communicate with other system components through established interconnect pathways without requiring extensive modifications to the interconnect fabric architecture.

In some implementations, the MxPU further comprises a memory management unit (MMU); wherein the memory located outside the MxPU comprises at least 64 GB of dynamic random-access memory (DRAM) coupled via the memory channels, wherein the first physical address space is a Host Physical Address (HPA) space, and the MMU is configured to map addresses within a virtual address space, utilized by an operating system of the MxPU, to physical addresses within the first physical address space. The MMU may enable the operating system running on the MxPU to utilize virtual addressing, which may provide memory protection, process isolation, and flexible memory allocation. The coupling of at least 64 GB of DRAM via the memory channels may provide sufficient memory capacity for memory pooling applications, wherein the MxPU may serve as a memory resource for external entities. The first physical address space being an HPA space may enable coherent memory access across system components and may establish a unified addressing scheme for the MxPU's resources.

In some implementations of the MxPU, the processing cores are configured to execute instructions compatible with an ×86 instruction set architecture; and further comprising at least three levels of in-package cache memory coupled to the coherent interconnect, and wherein a third level of the in-package cache memory has a capacity of at least 4 MB. The MxPU may be based on ×86 architecture, which may provide compatibility with a wide range of existing software and operating systems. The inclusion of at least three levels of in-package cache memory, with the third level (typically the last level cache or LLC) having at least 4 MB capacity, may provide a cache hierarchy that can improve memory access performance. This cache hierarchy may be beneficial when the MxPU serves as a CXL memory device, as the LLC may cache frequently accessed data from external entities, potentially reducing access latency compared to direct DRAM access.

In some implementations of the MxPU, the processing cores are configured to execute instructions compatible with a RISC-based instruction set architecture selected from ARM instruction set architecture or RISC-V instruction set architecture, and further comprising at least two levels of in-package cache memory coupled to the coherent interconnect, and wherein a last level of the in-package cache memory has a capacity of at least 4 MB. The MxPU may be based on RISC architectures such as ARM or RISC-V, which may provide power efficiency and scalability advantages for memory pooling applications. The inclusion of at least two levels of in-package cache memory, with the last level having substantial capacity of at least 4 MB, may help reduce memory access latency and improve overall system performance. The cache hierarchy may work in conjunction with the coherent interconnect to maintain data consistency across the processing cores and external accesses through the communication port.

In some implementations of the MxPU, the processing cores comprise streaming multiprocessors (SM) configured to execute instructions compatible with NVIDIA's Compute Unified Device Architecture (CUDA) parallel computing platform, and wherein a number of the streaming multiprocessors exceeds 50. The MxPU may be based on GPU architecture utilizing NVIDIA's CUDA platform, wherein the processing cores are implemented as streaming multiprocessors (SM) optimized for parallel computation. Having more than 50 streaming multiprocessors may provide substantial parallel processing capability, which may be beneficial for certain memory access patterns and workloads. This GPU-based MxPU architecture may be suitable for applications that benefit from high memory bandwidth and parallel memory access capabilities, while the repurposed area may accommodate the communication port and RPU functionality needed for CXL-based or UALink-based memory pooling.

In some implementations of the MxPU, a design of the MxPU was derived from an established CPU or GPU design comprising a second silicon die, and wherein the silicon die of the MxPU has a die size within ±9 % of the die size of the second silicon die of the established CPU or GPU design. The MxPU may be manufactured with one or more repurposed impaired areas while retaining a comparable die size of an established CPU or GPU design. This approach may improve the effective manufacturing yield of silicon dies comprising the MxPU devices because the repurposed impaired areas may not be required to pass the stringent functional correctness testing during the production phases of the MxPU, as they were originally required during the production phases of the established CPU or GPU design. Consequently, the impact of defects may be mitigated, leading to a higher effective manufacturing yield, which may contribute to reducing the manufacturing costs associated with the production of such MxPU devices. Additionally or alternatively, utilizing such repurposing and impairment techniques may reduce design and manufacturing costs associated with creating additional product variants, by identifying die areas associated with functionalities that are deemed unnecessary (hence functionally impaired) for specific product variants, and basing those MxPU variants on changes made in the repurposed impaired areas of an established CPU or GPU design. In this context, “established” refers to a design that exists at the time of making the modification, which may be well after the date of filing this patent application, and indicates a pre-existing design without implying a specific timeframe relative to the date of filing this patent application. Alternative words that could convey a similar meaning include current, pre-designed, previously developed, legacy, available, already-designed, in-use, or prevailing. These terms aim to describe a silicon die design that is already in existence and potentially in use at the time the modification, the impairment, and/or the chopping-out is implemented, regardless of when the design was originally created or when this patent application was filed.

In some implementations of the MxPU, a design of the MxPU was derived from an established CPU or GPU design, and the MxPU retains memory controllers of the established CPU or GPU design. The MxPU may be derived from an established CPU/GPU design such that it is manufactured with one or more repurposed areas while retaining the memory controllers supported by the established design. By repurposing one or more processing cores as impaired areas without affecting the memory controller operation, the design may be optimized for its intended purpose in scenarios that require retaining maximum memory capacity. Non-limiting examples of intended purposes include memory pool, memory switch, memory processor, or protocol translator. This modification may allow for more cost-effective production of the MxPU while preserving its ability to provision a larger memory capacity, a capability inherent to the established CPU/GPU design and beneficial for memory-intensive applications and workloads.

In some implementations of the MxPU, a design of the MxPU was derived from an established CPU or GPU design that included CXL root ports, and the MxPU retains the CXL root ports of the established CPU or GPU design. For the purpose of designing and manufacturing a memory processor or a memory switch, repurposing processing cores as impaired areas without affecting the CXL ports of the established CPU/GPU design may enable creating additional stock keeping units (SKUs) with minimal or no redesign of the floorplan and with minimal changes to the masks used during manufacturing. This approach may allow manufacturers to obtain additional product variants without incurring the full costs associated with rebuilding the floorplan layout, potentially reducing time-to-market and development expenses while maintaining the connectivity capabilities of the original design.

In some implementations, the MxPU further comprises an inter-socket link (ISoL) configured to utilize addresses within the first physical address space, wherein the ISoL couples the MxPU to a second MxPU and enables the processing cores to access a second memory coupled via second memory channels to the second MxPU. The MxPU may include an ISoL to support scaling from a single MxPU to a cluster of interconnected homogeneous or heterogeneous MxPUs. An ISoL may enable scaling across multiple MxPU instances, coherent shared memory across sockets, low-latency atomic operations, and workload migration. It may expose remote high-bandwidth memory and I/O, support composable disaggregation, and/or provide redundant paths for RAS features such as fail-over and hot-service. Partitioning target functionality across xPU instances may improve manufacturing yield, allow mixed process nodes, and lower power per bit.

In some implementations of the MxPU, the ISoL is selected from an interconnect based on: AMD Infinity Fabric, NVIDIA NVLink-C2C, ARM CHI C2C, or Intel UPI. The ISoL may be implemented utilizing various industry interconnect technologies, wherein the selection of ISoL technology may depend on the processor architecture of the MxPU and the desired system topology.

In some implementations of the MxPU, the communication port comprises the CXL endpoint, and further comprising a second CXL endpoint configured to communicate with a second entity, wherein the second entity utilizes addresses within a third physical address space, and the RPU is further configured to translate physical addresses within the third physical address space to physical addresses within the first physical address space to enable the second entity to access at least a portion of the memory. The MxPU may include CXL endpoints to support multi-headed configurations wherein external entities can simultaneously access the MxPU's memory resources. The RPU may maintain separate translation contexts for the coupled entities, performing physical address translations from the entities'physical address spaces to the MxPU's first physical address space. This multi-headed capability may enable the MxPU to function as a memory pool resource, providing memory services to hosts while maintaining proper isolation and access control between different entities.

In some implementations of the MxPU, the repurposed area comprises the at least one of the communication port or the RPU and a remaining unassigned area, and wherein the remaining unassigned area is utilized for at least one of on-die decoupling capacitors or spare standard cells. The repurposed area may include not only functional blocks such as the communication port or RPU but also remaining unassigned silicon area. This remaining unassigned area may be utilized for on-die decoupling capacitors, which may help improve power delivery stability and reduce noise in the power distribution network. Alternatively or additionally, the remaining unassigned area may be reserved for spare standard cells or Engineering Change Order (ECO) cells, providing flexibility for late-stage design fixes or modifications without requiring substantial layout changes, and thereby increasing the utility of the repurposed area while maintaining design flexibility.

In some implementations of the MxPU, the communication port comprises an NVLink port, and the second physical address space comprises a network address space. When the MxPU is configured with an NVLink port, the second physical address space may include a network address space utilized by NVLink-connected devices. The network address space may enable NVLink-based devices to address memory resources across the NVLink fabric, wherein the RPU may translate between the network address space and the MxPU's first physical address space.

In some implementations of the MxPU, the first physical address space comprises a GPU physical address space, and the RPU is further configured to translate physical addresses within the network address space to physical addresses within the GPU physical address space. In MxPUs that are based on GPUs, the RPU may function similarly to a link translation lookaside buffer (TLB), translating between network addresses utilized by remote NVLink devices and local GPU physical addresses utilized by the MxPU's processing cores and memory controllers. This translation may enable remote NVLink peers to access the MxPU's GPU memory resources.

In some implementations of the MxPU, the MxPU further comprises a second silicon die coupled to the silicon die within an integrated circuit package of the MxPU, and wherein the second silicon die comprises an NVLink Fusion chiplet that includes the NVLink port and at least a portion of the RPU. The NVLink Fusion chiplet may provide a dedicated die implementing the NVLink port, the RPU, and associated translation logic, coupled to the processor die within the same integrated circuit package. This chiplet-based approach may enable the MxPU to incorporate NVLink connectivity and address translation capabilities without modifying the processor die's floorplan beyond the repurposed area's interconnect interface. In some examples, the NVLink Fusion chiplet may be fabricated utilizing a different process node than the processor die, potentially allowing optimization of the NVLink interface for power or performance independently of the processor die's process technology. Alternatively, the RPU, the NVLink port, and associated CXL interface logic may be implemented as functional blocks on the same die as the processor, or split between silicon dies or chiplets inside the integrated circuit package of the MxPU.

In some implementations, the MxPU further comprises a CXL root port coupled to the coherent interconnect, wherein the RPU is configured to translate messages received via the NVLink port into messages based on CXL, and to forward the translated messages to the coherent interconnect via the CXL root port. The RPU may utilize CXL as an intermediate protocol to bridge between the NVLink domain and the protocol utilized by the coherent interconnect. The RPU may expose a CXL device, such as a CXL endpoint (CXL EP) implementing a Type-1 or a Type-2 CXL device, to the processor via the CXL root port. The CXL root port may be coupled to the coherent interconnect via a coherent interconnect interface, such as a ring-to-CXL (R2CXL) interface, that may communicate with the coherent interconnect according to a protocol utilized by the coherent interconnect. This intermediate translation approach may enable the RPU to leverage existing CXL protocol infrastructure and interfaces already present in the processor design, potentially reducing the complexity of integrating NVLink connectivity into the MxPU. In some examples, the R2CXL interconnect interface may reside within the RPU, complementing the translation path from NVLink, via CXL, to traffic conforming to the protocol utilized by the coherent interconnect.

In some implementations of the MxPU, the MxPU comprises NVLink ports, and the repurposed area accommodates at least some of the NVLink ports. When the MxPU is configured as a processor or a switch with NVLink ports, the repurposed area may accommodate NVLink ports rather than a single port. This multi-port configuration may enable the MxPU to function as a multi-port GPU or an NVLink-based switch device, facilitating interconnection between NVLink-enabled devices in a fabric topology. The NVLink ports may share the RPU resources for address translation and protocol handling.

In some implementations of the MxPU, the second physical address space comprises a Network Physical Address (NPA) space, and the messages comprise UALink-based messages. When the MxPU includes a UALink port, the second physical address space may include an NPA space as defined by the UALink address model. UALink-based messages may conform to UPLI and may include read, write, and atomic operations that carry NPA addresses. The RPU may translate between the NPA space and the MxPU's first physical address space to enable UALink-connected accelerators to access the MxPU's memory resources.

In some implementations of the MxPU, the second physical address space comprises a Network Physical Address (NPA) space, the first physical address space comprises a System Physical Address (SPA) space, and wherein the RPU is further configured to translate physical addresses within the NPA space to physical addresses within the SPA space. In MxPUs that are based on UALink accelerators, the RPU may function as a link MMU that translates NPAs received from remote UALink accelerators to local SPAs utilized by the MxPU's processing cores and memory controllers. This NPA-to-SPA translation may enable the MxPU to participate in a UALink fabric while maintaining its local SPA-based memory addressing scheme.

In some implementations of the MxPU, the second physical address space comprises a Network Physical Address (NPA) space, the first physical address space comprises a Host Physical Address (HPA) space, and wherein the RPU is configured to translate physical addresses within the NPA space to physical addresses within the HPA space. In MxPUs that are based on CPUs, the RPU may translate NPAs received from UALink-connected accelerators to HPAs utilized by the MxPU's processing cores and memory controllers. This configuration may enable a CPU-based MxPU to serve as a UALink switch or a UALink-attached memory resource, providing UALink accelerators with access to the MxPU's host memory via NPA-to-HPA translations.

In some implementations of the MxPU, the MxPU comprises UALink ports, and the repurposed area accommodates at least some of the UALink ports. When the MxPU is configured to operate similarly to a UALink switch, the repurposed area may accommodate UALink ports rather than a single port, which may facilitate interconnection between UALink-enabled devices in a fabric topology. UALink ports may share the RPU resources for address translation and protocol handling.

In some implementations of the MxPU, the memory located outside the MxPU comprises at least 8 GB of dynamic random-access memory (DRAM) coupled via the memory channels, and the communication port comprises CXL endpoints located in the repurposed area, enabling the MxPU to function as a CXL Multi-Headed Device (MHD). The MxPU may be configured as a CXL Multi-Headed Device (MHD) by incorporating CXL endpoints within the repurposed area. This MHD configuration may allow external hosts to simultaneously access the MxPU's memory resources through different CXL connections. Different CXL endpoints may have different address translation contexts managed by the RPU, enabling isolated access to different portions of the DRAM or shared access with appropriate coherency mechanisms. Additionally or alternatively, the repurposed area may be sufficiently large to accommodate both the communication port and the RPU, rather than just one or the other. This configuration may enable the MxPU to implement CXL or UALink functionality within the repurposed silicon area, potentially enabling and/or enhancing memory pooling or switching capabilities while maintaining the original footprint of the silicon die.

The following method claim describes a design and manufacturing approach for creating processor device variants with improved yield by repurposing silicon die areas previously allocated to processing cores. By identifying areas of a processor design for repurposing, manufacturers may create new processor variants that accommodate communication ports and address translation units within the repurposed areas, without requiring a full redesign of the processor die.

In various implementations, a method for improving manufacturing yield of processor devices, comprising: identifying at least one processing core area in a processor design for repurposing as an impaired area; configuring the processor design to exclude the at least one processing core area from functional testing requirements while retaining a same die size; implementing at least one of a communication port or a resource provisioning unit (RPU) in the impaired area, wherein the communication port is selected from a Compute Express Link (CXL) endpoint, a CXL switch port, an NVLink port, or a UALink port, and the RPU is configured to translate between physical addresses associated with different physical address spaces; and manufacturing processor devices based on the configured processor design, whereby defects occurring within the impaired area do not cause rejection of the processor devices during production testing. This method may enable improved manufacturing yield by identifying and repurposing certain areas of a processor die as potential impaired areas that are excluded from stringent functional testing requirements. By implementing alternative functional blocks such as communication ports or RPUs within these repurposed impaired areas, the method may create valuable product variants while reducing the silicon area that must pass stringent functional tests. For example, processing cores are typically tested to operate correctly at high clock rates that significantly exceed the typical clock rates required for communication ports and RPUs. Defects that would normally cause die rejection if they occur in processing cores may be tolerated when they occur in alternative functional blocks in the repurposed impaired area, potentially increasing the percentage of usable dies from the wafers.

The implementations of the following method describe operational aspects of an MxPU derived from an established processor design. During operation, the MxPU utilizes processing cores and a coherent interconnect to access memory via memory channels, while a communication port receives messages from external entities utilizing a different physical address space. A resource provisioning unit (RPU) performs the translations between the external address space and the MxPU's internal address space, enabling the MxPU to serve as a memory resource, a protocol translator, or a switch for externally coupled devices. At least one of the communication port or the RPU operates from a silicon die area that was originally designed for processing cores in the established processor design, thereby leveraging the repurposed area for alternative functionality.

In various implementations, a method for operating a modified processing unit (MxPU), comprising: utilizing, by processing cores of the MxPU coupled via a coherent interconnect, a first physical address space to access memory located outside the MxPU via memory channels; receiving, via a communication port selected from a Compute Express Link (CXL) endpoint, a CXL switch port, an NVLink port, or a UALink port, messages comprising physical addresses within a second physical address space; translating, by a resource provisioning unit (RPU), physical addresses within the second physical address space to physical addresses within the first physical address space; and operating at least one of the communication port or the RPU from a silicon die area that excludes at least one processing core present in an established processor design from which the MxPU was derived. In some implementations, the RPU may dynamically translate between the address spaces during operation, enabling the MxPU to simultaneously serve its local processing workloads and provide memory services or connectivity to externally coupled devices. The silicon die area from which the communication port or RPU operates may correspond to a repurposed area or a repurposed impaired area, wherein processing cores from the established processor design have been excluded, replaced, or electrically disabled to accommodate the alternative functional blocks.

In some implementations of the method, the communication port comprises the CXL endpoint configured to communicate with an entity according to a protocol based on CXL, the first physical address space is a first Host Physical Address (HPA) space utilized by the processing cores, the second physical address space is a second Host Physical Address (HPA) space utilized by the entity, and the translating comprises performing host-to-host physical address translations from the second HPA space to the first HPA space. The method may include performing host-to-host physical address translations that enable external entities to access the MxPU's memory resources utilizing protocols based on CXL. These translations may dynamically map between different HPA spaces during operation, allowing the MxPU to serve memory access requests from external hosts while maintaining physical address space isolation and proper access control.

In some implementations, the method further comprises receiving, via a second communication port, second messages comprising physical addresses within a third physical address space utilized by a second entity; and translating, by the RPU, physical addresses within the third physical address space to physical addresses within the first physical address space to enable the second entity to access at least a portion of the memory. The method may include supporting multi-headed operations wherein external entities simultaneously access the MxPU's memory resources. The RPU may maintain separate translation contexts and perform different address translations for different coupled entities during operation, enabling the MxPU to function as a memory pool resource with concurrent access capabilities while maintaining isolation between different entities'memory accesses.

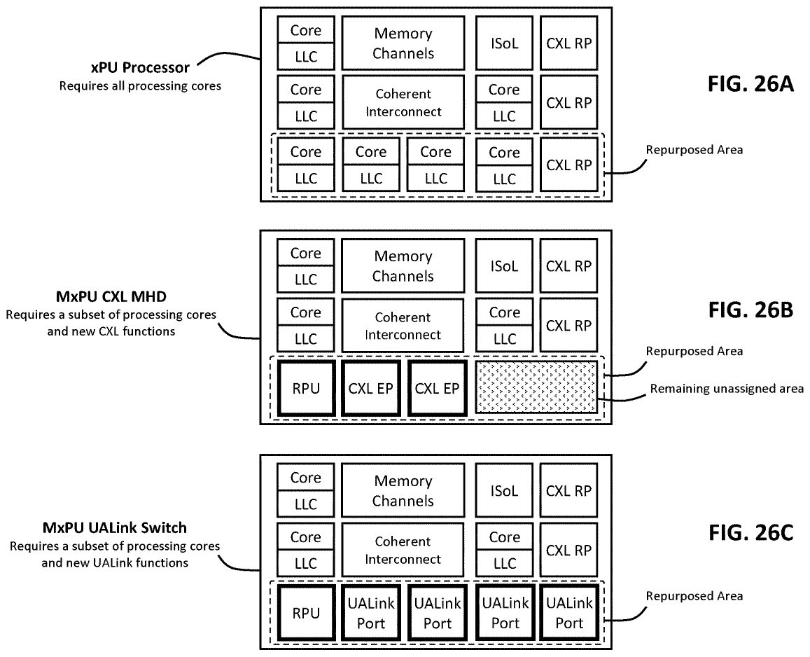

FIG. 26A illustrates an example of a silicon device functioning as an established xPU design before modification, which may include processing cores associated with Last Level Caches (LLCs), coupled through a cache coherent interconnect. The device may also include memory channels for external memory access, an inter-socket link (ISoL) for multi-processor configurations, and CXL root ports (RPs) for peripheral connectivity. The area identified as the repurposed area shown contains four processing cores with their associated LLC and one CXL RP, representing silicon area that may be repurposed in modified designs while maintaining the original die dimensions. The repurposed area may be used to create MxPU derivatives of the original xPU design, or may serve other purposes such as improving manufacturing yield.

FIG. 26B illustrates an example of a silicon device capable of providing the functionality of a CXL Multi-Headed Device (MHD) when coupled to memory, wherein the repurposed area may accommodate an RPU and CXL endpoints instead of the processing cores and optionally CXL root ports that originally resided in the repurposed area as illustrated in FIG. 26A. The RPU performs physical address translations that enable hosts coupled to the CXL MHD MxPU to access memory via the MxPU memory channels. The remaining silicon area within the repurposed area may be utilized for on-die decoupling capacitors or spare/ECO standard cells, maximizing the utility of the repurposed space, which may enable the device to serve as a CXL-attached memory resource for external hosts while maintaining compatibility with the original die size and package.

FIG. 26C illustrates an example of a silicon device (MxPU) capable of providing the functionality of a UALink Switch, wherein the repurposed area may accommodate an RPU and UALink ports instead of the processing cores and the CXL root port that originally resided in the repurposed area. The four UALink ports shown may provide connectivity to UALink-enabled devices, with the RPU performing physical address translations, such as from UALink Network Physical Addresses (NPAs) to MxPU Host Physical Addresses (HPAs) that enable UALink Accelerators coupled to the MxPU to access memory via the MxPU memory channels. The RPU may further enable UALink Accelerators to communicate with each other by translating UALink messages to MxPU interconnect messages and relaying the translated messages between UALink ports. The MHD MxPU example and the Switch MxPU example demonstrate how the same base silicon design may be adapted for different connectivity standards by implementing appropriate functional blocks within the repurposed area.

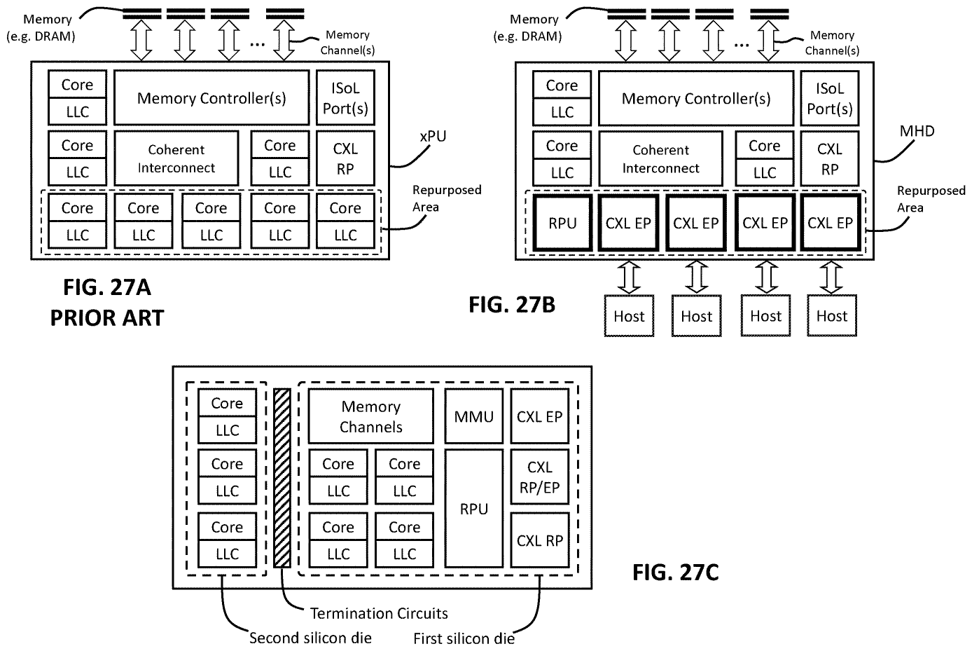

FIG. 27A illustrates a system comprising a prior art xPU design, such as a processor design (e.g., CPU or GPU), that includes a repurposed area (which may also be referred to as a designated area). The xPU may be based on an established xPU design, such as an established processor design, with memory controller(s) coupled to memory channels and to memory such as DRAM, ISoL port(s) such as Intel UPI port(s), a CXL root port (RP), a coherent interconnect, processing cores, and last level cache (LLC) slices, wherein at least some of the processing cores and/or the LLC slices may reside in a repurposed area of the xPU. The repurposed area may represent an intentional reservation of silicon area, such as in a die floorplan of an established xPU design, that may be intentionally disabled for product binning/segmentation, such as for creating different types of MxPUs, or utilized for different purposes, such as in different product Stock Keeping Units (SKUs), wherein different product SKUs may vary by the number of processing cores in the repurposed area, may vary by the type and mix of processing cores in the repurposed area (e.g., combinations of performance cores and efficiency cores, such as P-cores and E-cores, or big/little cores), or may vary by the operating frequency of the processing cores in the repurposed area. The repurposed area may be a repurposed impaired area of an xPU silicon die that may be limited in performance, e.g., limited in operating frequency that may fit slower processing cores, or may fit other functions of an xPU with lower performance requirements, such as communication ports (e.g., CXL ports) or miscellaneous non-core (e.g., uncore) functions.

FIG. 27B illustrates an example of a Multi-Headed Device (MHD) implementation that may be based on an xPU or an MxPU design, such as a processor design (e.g., CPU or GPU), that includes a repurposed area. The MHD may include processing cores, last level cache (LLC) slices, memory controller(s) coupled to memory channels and to memory such as DRAM, ISoL port(s) such as Intel UPI port(s), a CXL root port (RP), a coherent interconnect, and a repurposed area where processing cores of the original xPU may be replaced with one or more CXL endpoint ports, creating an MHD. The repurposed area may also include a Resource Provisioning Unit (RPU) that may enable physical address translations between physical address spaces, such as between Host Physical Address (HPA) spaces. The repurposed area may be modified to accommodate CXL endpoints that may replace processing cores, enabling MHD functionality based on a processor architecture. In some examples, the xPU may be based on an established xPU design, such as an established processor design (e.g., established CPU design or established GPU design).

Modern computing systems may require processors optimized for specific roles such as memory pooling, communication switching, and resource provisioning. These roles may not require the full computational capabilities of a general-purpose CPU, yet designing a new processor from scratch for each specific role involves substantial engineering effort, verification overhead, and time-to-market delays. By deriving a processor from an established CPU design and selectively removing unnecessary portions of the silicon die, it is possible to create cost-effective derivative processors that retain the communication and memory capabilities of the original design while reducing die area and power consumption. The implementation below addresses the challenges associated with selectively removing portions of a silicon die from an established CPU design. Termination circuits are implemented at interfaces between different silicon die areas to manage signal integrity, maintain coherent interconnect functionality, and provide electrical boundaries that accommodate variations in the dicing process. The termination circuits may be implemented during the floorplan partitioning stage, enabling the creation of multiple processor versions from a base design with minimal modifications to the original RTL design. The resulting processor retains communication ports such as CXL endpoints, CXL switch ports, and UALink ports, along with an RPU for address translation, enabling the processor to serve as a memory processor, communication switch, or resource provisioning node in multi-tier computing architectures.

In various implementations, a processor, derived from an established CPU design, comprising: memory channels capable of communicating with memory located outside the processor; processing cores, coupled via a coherent interconnect, configured to utilize a first physical address space to access the memory via the memory channels, and to respond to snoop requests that include physical addresses within the first physical address space; communication ports, selected from at least one of: Compute Express Link (CXL) endpoints, CXL switch ports, or UALink ports; wherein the communication ports are configured to receive messages comprising physical addresses within other physical address spaces; a resource provisioning unit (RPU) configured to translate physical addresses within the other physical address spaces to physical addresses within the first physical address space; and termination circuits implemented at interfaces of a first silicon die area comprising the communication ports, wherein the interfaces are configured to connect the first silicon die area with a second silicon die area that does not include the communication ports. The processor may be manufactured by modifying an established CPU design wherein termination circuits are placed at interfaces between different silicon die areas. The first silicon die area may contain the communication infrastructure including CXL endpoints, CXL switch ports, and/or UALink ports along with the RPU, while the second silicon die area may contain components that are not utilized for the processor's intended functionality. The coherent interconnect may implement cache coherency protocols such as MESI, MOESI, or proprietary coherency schemes to maintain data consistency across the processing cores. The RPU may perform real-time address translations to enable external entities to access memory resources through the communication ports while maintaining proper isolation between different physical address spaces. The termination circuits may serve as electrical boundaries at the first silicon die area that allow for flexible manufacturing options, including the ability to retain or remove the second silicon die area based on product requirements. The interfaces may remain functional whether or not the second silicon die area is physically present, as the termination circuits may manage signal integrity independently of the presence of the second silicon die area.

In some implementations of the processor, at least some of the termination circuits comprise an enable input configured to control signal propagation, wherein when the enable input is activated, the termination circuits block signal propagation on conductors designed to connect the first silicon die area with the second silicon die area, and when the enable input is deactivated, the termination circuits allow signal propagation between the first silicon die area and the second silicon die area. The enable input functionality may provide dynamic control over the termination circuits'behavior, allowing for configuration or manufacturing-time selection of different processor variants. When the enable input is activated, the termination circuits may effectively isolate the first silicon die area from the second silicon die area, creating electrical boundaries that prevent signal propagation across the interface. This isolation may be achieved utilizing various circuit techniques such as tri-state buffers, transmission gates, or analog switches that can disconnect the signal paths. When the enable input is deactivated, the termination circuits may become transparent to signal flow, allowing normal communication between the silicon die areas as if the termination circuits were not present. The enable input may be controlled utilizing various mechanisms including fuse programming, configuration registers, external pins, or firmware settings, providing flexibility in how the processor's functionality is configured.

In some implementations of the processor, the termination circuits are configured to block signal propagation between the second silicon die area and the first silicon die area, wherein for input signals, the termination circuits comprise pullup or pulldown circuits to provide a defined logical state, and wherein for output signals, the termination circuits block signal propagation to prevent antenna effects and/or short circuits. The termination circuits may have different implementations for handling input and output signals to maintain signal integrity and prevent electrical issues. For input signals that would normally come from the second silicon die area, pullup or pulldown circuits may be employed so that these inputs maintain a stable and predictable logical state rather than floating, which could cause metastability, increased power consumption, or unpredictable behavior in the receiving logic. The pullup circuits may connect the input to a positive voltage rail through a resistor, while pulldown circuits may connect to ground, with the choice between pullup and pulldown potentially depending on the default state requirements of the specific signals. For output signals from the first silicon die area, the termination circuits may include blocking mechanisms such as series switches or gates that prevent these signals from propagating to the removed or disconnected second silicon die area, thereby avoiding antenna effects that could cause electromagnetic interference or signal integrity issues, and preventing potential short circuits that could occur if output drivers were coupled to severed or improperly terminated conductors.

In some implementations, the processor further comprises conductors connecting the termination circuits to the second silicon die area, wherein the conductors are modified during a floorplan partitioning stage based on tolerance requirements of a dicing stage; and wherein the termination circuits are configured to maintain integrity of the coherent interconnect by: allowing signal passage to the second silicon die area when present, or performing a turnaround for data arriving on interconnect paths when the second silicon die area is removed. The conductors between the termination circuits and the second silicon die area may be designed with specific lengths and routing patterns that accommodate variations in the dicing process, wherein longer conductors may provide greater tolerance for dicing position variations while shorter conductors may minimize signal delay and area overhead. During the floorplan partitioning stage, these conductor lengths may be optimized based on the expected precision of the dicing equipment and the acceptable range of cut positions. The termination circuits may incorporate logic to maintain the coherent interconnect's functionality, particularly for ring-based or mesh-based interconnect topologies wherein data packets circulate through the entire network. When the second silicon die area is present, the termination circuits may act as pass-through elements, allowing data packets to flow normally through the interconnect. When the second silicon die area is removed, the termination circuits may implement turnaround functionality that receives incoming data packets and redirects them back into the interconnect, effectively shortening the interconnect path while maintaining logical continuity for proper packet routing and preventing deadlock conditions.

In some implementations of the processor, functional blocks in the first silicon die area not directly affected by removal of the second silicon die area maintain functional characteristics of their original Register Transfer Level (RTL) design; and interface blocks that directly connect between the first silicon die area and the second silicon die area have modified RTL designs comprising modifications to at least one of: signal routing, interface logic, or adaptations for maintaining functionality without the second silicon die area. The design methodology may minimize modifications to the established CPU design's RTL by concentrating changes in the interface blocks that directly interact with the potentially removed second silicon die area. Functional blocks in the first silicon die area that do not have direct connections to the second silicon die area may retain their original RTL implementation, which may reduce verification effort, maintain proven functionality, and minimize the risk of introducing new bugs. The interface blocks that have modified RTL designs may include changes to signal routing logic to redirect signals that would normally go to the second silicon die area, modifications to interface protocols to handle the absence of expected responses from the removed area, and adaptations to state machines or control logic that may need to operate differently when the second silicon die area is not present. These RTL modifications may be designed to be minimally invasive, potentially using conditional compilation or parameterization techniques that allow the same RTL source to support both configurations with and without the second silicon die area.

In some implementations of the processor, the modified RTL designs further comprise modifications to clock distribution networks to exclude the second silicon die area, and power management logic that is adjusted to account for removal of the second silicon die area. The clock distribution network modifications may include reconfiguring clock trees to eliminate branches that would have supplied clock signals to the second silicon die area, which may reduce clock network power consumption and potentially improve clock skew characteristics for the remaining portions of the processor. The power management logic modifications may encompass changes to power gating controls that would have managed power domains in the second silicon die area, updates to power state machines that no longer need to coordinate with components in the removed area, and adjustments to dynamic voltage and frequency scaling algorithms that may need to account for the reduced computational resources and power consumption characteristics of the modified processor.

In some implementations of the processor, manufacturing of the processor comprises physically removing the second silicon die area from a silicon die while retaining the communication ports in the first silicon die area, thereby reducing die size compared to the established CPU design. The processor may be derived from an established CPU design by physically removing the second silicon die area from the silicon die while retaining the communication ports supported by the established CPU design. This manufacturing process may reduce the overall die size, and potentially also the manufacturing costs, compared to the established CPU design, while preserving the full communication port functionality. By removing portions of the silicon die that do not affect the communication port operation, the design may be optimized for its intended purpose as a memory-centric processing unit in high-fanout, multi-tier memory pool scenarios. The retention of the communication ports, which may include CXL endpoints, CXL switch ports, and/or UALink ports, may enable the processor to establish connections with the same number of external entities as could be achieved with the established CPU design, thereby maintaining connectivity capabilities and facilitating efficient resource sharing among coupled entities.

In some implementations of the processor, manufacturing of the processor comprises physically removing the second silicon die area from a silicon die while retaining memory controllers supported by the established CPU design in the first silicon die area, thereby reducing die size compared to the established CPU design. The processor may be derived from an established CPU design such that the manufacturing process includes physically removing the second silicon die area from the silicon die while retaining memory controllers supported by the established CPU design. This manufacturing process may reduce the overall die size while preserving the full functionality of the memory controllers. By removing portions of the silicon die that do not affect memory controller operation, the design may be optimized for its intended purpose as a memory-centric processing unit in scenarios that maximize memory capacity. The retention of memory controllers may enable the processor to support the same memory capacity as the established CPU design. This may be beneficial for applications where memory capacity and bandwidth are more valuable than computational throughput, such as memory pooling and large-capacity memory tiering scenarios.

In some implementations of the processor, the RPU is further configured to perform physical address translations from a second host physical address (HPA) space, utilized by an entity coupled to at least one of the communication ports, to physical addresses within the first physical address space utilized by the processing cores. The RPU may perform address translations to enable memory access between different physical address spaces. The physical address translations may include maintaining translation tables, implementing content-addressable memories, or utilizing programmable address decoders that can map addresses within the second HPA space to corresponding physical addresses within the first physical address space. The entity utilizing the second HPA space may be an external host, accelerator, or another processor that accesses memory resources managed by the processor. The translation process may support various mapping schemes including linear offset mappings, windowed mappings, or more complex non-contiguous mappings, and may include access control to enforce memory protection boundaries between different entities.

In some implementations of the processor, the memory channels comprise at least four memory channels, and the second silicon die area comprises additional processing cores that were utilized in the established CPU design but are unnecessary for operation of the processor when functioning as a memory processor. The inclusion of at least four memory channels may provide substantial memory bandwidth to support the processor's role as a memory processor, wherein channels may operate in parallel to increase aggregate bandwidth and reduce access latency utilizing interleaving. The second silicon die area containing additional processing cores from the established CPU design may represent computational resources that, while useful in a general-purpose CPU context, may not be utilized when the processor is repurposed for memory-centric operations. The removal of these additional processing cores may reduce power consumption, decrease die area, and potentially improve yields while maintaining the memory access capabilities for the processor's intended use case.

In some implementations of the processor, the termination circuits are implemented during a floorplan partitioning stage that includes systematic division of an integrated circuit design into functional blocks, enabling creation of processor versions with distinct cutting locations between the first silicon die area and the second silicon die area. The implementation of termination circuits during the floorplan partitioning stage may provide flexibility in creating different processor variants from a base design. The floorplan partitioning stage may include evaluating the established CPU design to identify optimal boundaries between functional blocks where termination circuits can be inserted with minimal impact on the overall design. This systematic division may consider factors such as signal routing complexity, power domain boundaries, clock domain crossings, and functional dependencies between blocks. It may also enable a product family with different cost points and capabilities while leveraging a common design foundation and a reduced engineering effort for the variants.

In some implementations of the processor, the termination circuits are positioned adjacent to connection points between the first silicon die area and the second silicon die area to minimize length of unterminated signal paths and mitigate risks associated with signal integrity issues and electromagnetic coupling effects; and wherein the communication ports comprise at least one CXL endpoint configured to communicate according to CXL.mem. The adjacent positioning of termination circuits to the connection points may minimize the stub length of unterminated conductors, which may reduce signal reflections, minimize electromagnetic emissions, and improve overall signal integrity. The proximity of termination circuits to the boundary between silicon die areas may allow signals to be properly terminated within a short distance of where they would be interrupted by the removal of the second silicon die area, potentially reducing the risk of these unterminated segments acting as antennas or causing crosstalk with nearby signals. The inclusion of at least one CXL endpoint configured for CXL.mem may enable the processor to function as a CXL-attached memory device, wherein external hosts can access the processor's memory resources utilizing CXL.mem messages.

Manufacturing a processor derived from an established CPU design involves a series of fabrication steps that create the processor's functional components while introducing termination circuits at certain interfaces between silicon die areas. By incorporating termination circuits during the fabrication process, the method enables the creation of processor versions from a base design, including versions where portions of the silicon die are physically removed to reduce die area and cost. The fabrication process may be adapted to include various configurations of the termination circuits, supporting both pass-through and blocking modes depending on the target product variant. The method below may leverage existing semiconductor fabrication infrastructure and design tools to minimize the engineering effort for creating derivative processors. By preserving the established CPU design's RTL for functional blocks not directly affected by the removal of silicon die areas, and concentrating modifications in the interface blocks at the boundaries, the method may reduce verification overhead and time-to-market for the derivative processor products.

In various implementations, a method of manufacturing a processor derived from an established CPU design, the method comprising: fabricating circuitry for memory channels capable of communicating with memory located outside the processor; fabricating circuitry for processing cores coupled via a coherent interconnect, wherein the processing cores are configured to utilize physical addresses within a first physical address space to access the memory via the memory channels, and to respond to snoop requests that include physical addresses within the first physical address space; fabricating circuitry for communication ports selected from at least one of: Compute Express Link (CXL) endpoints, CXL switch ports, or UALink ports; wherein the communication ports are configured to receive messages comprising physical addresses within other physical address spaces; fabricating circuitry for a resource provisioning unit (RPU) configured to translate physical addresses within the other physical address spaces to physical addresses within the first physical address space; and fabricating termination circuits at interfaces connecting between: a first silicon die area comprising the communication ports, and a second silicon die area that does not include the communication ports. The method of manufacturing the processor may include modifying an established CPU design by placement of termination circuits that create defined boundaries between different silicon die areas. The fabrication process may include creating the first silicon die area containing the communication infrastructure and the RPU, while the second silicon die area may contain components from the established CPU design that are not utilized for the processor's intended functionality. The termination circuits may be fabricated during various stages of the manufacturing process, including during metallization layers where they can be integrated into the interconnect structure.

In some implementations of the method, fabricating the termination circuits comprises fabricating an enable input as part of at least some of the termination circuits, the enable input being configured such that when activated, the at least some of the termination circuits block signal propagation on conductors connecting the first silicon die area with the second silicon die area, and when deactivated, the at least some of the termination circuits allow signal propagation between the first silicon die area and the second silicon die area. The enable input may provide a configurable mechanism for selecting between pass-through and isolation modes during manufacturing or at runtime. The enable input may be implemented utilizing fuse elements, configuration registers, or external control signals, allowing different product variants to be produced from the same fabricated die by selectively activating or deactivating the termination circuits.

In some implementations of the method, the established CPU design is defined by a first Register Transfer Level (RTL) design, and the processor is defined by a second RTL design derived from the first RTL design by:
preserving portions of the first RTL design corresponding to functional blocks in the first silicon die area not directly affected by removal of the second silicon die area to form part of the second RTL design; and modifying portions of the first RTL design corresponding to interface blocks that connect between the first silicon die area and the second silicon die area, to specify the termination circuits in the second RTL design. Deriving the second RTL design from the first RTL design may minimize the engineering effort by reusing verified design blocks where possible. The preserved portions may include processing core logic, memory controller interfaces, and communication port implementations that do not have direct dependencies on the second silicon die area. The modified portions may be limited to interface blocks at the boundary, where termination circuit logic is inserted to manage signal integrity and interconnect continuity.

In some implementations of the method, the fabricating of the termination circuits is performed at locations determined during a floorplan partitioning stage of a design modification process applied to the established CPU design, the floorplan partitioning stage comprising: systematically dividing an integrated circuit design corresponding to the established CPU design; identifying potential cut points between the first silicon die area and the second silicon die area; and optimizing placement for the termination circuits. The floorplan partitioning stage may evaluate multiple candidate cut points based on criteria such as signal density at the boundary, power domain alignment, clock domain boundaries, and the physical area overhead of the termination circuits. The optimization of termination circuit placement may balance signal integrity requirements against area and routing constraints, and may consider the tolerances of the downstream dicing process.

In some implementations, the method further comprises configuring the termination circuits to allow signal propagation between the first silicon die area and the second silicon die area for manufacturing a first version of the processor; and configuring the termination circuits to block signal propagation between the first silicon die area and the second silicon die area for manufacturing a second version of the processor. The method may support manufacturing versions of processors from a base design by configuring the termination circuits differently for different versions. For the first version of the processor, the termination circuits may be configured in a pass-through mode that allows normal signal propagation between the first and second silicon die areas, effectively creating a processor that retains the full functionality of the established CPU design. For the second version of the processor, the same termination circuits may be configured in a blocking mode that prevents signal propagation between the silicon die areas, creating a reduced-functionality processor optimized for specific use cases such as memory processing or communication switching. The ability to create different product variants from a set of masks may reduce development costs and time-to-market while enabling a broader product portfolio.

In some implementations of the method, for input signals the termination circuits comprise pullup or pulldown circuits to maintain a defined logical state, and for output signals the termination circuits block signals to prevent antenna effects or short circuits. The differentiated handling of input and output signals may address distinct electrical concerns at the boundary. Pullup or pulldown circuits on inputs may prevent floating states that could cause metastability or excess power draw, while blocking circuits on outputs may prevent electromagnetic emissions from unterminated signal stubs.

In some implementations, the method further comprises modifying conductors connecting the termination circuits to the second silicon die area based on tolerance requirements of a dicing stage. The conductor lengths and routing patterns may be adjusted to accommodate the precision of the dicing equipment. Longer conductors may provide greater tolerance for cut position variations, while shorter conductors may reduce signal delay and area overhead. The modification may also account for potential mechanical stress at the die edge during the dicing process.

In some implementations, the method further comprises maintaining integrity of the coherent interconnect by configuring the termination circuits to: allow signal passage to the second silicon die area when present, or perform a turnaround for data arriving on interconnect paths when the second silicon die area is removed. The coherent interconnect may utilize a ring-based or mesh-based topology where data packets circulate through the network. When the second silicon die area is present, the termination circuits may allow normal packet flow. When removed, the turnaround functionality may redirect packets back into the remaining interconnect, preserving logical continuity and preventing deadlock conditions that could otherwise arise from broken paths.

In some implementations of the method, the processor is manufactured based on a modified design created by: preserving Register Transfer Level (RTL) design of functional blocks in the first silicon die area not directly affected by removal of the second silicon die area, and modifying RTL design of interface blocks that connect between the first silicon die area and the second silicon die area. Preserving the RTL design of unaffected functional blocks may allow those blocks to retain their verified functionality without additional validation effort. The modifications to interface block RTL may be concentrated at the boundary between the silicon die areas, where termination circuit logic, signal rerouting, and interconnect turnaround functionality are introduced. This approach may minimize the scope of design changes and reduce the overall verification burden.

In some implementations of the method, the modifying of the RTL design is limited to signal routing modifications, interface logic modifications, and adaptations for maintaining functionality without the second silicon die area. Limiting the scope of RTL modifications to signal routing, interface logic, and functionality adaptations may reduce the risk of introducing regressions in unrelated portions of the design. This focused modification approach may also simplify the verification process by constraining the set of changed design elements.

In some implementations of the method, the modifying of the RTL design comprises at least one of: updating signal routing to accommodate the termination circuits, modifying clock distribution networks to exclude the second silicon die area, or adjusting power management logic to account for removal of the second silicon die area. The signal routing updates may redirect signals that would otherwise traverse the boundary between silicon die areas. The clock distribution network modifications may eliminate clock tree branches serving the removed area, potentially reducing power consumption and improving clock skew characteristics. The power management logic adjustments may update power gating controls, power state machines, and dynamic voltage and frequency scaling algorithms to reflect the reduced processor configuration.

In some implementations, the method further comprises verifying functionality of a resulting modified RTL design by: performing static timing analysis on the modified interface blocks, conducting functional simulations of the processor design, and comparing results with the established CPU design to verify equivalent performance in remaining functional blocks. The verification process for the modified RTL design may employ a methodology to confirm functional correctness and performance equivalence with the established CPU design. The static timing analysis on modified interface blocks may verify that the addition of termination circuits and modifications to signal routing do not introduce timing violations or degrade performance on affected paths. The functional simulations may include directed tests targeting the termination circuit behavior under various configurations, random testing to uncover corner cases, and system-level simulations to verify proper operation in the context of the complete processor design. The comparison with the established CPU design may involve running identical test suites on both designs and verifying that the remaining functional blocks exhibit identical behavior. This verification process may also include formal verification techniques to mathematically prove the equivalence of specific properties between the original and modified designs.

In some implementations, the method further comprises physically removing the second silicon die area while retaining the communication ports in the first silicon die area. The physical removal may be performed during the dicing stage, where the silicon wafer is cut to exclude the second silicon die area. The retention of communication ports in the first silicon die area may preserve the processor's ability to connect with external entities via CXL and/or UALink interfaces, maintaining the same connectivity as the established CPU design in a reduced die area.

In some implementations, the method further comprises physically removing the second silicon die area while retaining memory controllers supported by the established CPU design in the first silicon die area. The physical removal of the second silicon die area while retaining the memory controllers may allow the processor to support the same memory capacity as the established CPU design. This may be beneficial for applications where memory bandwidth and capacity are more valuable than computational throughput, such as memory pooling and large-capacity memory tiering scenarios.

FIG. 27C illustrates an example of a processor derived from an established CPU design, wherein termination circuits are implemented at interfaces between different silicon die areas. The processor may be manufactured using one of two exemplary approaches. A first approach is to remove a portion of the silicon design during the floorplan partitioning stage, resulting in a chip design that excludes the unnecessary part. A second approach is to physically chop the unnecessary part at the dicing stage, which includes physically cutting away a portion of the manufactured chip. The illustrated processor includes a first silicon die area comprising Memory Channels, an MMU, one or more CXL EPs, one or more CXL RPs, processing cores with LLCs, and an RPU. A second silicon die area comprises additional processing cores with their associated LLCs. To preserve the integrity of the remaining components (whether the portion is removed at the floorplan partitioning stage or at the dicing stage), termination circuits are added between the first and second silicon die areas to block signal propagation beyond specific physical points. The termination circuits are used to properly end signal paths, preventing reflections or unintended signal propagation. By adding the termination circuits at potential cut points, the design becomes more tolerant to variations in the physical dicing process, as signals are cleanly terminated regardless of the exact cut location within a certain range. Therefore, adding the termination circuits may also increase the permissible variance in the dicing process compared to an alternative solution that does not add such termination circuits.

The termination circuits may be implemented during the floorplan partitioning stage, which includes the systematic division of the integrated circuit design to large functional blocks. This implementation of termination circuits enables the creation of one or more chip versions with distinct cutting locations. For example, a first version of the integrated circuit may be designed with termination circuits positioned for cutting at a first predetermined location between the first and second silicon die areas, and a second version of the integrated circuit may be designed with termination circuits positioned for cutting at a second predetermined location. The termination circuits may be added adjacent to the connection or cutting points between the silicon die areas so that signals are properly terminated close to where they may be interrupted. This adjacency minimizes the length of unterminated signal paths, thereby mitigating risks associated with signal integrity issues and unintended electromagnetic coupling effects. In the illustrated example, the termination circuits form an interface region between the first silicon die area containing the communication ports (CXL EP, CXL RP/EP, CXL RP) and the second silicon die area containing the additional processing cores.

Optionally, at least some of the termination circuits incorporate an “enable” input that controls their operation when activated. The functionality of the termination circuits is such that when the enable input is activated, the termination circuit effectively blocks signal propagation between the first and second silicon die areas, whereas when the enable input is deactivated, the circuit allows signals to pass through unimpeded. This “enable” functionality that controls the chip's behavior allows for the selective activation or deactivation of certain signal paths depending on which version of the chip is being produced or utilized. For example, if there is a need to chop-out the second silicon die area containing optional processing cores coupled to the coherent interconnect, then the interconnect loops must be closed such that data can still circulate through the remaining portions of the coherent interconnect in the first silicon die area, maintaining the chip's functionality despite the removal of the second silicon die area. Thus, in this example the termination circuits operate in two modes: either allowing signal passage to the second silicon die area that exists after it, or performing a turnaround for the data arriving on the interconnect paths, effectively shortening the path logically. Additionally, the length of the conductors connecting the termination circuits to the optional logic in the second silicon die area (that may be chopped from a certain version of the chip) may be changed according to the required tolerance and properties of the dicing stage. Typically, signal ends are not left floating, especially not inputs that can lead to unstable or metastable states. Therefore, pullup or pulldown termination circuits are placed on the inputs so that the input is in a defined logical state. These circuits are designed such that they handle input signals even if they are floating due to the second silicon die area being cut. On the output, the termination circuits block the signals to prevent antennas or to prevent short circuits when the signals themselves were blocked already in the logical termination block.

One of the possible goals during the modification of an established CPU design to create the processor illustrated in FIG. 27C may be to modify the RTL as little as possible. RTL is a design abstraction representing the registers of a digital circuit and the operations performed on signals as they pass between these registers. Modifying RTL can have far-reaching effects on the chip's functionality and timing, and changes typically require re-verification of the entire design and re-synthesis of the affected portions. Thus, modifying the RTL can be time-consuming and may introduce new issues. By minimizing RTL changes, the design process becomes more efficient and less prone to errors. Additionally, large chip designs are often divided to smaller, manageable blocks that can be designed and synthesized separately, which allows for parallel development and easier management of complex designs. By implementing the chopping at the floorplan partitioning stage between the first and second silicon die areas, it is possible to isolate the effects to specific blocks, leaving others unchanged, which minimizes the scope of modifications and reduces the overall impact on the design and verification process. In the illustrated example, the first silicon die area retains the communication ports (CXL EP, CXL RP/EP, CXL RP) and the RPU for the processor's operation, while the second silicon die area containing additional processing cores may be optionally removed based on product requirements.

### TERMINOLOGY

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and infinity fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### GENERAL CONSIDERATIONS

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method for translating between Peripheral Component Interconnect Express (PCIe) Transaction Layer Packets (TLPs) and Compute Express Link (CXL) messages, comprising:
receiving a PCIe memory request by a computer from a first entity;
translating, by the computer, the PCIe memory request to a CXL.mem Master-to-Subordinate (M2S) request;
sending, by the computer to a second entity, the CXL.mem M2S request;
receiving, by the computer from the second entity, a CXL.mem Subordinate-to-Master Data Response (S2M DRS) corresponding to the CXL.mem M2S request;
translating, by the computer, the CXL.mem S2M DRS to a PCIe Completion; and
sending the PCIe Completion by the computer to the first entity.

2. The method of claim 1, wherein the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity.

3. The method of claim 2, wherein the first entity comprises a GPU that does not support CXL.mem, wherein the second entity comprises a CXL memory pool, and wherein the computer exposes memory resources of the CXL memory pool to the GPU via a PCIe memory address space.

4. The method of claim 3, wherein the computer communicates with GPUs via interfaces, and wherein the computer translates PCIe memory requests from the GPUs to CXL.mem M2S requests targeting a shared memory resource of the CXL memory pool.

5. The method of claim 4, wherein the computer maintains memory allocation information associating portions of the CXL memory pool with certain respective GPUs of the GPUs, and wherein translating the PCIe memory request comprises selecting a portion of the CXL memory pool based on an identity of a requesting GPU.

6. The method of claim 2, wherein the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CplD) comprising the data and the first Tag; and wherein the computer maintains a mapping between the first Tag and the second Tag.

7. The method of claim 6, further comprising: receiving, by the computer from the first entity, a PCIe Memory Write request (MWr) comprising write data; translating the PCIe MWr to a CXL.mem M2S request with Data (M2S RwD) comprising a MemWr* and the write data;
sending the CXL.mem M2S RwD to the second entity; and receiving, from the second entity, a CXL.mem S2M No Data Response (S2M NDR) comprising Cmp*.

8. The method of claim 1, wherein the computer is included in a switch, and wherein the PCIe memory request is selected from: a UIO Memory Read (UIOMRd) request, a UIO Memory Write request (UIOMWr), a Memory Read (MRd) request, or a Memory Write request (MWr).

9. The method of claim 1, wherein the PCIe memory request comprises a PCIe Unordered Input/Output (UIO) Memory Read (UIOMRd) request, and wherein the PCIe Completion comprises a PCIe UIO Read Completion with Data (UIORdCplD).

10. The method of claim 9, further comprising: receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity.

11. The method of claim 9, wherein the CXL.mem S2M DRS comprises a DevLoad, and wherein the PCIe Completion comprises a CXL DevLoad (CDL) populated based on the DevLoad.

12. The method of claim 1, further comprising sending, by the computer to the second entity, a CXL.mem M2S request comprising MemSpecRd.

13. The method of claim 12, further comprising: receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data;
and populating a subsequent PCIe Completion with at least some of the buffered data responsive to the subsequent PCIe memory request.

14. The method of claim 12, further comprising detecting sequential access patterns in physical addresses of prior PCIe memory requests received from the first entity, and initiating the CXL.mem M2S request comprising MemSpecRd targeting a next sequential physical address.

15. The method of claim 12, further comprising detecting strided access patterns in physical addresses of prior PCIe memory requests received from the first entity, calculating a stride distance between accessed addresses, and initiating the CXL.mem M2S request comprising MemSpecRd targeting a physical address offset by the stride distance.

16. The method of claim 1, wherein the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag.

17. The method of claim 1, wherein the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion.

18. The method of claim 1, wherein the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion.

19. A non-transitory computer-readable medium comprising instructions which, when executed by a processor, cause the processor to perform the method of claim 1.

20. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

21. An active cable comprising first and second pluggable modules coupled by a physical medium; wherein the active cable further comprises hardware circuitry, integrated into the active cable, configured to perform the method of claim 1.

22. An apparatus configured to operate as a switch, wherein the apparatus comprises switching circuitry and is configured to perform the method of claim 1.

23. An apparatus for translating between Peripheral Component Interconnect Express (PCIe) Transaction Layer Packets (TLPs) and Compute Express Link (CXL) messages, comprising:
a first interface configured to communicate with a first entity based on PCIe;
a second interface configured to communicate with a second entity based on CXL.mem; and
a computer coupled to the first interface and the second interface, wherein the computer is configured to:
receive a PCIe memory request from the first entity via the first interface;
translate the PCIe memory request to a CXL.mem Master-to-Subordinate (M2S) request;
send, to the second entity via the second interface, the CXL.mem M2S request;
receive, from the second entity via the second interface, a CXL.mem Subordinate-to-Master Data Response (S2M DRS) corresponding to the CXL.mem M2S request;
translate the CXL.mem S2M DRS to a PCIe Completion; and
send the PCIe Completion to the first entity via the first interface.

24. The apparatus of claim 23, wherein the PCIe memory request comprises a first physical address belonging to a first physical address space, the CXL.mem M2S request comprises a second physical address belonging to a second physical address space, and wherein the computer is further configured to translate between the first physical address and the second physical address.

25. The apparatus of claim 23, wherein the first entity comprises a GPU that does not support CXL.mem, the second entity comprises a CXL memory pool, and wherein the computer is configured to expose memory resources of the CXL memory pool to the GPU as a PCIe memory-mapped region.

26. The apparatus of claim 23, wherein the computer is further configured to send, to the second entity via the second interface, a CXL.mem M2S request comprising MemSpecRd.

27. The apparatus of claim 23, wherein the apparatus is located in an active cable.

28. A system comprising:
Graphics Processing Units (GPUs), wherein at least one GPU of the GPUs does not support Compute Express Link (CXL) communications;
a CXL device coupled to memory having a capacity greater than a capacity of high-bandwidth memory (HBM) of any one of the GPUs; and
a computer coupled between the GPUs and the CXL device, the computer comprising:
a first interface configured to communicate with the GPUs based on PCIe; and
a second interface configured to communicate with the CXL device based on CXL.mem;
wherein the computer is configured to:
receive, from a GPU of the GPUs via the first interface, a PCIe memory request;
translate the PCIe memory request to a CXL.mem Master-to-Subordinate (M2S) request;
send, to the CXL device via the second interface, the CXL.mem M2S request;
receive, from the CXL device via the second interface, a CXL.mem Subordinate-to-Master Data Response (S2M DRS);
translate the CXL.mem S2M DRS to a PCIe Completion; and
send the PCIe Completion to the GPU via the first interface.

29. The system of claim 28, wherein the memory is accessible by the GPUs as a shared memory region, and wherein the computer is configured to translate PCIe memory requests from the GPUs to CXL.mem M2S requests targeting the shared memory region.

30. The system of claim 28, wherein the computer maintains memory allocation information associating portions of the memory with respective GPUs, and wherein translating the PCIe memory request comprises selecting a target address within the memory based on an identity of a requesting GPU of the GPUs.
